(19) United States
(12) Patent Application Publication
(10) Pub. No.: US 2016/0227042 A1
(43) Pub. Date: Aug. 4, 2016

(54) SYSTEMS AND METHODS FOR CALL BACKUP AND TAKEOVER USING WEB AND MOBILE INTERFACES

(71) Applicant: GUBAGOO, INC., West Palm Beach, FL (US)

(72) Inventors: Jeffrey W. Gray, Trinity, FL (US); Bradley Title, Boynton Beach, FL (US)

(21) Appl. No.: 15/004,853

(22) Filed: Jan. 22, 2016

Related U.S. Application Data
(60) Provisional application No. 62/106,688, filed on Jan. 22, 2015.

(51) Int. Cl. H04M 3/58; H04W 4/16; G06Q 30/02; H04M 3/42; H04M 1/725; H04M 3/54; H04W 4/14; H04M 3/51

(52) U.S. Cl. CPC H04M 3/58; H04W 4/14; H04W 4/16; H04M 3/5191; H04M 3/42042; H04M 3/5175; H04M 1/72522; H04M 3/54; G06Q 30/0267

(57) ABSTRACT

A telecommunications system for handling call volume, including an application with takeover ability loaded on a mobile device, updating the application when a call is being handled by a third party, and transferring the call when an option to takeover is chosen.

### CROSS REFERENCE TO RELATED APPLICATIONS

The present application claims priority to U.S. Provisional Application Ser. No. 62/106,688, filed Jan. 22, 2015 for “Systems and Methods for Call Backup and Takeover Using Web and Mobile Interfaces” and is also related to U.S. Pat. No. 9,189,798, filed Nov. 27, 2012 for “Systems and Methods for Online Website Lead Generation Service,” and U.S. application Ser. No. 14/218,387, filed Mar. 18, 2014 for “Systems and Methods for Online Website Lead Generation Service,” which are hereby incorporated by reference in their entirety and for all purposes.

### FIELD OF THE INVENTION

The field of the invention relates to systems and methods for call backup and takeover using web and mobile interfaces in a telecommunications system.

### BACKGROUND OF THE INVENTION

Call centers are used in various industries to support primary retail and service outlets. When primary retail and service outlets are inundated with calls then call centers can record information and later report it to the outlets for their use. Some examples of outlets include retail stores with customer service departments, men's clothing, women's clothing, children's clothing, shoes, electronics, exercise equipment or any other departments. Another example of an outlet that may require a call center is a car dealership. Car dealerships typically have numerous departments including sales, finance, parts, service, and others and are frequently busy due to high volume of foot traffic and calls to arrange appointments. Since transferring a call to a call center can be inefficient because the dealership may not receive potentially important customer communications it would be beneficial to have a system which facilitates real-time call handoffs between call centers and the outlets they support. These handoffs can include data transfer of collected information where employees of the outlets can screen calls based on various criteria to handle the most important calls first. Accordingly, improved systems and methods to provide for call backup and takeover using web and mobile interfaces in a telecommunications system may be desirable.

### SUMMARY OF THE INVENTION

In a preferred embodiment, the system includes an integrated telecommunications and web communications platform allowing for customer overflow interaction and vendor call takeover. Some features include instant browser based call notification, call recording, automated-DID provisioning and instant activation, web-based configuration, intelligent transfer, intelligent scheduling, inventory lookup based on customer input, inventory and advertisement source integrated CDR and reporting modules and cloud computing integration. Additional features include call center queuing, multi-site redundancy, skills-based routing, dynamically configurable IVR, real-time call monitoring and load balancing.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

In order to better appreciate how the above-recited and other advantages and objects of the inventions are obtained, a more particular description of the embodiments briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1 is an example embodiment diagram of an agent interface in accordance with the present invention.

FIG. 2 is an example embodiment diagram of an agent interface including a script in accordance with the present invention.

FIG. 3 is an example embodiment diagram of an agent interface including inventory in accordance with the present invention.

FIG. 4 is an example embodiment diagram of an agent interface including a targeted search of inventory in accordance with the present invention.

FIG. 5 is an example embodiment diagram of a client email including a targeted offer in accordance with the present invention.

FIG. 6 is an example embodiment diagram of an agent interface including appointment setting in accordance with the present invention.

FIG. 7 is an example embodiment diagram of an agent interface including call transferring in accordance with the present invention.

FIG. 8 is an example embodiment diagram of an agent interface including a call wrap-up in accordance with the present invention.

FIG. 9 is an example embodiment diagram of a sales lead report for a vendor in accordance with the present invention.

FIGS. 10A-C are example embodiment diagrams of a vendor login, dashboard and agent list for a vendor mobile application in accordance with the present invention.

FIGS. 11A-C are example embodiment diagrams of a lead inbox, slide out navigation and inventory detail for a vendor mobile application in accordance with the present invention.

FIGS. 12A-C are example embodiments of diagrams of an expanded lead detail, incoming call viewer and call takeover screen for a vendor mobile application in accordance with a the present invention.

FIGS. 13A-C are example embodiments of diagrams of a takeover viewer screen, call transfer screen and takeover details screen for a vendor mobile application in accordance with the present invention.

FIGS. 14A-K are example embodiments of diagrams of an incoming call screen and connected call screen for a vendor mobile application in accordance with the present invention.

FIG. 15 is an example embodiment of a system architecture in accordance with the present invention.

FIG. 16 is an example embodiment of a system architecture in accordance with the present invention.

FIG. 17 is an example embodiment of a prior art vendor call routing overflow flow chart in accordance with the present invention.

FIG. 18 is an example embodiment of a call queue routing flow chart as may be implemented using the current system in accordance with the present invention.

FIG. 19 is an example embodiment of a call event timers flow chart in accordance with the present invention.

FIG. 20 is an example embodiment of a call flow chart in accordance with the present invention.

FIG. 21 is an example embodiment of a call forwarding flow chart in accordance with the present invention.

FIG. 22 is an example embodiment of a non-Centrex architecture flowchart in accordance with the present invention.

FIG. 23 is an example embodiment of a Centrex architecture flowchart in accordance with the present invention.

FIG. 24 is an example embodiment of a hosted VoIP architecture flowchart in accordance with the present invention.

FIG. 25 is an example embodiment of a call forwarding service and Centrex architecture flowchart in accordance with the present invention.

FIG. 26 is an example embodiment of a call forwarding service and system architecture flowchart in accordance with the present invention.

FIG. 27 is an example embodiment of a system architecture flowchart in accordance with the present invention.

FIG. 28 is an example embodiment of a prior art architecture flowchart in accordance with the present invention.

FIG. 29 is an example embodiment of a call flowchart in accordance with the present invention.

FIG. 30 is an example embodiment of a call timeline flowchart in accordance with the present invention.

FIG. 31 is an example embodiment of a role designation chart in accordance with the present invention.

FIG. 32 is an example embodiment of an inventory request routine flowchart in accordance with the present invention.

FIG. 33 is an example embodiment of a minimum inventory pipeline setup chart in accordance with the present invention.

FIG. 34 is an example embodiment of a multi-location inventory pipeline setup chart in accordance with the present invention.

FIG. 35 is an example embodiment of a skill relationship chart in accordance with the present invention.

FIGS. 36A-D are example embodiments of flowcharts showing a standard call takeover in accordance with the present invention. FIG. 36A shows incoming call routing, FIG. 36B shows call transferring, FIG. 36C shows call in progress and FIG. 36D shows call wrap up and lead forwarding.

FIGS. 37A-M are example embodiments of user interface interaction between the system and takeover application.

FIG. 37A is an example embodiment of a side-by-side of a web user interface with no incoming call and takeover application interface dashboard in accordance with the present invention.

FIG. 37B is an example embodiment of a side-by-side of a web user interface with an incoming call and takeover application interface dashboard in accordance with the present invention.

FIG. 37C is an example embodiment of a side-by-side of a web user interface with a call script display and takeover application interface dashboard in accordance with the present invention.

FIG. 37D is an example embodiment of a side-by-side of a web user interface with inventory search and takeover application interface dashboard in accordance with the present invention.

FIG. 37E is an example embodiment of a side-by-side of a web user interface with takeover option and takeover application interface push notification in accordance with the present invention.

FIG. 37F is an example embodiment of a side-by-side of a web user interface with inputted customer details and takeover application interface with call details in accordance with the present invention.

FIG. 37G is an example embodiment of a side-by-side of a web user interface with call takeover notification and takeover application interface with connection options in accordance with the present invention.

FIG. 37H is an example embodiment of a side-by-side of a web user interface with call takeover details and takeover application interface with call connection in accordance with the present invention.

FIG. 37I is an example embodiment of a side-by-side of a web user interface with call takeover details and takeover application interface with call connection notification in accordance with the present invention.

FIG. 37J is an example embodiment of a side-by-side of a web user interface with call takeover details and takeover application interface with call connection details in accordance with the present invention.

FIG. 37K is an example embodiment of a side-by-side of a web user interface with call takeover details and takeover application interface with call transfer missed notification in accordance with the present invention.

FIG. 37L is an example embodiment of a side-by-side of a web user interface with call takeover declined details and takeover application interface with call missed details in accordance with the present invention.

FIG. 37M is an example embodiment of a side-by-side of a web user interface with call details and takeover application interface with other user call connection details in accordance with the present invention.

FIG. 38 is an example embodiment of an example embodiment of a diagram of a system in accordance with an embodiment of the present invention.

FIG. 39 is an example embodiment of a call takeover architecture diagram.

FIG. 40 is an example embodiment of a chat operator user interface screen with a call takeover “widget” in the bottom right corner.

FIG. 41A is an example embodiment diagram of an operator call status user interface screen for a vendor mobile application in accordance with the present invention.

FIG. 41B is an example embodiment diagram of an agent chat user interface screen with a takeover notification for a vendor mobile application in accordance with the present invention.

FIG. 41C is an example embodiment diagram of an operator chat user interface screen with a takeover notification for a vendor mobile application in accordance with the present invention.

FIG. 41D is an example embodiment diagram of an operator chat status screen for a vendor mobile application in accordance with the present invention.

FIG. 41E is an example embodiment diagram of an operator call status screen for a vendor mobile application in accordance with the present invention.

FIG. 41F is an example embodiment diagram of a vendor department status screen for a vendor mobile application in accordance with the present invention.

FIG. 41G is an example embodiment diagram of a vendor live call screen for a vendor mobile application in accordance with the present invention.

FIG. 42 is an example embodiment diagram of an authentication sequence.

FIG. 43 is an example embodiment diagram of a framework authentication activity diagram.

FIG. 44 is an example embodiment of a user cache sequence diagram.

FIG. 45 shows an example embodiment of a call notification sequence diagram.

FIG. 46 is an example embodiment of a takeover system integration options diagram.

FIG. 47 is an example embodiment of a framework sequence diagram.

FIG. 48 is an example embodiment of a pub sub sequence diagram.

FIG. 49 is an example embodiment of a call notification sequence diagram.

FIG. 50 shows an example embodiment of a SNS registration sequence diagram.

FIG. 51 is an example embodiment of a takeover client subscription sequence diagram.

### DETAILED DESCRIPTION OF THE PREFERRED EMBODIMENTS

The following Terms are used throughout this document although definitions are not limited to those provided here: VoIP—Voice over Internet Protocol; PSTN—Packet Switched Telephone Network; NPA—area code of a phone number; NXX—central office exchange portion of a phone number; DID—Direct Inward Dial—phone number routed directly to a specific agent in the system, bypassing IVR menus or a local phone number used in internet advertising to track a specific advertisement-service; DNIS—Dial Number Identification Service—determination of the phone number which caller dialed to reach the service; ANI (Caller ID)—Automatic Number Identification—number from which a caller is calling; WebRTC—Real Time Communication-communications protocol for allowing VoIP calls to be directly routed to an Internet Browser; Queue—logical grouping of Skills used for reporting or management purposes in order to calculate Hold Time, Abandon Rate, Occupancy, and others; and IVR—Interactive Voice Response.

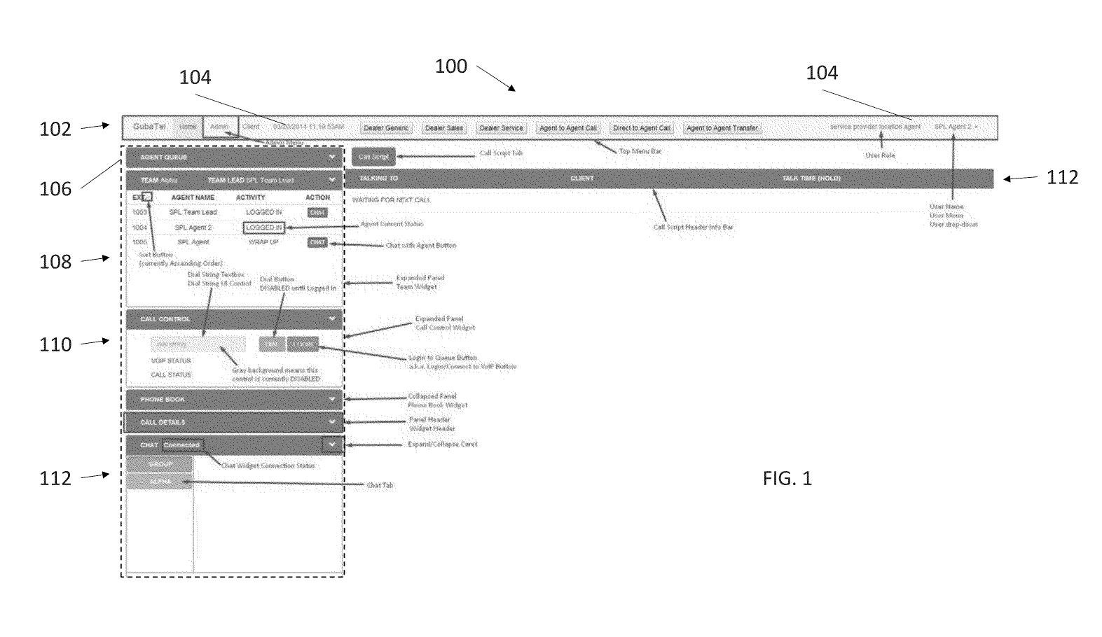

Turning to FIG. 1, a diagram of an example embodiment of an agent interface 100 in accordance with the present invention is shown. In the example embodiment a top menu bar 102 can include Home, Admin, Client dropdown menus in addition to Dealer Generic, Dealer Sales, Dealer Service, Agent to Agent Call, Direct to Agent Call, and Agent to Agent Transfer buttons that are selectable by a user. Identifying information 104 can also be shown such as time and date, user role, and user name. The agent interface 100 shown includes sections 106 for Agent Queue, Team information, Call Control, Phone Book, Call Details, Chat, and Call Script. Team information section 108 can include agent names, activities including status such as logged in and actions such as chat buttons. Call Control section 110 can include fields for dial string, buttons such as Dial and Login and status such as VoIP Status and Call Status. Chat section 112 can include information about whether the agent is logged in and who the agent is talking to. A call script header info bar can include a talking to and client talk time (hold) fields.

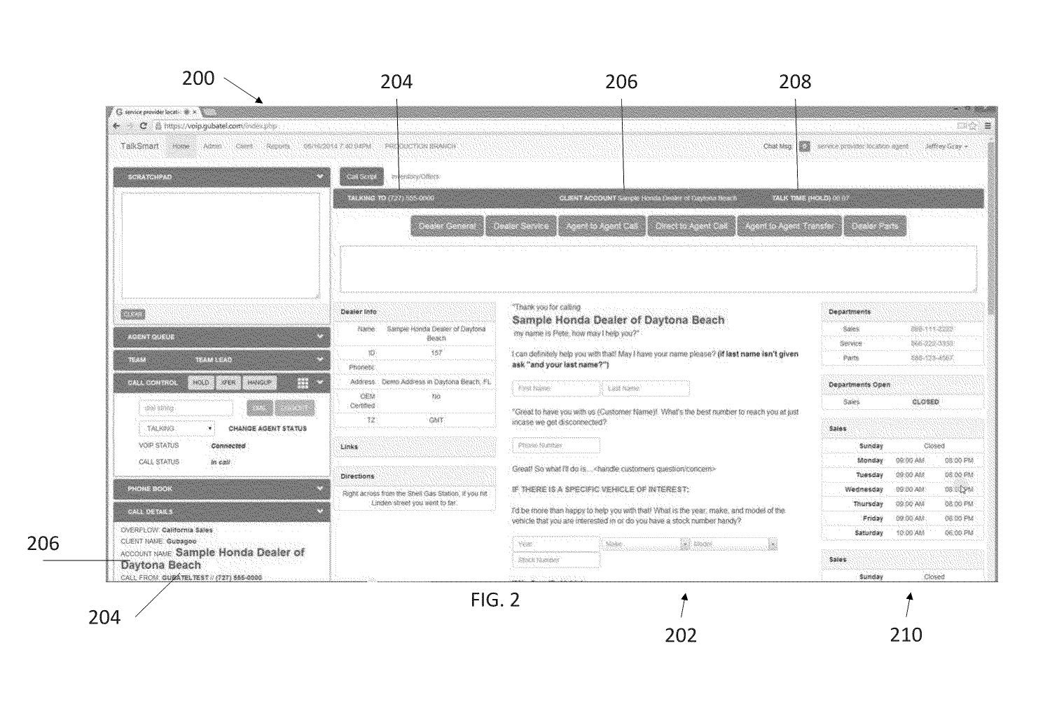

Turning to FIG. 2, a diagram of an example embodiment of an agent interface 200 including a script 202 in accordance with the present invention is shown. In the example embodiment an agent can receive a call. Upon receiving the call a phone number or caller identifier 204 can be displayed. A vendor name 206 can be displayed in addition to the length of time of the call 208. The system can display a script 202 for the agent to operate from while fielding the call. In the example embodiment the agent is shown the script 202 which begins “Thank you for calling Sample Honda Dealer of Daytona Beach. My name is Pete, how may I help you?” The script is interactive in that it includes fields, dropdown menus or buttons which the agent can interact with and which the system can use inputted information at later instances in the process. For example, the caller (also referred to as a client herein) can provide a name, phone number, and specific information about a product or service for which the caller is interested. This information is then saved in a database and used to populate emails or other messages to the caller; emails, messages, or live viewing for vendors; and emails, messages, trackers, or live viewing for system administrators. In various embodiments of the systems and methods described herein different or additional information can be tracked as appropriate for the particular embodiments. Also displayed on the agent's screen are a listing of vendor departments and associated numbers or other contact information 210, including whether the departments are open or closed and time schedules.

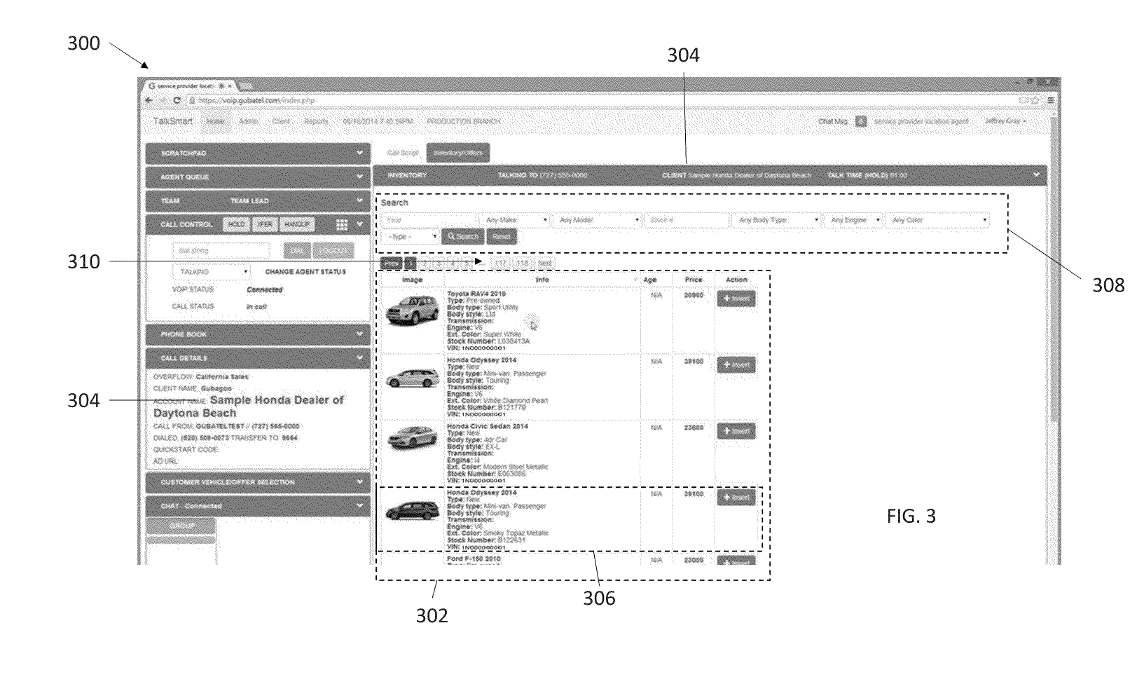

Turning to FIG. 3, a diagram of an example embodiment of an agent interface 300 including inventory listing 302 in accordance with the present invention is shown. In the example embodiment the agent is representing a vendor “Sample Honda Dealer of Daytona Beach,” indicated by a vendor name 304. The system provides for agent access to a database containing inventory information shown in inventory listing area 302. In the embodiment shown, the agent has selected to view inventory listing area 302 which includes motor vehicles and pertinent information such as make and model, new or used, body style, engine, color, dealer numbers, age, price, action and Vehicle Identification Number (VIN) in a product information area 306. In various embodiments the inventory information database can be updated regularly such as daily, weekly, hourly, or upon each transaction, such that it is a live or relatively close to live update of products currently in the vendor's inventory. The agent interface 300 shown also includes functionality to search 308 for inventory by production year, make model, dealer numbers, body styles, engine type, color, and others. Results can be displayed as a series of pages or in other appropriate manners using selectable navigation buttons 310.

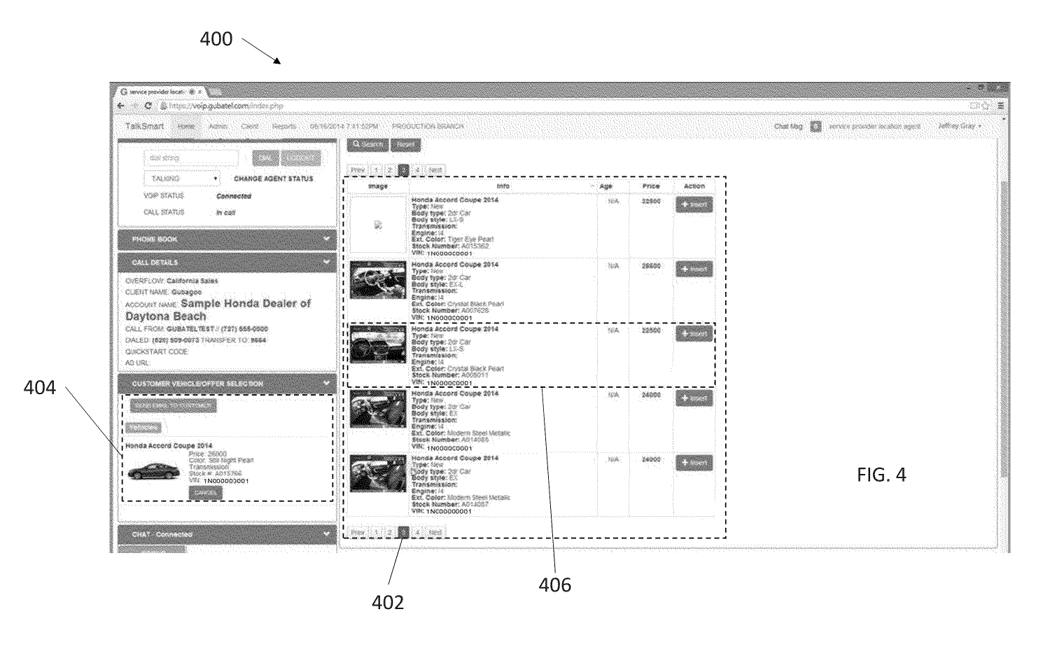

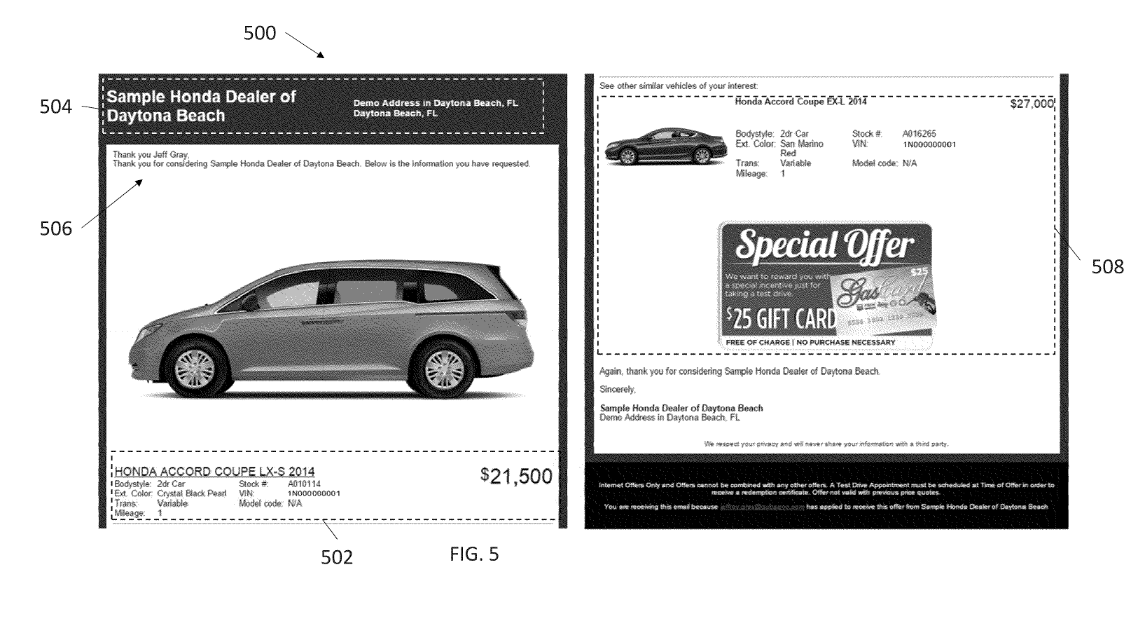

Turning to FIG. 4, a diagram of an example embodiment of an agent interface 400 including a targeted search 402 of inventory in accordance with the present invention is shown. In the example embodiment an agent has input caller requests into the system and the system is displaying an inventory listing of targeted search 402 of Honda Accord Coupe 2014 shown as available in the database. A price listing is shown for each option 406 and action buttons are shown such for a particular offer as insert or remove from a client email or other notification. The screen has a section for Customer Vehicle/Offer Selection 404 which displays to the agent what the agent has selected in accordance with the client's desire. Although only one selection is shown it should be understood that numerous selections can be included in a single email or notification.

Turning to FIG. 5, a diagram of an example embodiment of a client email 500 (split in half) including a targeted offer in accordance with the present invention is shown. In an example embodiment, the system can generate an email 500 or other notification such as SMS, postal mail, social media post, or others based on the client's information as relayed to the system through the agent. The example email 500 shown includes price and other vehicle information 502, vendor information 504 including name, address, phone numbers or other information. The email 500 can be personalized with the client's name 506 or other information the agent inputted into the system in addition to phone number or other identifying information the system may have collected or stored in a database. Agents can have the option to include special offers in email communications to clients or special offers, deals, or other sales information can be automatically included in emails based on system criteria such as whether the item is new or used, the make or model, or others.

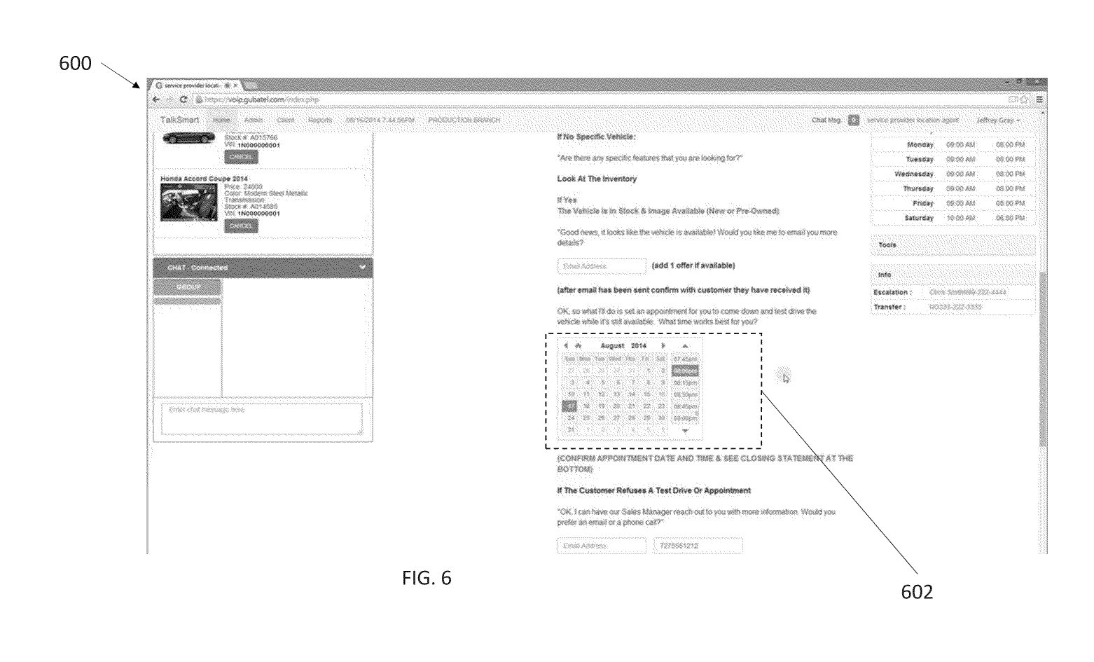

Turning to FIG. 6, a diagram of an example embodiment of an agent interface 600 including appointment setting in accordance with the present invention is shown. In the example embodiment the system provides a calendar 602 which an agent can use to schedule appointments. The calendar 602 can include timeslots as well as dates. The calendar can be linked to a database and can be updated from the vendor side as well in order for the system to maintain a current list of open timeslots.

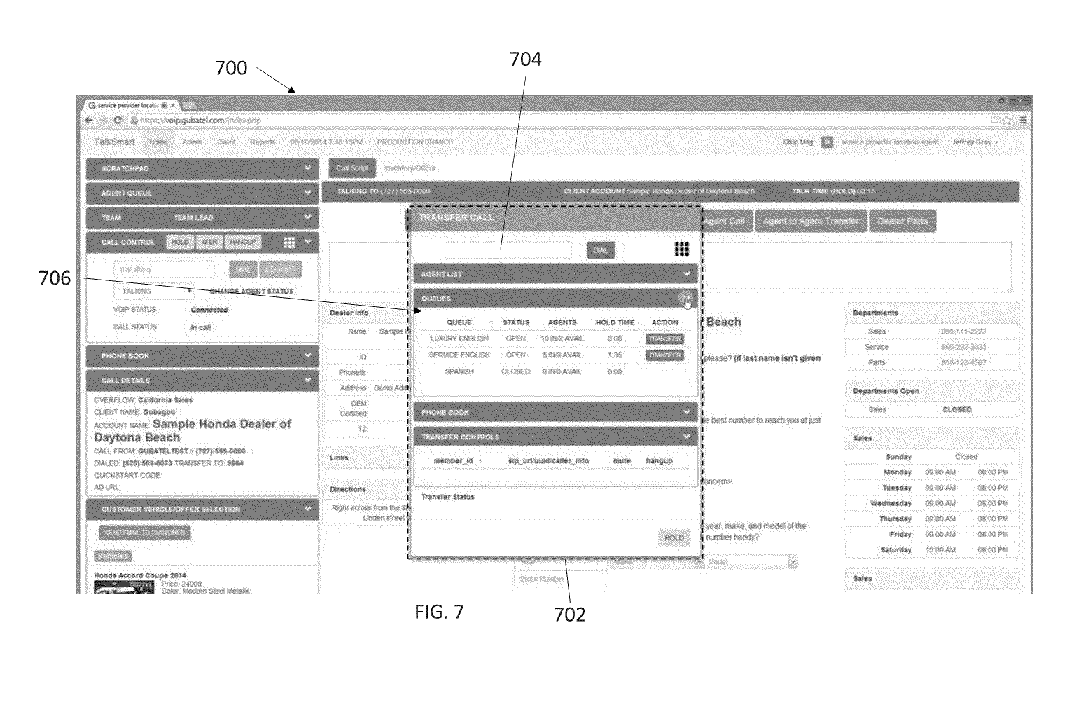

Turning to FIG. 7, an example embodiment diagram of an agent interface 700 including call transferring in accordance with the present invention is shown. In the example embodiment an agent has selected a transfer call option from the user interface 700. The transfer call option provides a window 702 which allows the agent to transfer the call to another agent via direct entry of a number in field 704, a queue 704, a phone book entry, or another location or individual.

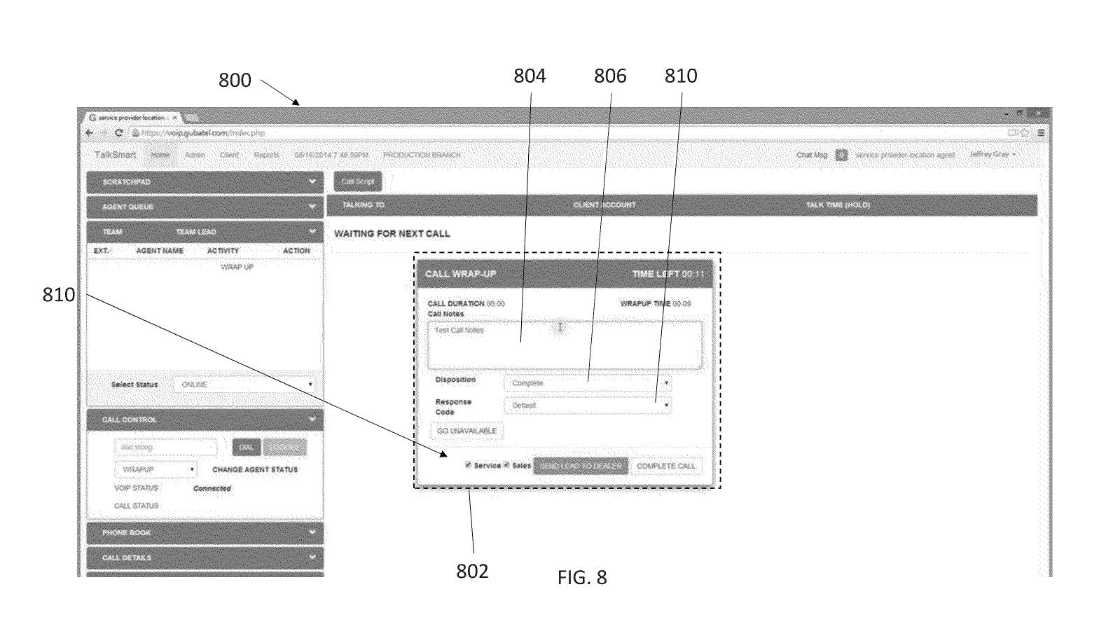

Turning to FIG. 8, a diagram of an example embodiment of an agent interface 800 including a call wrap-up in accordance with the present invention is shown. In the example embodiment the system displays a call wrap-up window 802 which allows an agent to input notes in field 804 about the call and can also include drop down menus including a disposition menu 806 such as “complete” or “call back” and a response code menu 808 such as a “hot lead” after a call has ended. The call wrap up can be sent to a sales, service or other appropriate department or group of departments using buttons 810.

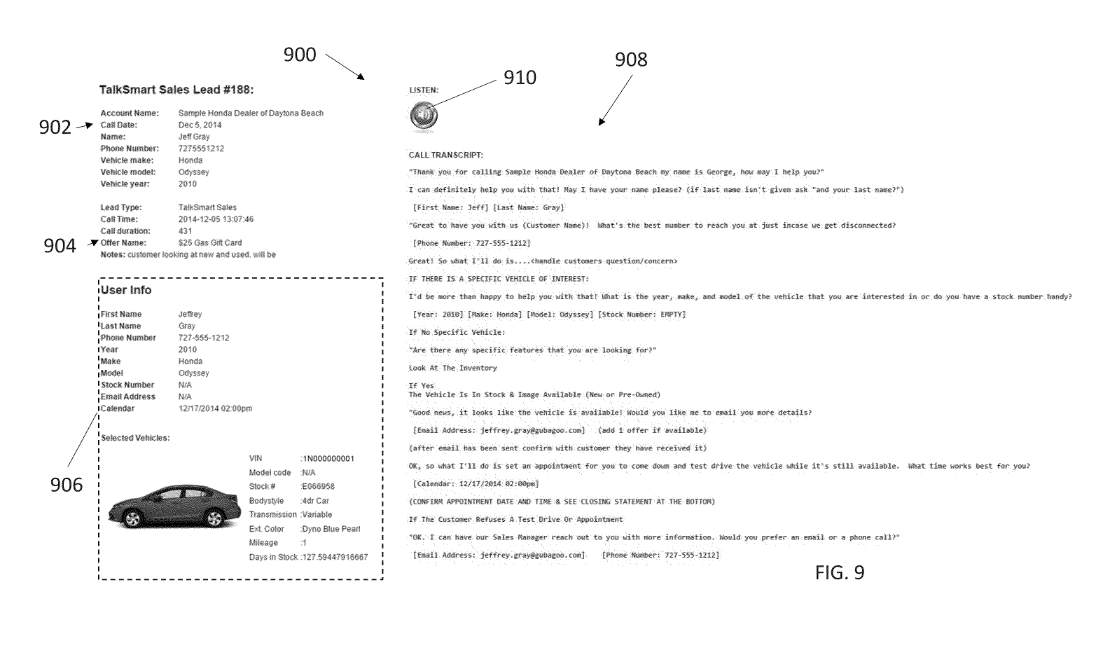

FIG. 9 is a diagram of an example embodiment of a sales lead report 900 for a vendor in accordance with the present invention. In the example embodiment a sales lead report 900 can include information such as the vendor information 902, call information 904 such as time and duration of a call, offers relayed to the client and client information 906. In addition a call transcript 908 can be provided to the vendor as well as an audio recording file of the call which can be saved in a database for the vendor to listen to at the vendor's convenience by selecting a listen button 910.

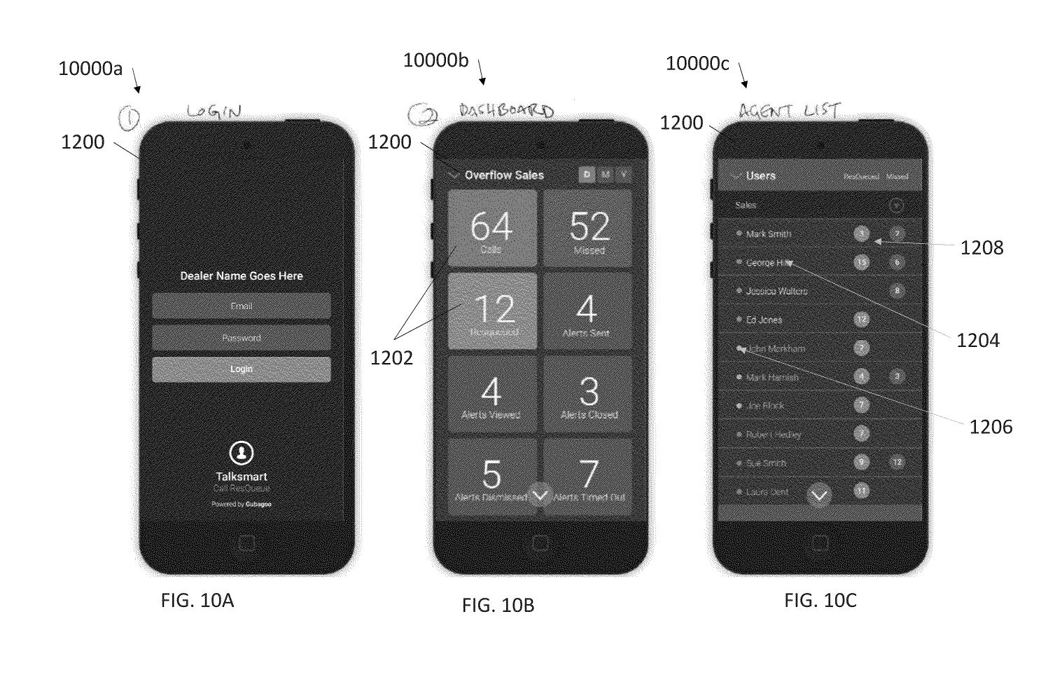

A call takeover application will be described with respect to FIGS. 10-14. This application is also referred to as a resq app herein. Users can include dealers who are also referred to as vendors herein; administrators who can be system operators and internal dealer operators; and website users who can be customers or clients. This application has various features standard features grouped by the user including: Operator can notify a specific user group (department) or individual user about an inbound call; Operator can notify a specific user group (department) or individual user about an inbound chat/sms; Operator can view call transfer requests from a user; Operator can view chat/sms transfer requests from a user; Operator is able to transfer a call to a user; and Operator is able to transfer a chat/sms to a user.

Dealer user receives an alert on phone when operator sends notification; Dealer user can view a list of calls/chats/sms that are currently active and past and have been sent to them or their department; Dealer user can view customer information and agent notes associated with any active or past call in call list; Dealer user can view chat transcript associated with any chat in active or past chat list; Dealer user can request that a call be transferred to them after notified by agent that call is taking place; Dealer user can request that a chat/sms be transferred to them after notified by agent that chat is taking place; Dealer user is able to view a real-time list of current chat sessions; dealer user should be able to send an SMS in a previously closed SMS conversation; dealer user will be able to search and view inventory; dealer user will be able to search and view inventory; dealer user will be able to send a vehicle image and associated vehicle data to the chat customer; dealer user will be able to view offers; dealer user will be able to send an offer in a chat to customer; dealer user will be able to set my status to online or unavailable; dealer user will be able to view my metrics/stats based on my performance; dealer manager will be able to view metric/stats for all of my account based on day, month, year; dealer manager will be able to view metric/stats for all of my individual staff, grouped by department; and dealer user able to send lead after a call/chat/sms; dealer user can add wrapup notes consolidated with agent notes.

After call is transferred, dealer user can see agent notes and customer information associated with current active call; and After chat is transferred, dealer user can see agent notes and customer information associated with current active chat.

Account managers can create users and user groups in admin portal; and account manager able to add a lead routing address for txt leads and adf leads.

If the system has a backlog, the following features are available: dealer user able to send a photo from phone camera to chat/sms customer; dealer user able to email or sms a photo from phone camera to call resq customer; dealer user able to send a whisper message (internal message) to chat operator when viewing a chat (and vice versa); dealer user able to send a whisper message to a call operator when viewing a call and vice-versa; dealer user can transfer a chat to another chat resq dealer user; dealer user can transfer a call to another call resq dealer user; dealer user can send an email to customer with offers from in app; dealer user can send an email to customer with inventory from in app; user permission levels (department heads vs GM); dealer user able to select a phone to which a call is transferred; dealer user, when engaged in a chat with a customer in the resq app, able to request a video session; and dealer user, when engaged in a chat with a customer in the resq app able to request a voice session.

Website chat user, when engaged in a chat with a dealer in the resq app, able to request a video session; website chat user, when engaged in a chat with a dealer user in the resq app, able to initiate a voice session with dealer user; website user, if dealer is hybrid able to request a video session from website; website user, if dealer is hybrid able to request a voice session from website; and website user, if dealer is hybrid able to select the department to have a session with.

Administrator can schedule user to be offline and online; and administrator can enable notifications for users that are inactive for a certain period of time.

FIGS. 10A-C are diagrams of an example embodiment of a vendor login 10000a, dashboard 10000b and agent list 10000c for a vendor mobile application in accordance with the present invention are shown respectively. In the example embodiment a vendor can monitor portions of the system from a wireless device such as a smartphone 1200. A login screen 10000a provides a vendor employee the opportunity to log in to the system using an identifier such as an email and a password. A dashboard screen 10000b can show a system status. The dashboard screen shown has buttons 1202 to view all calls, missed calls, retrieved calls, alerts sent, alerts viewed, alerts closed, alerts dismissed, alerts timed out and others. An agent list screen 10000c shows a listing 1204 of agents and their status 1206 such as available, unavailable, busy, away, or offline which can be shown in the form of colors or other indicators. Also, retrieved calls and missed calls 1208 can be seen on an agent by agent basis in the form of colors or other indicators and associated numbers.

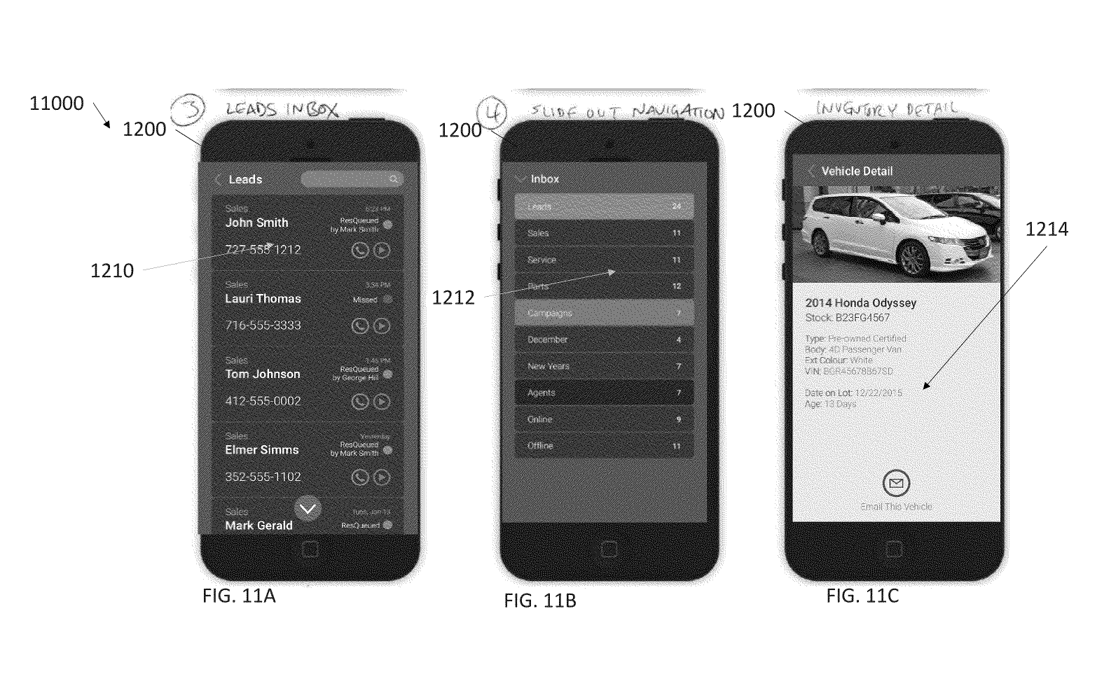

Turning to FIGS. 11A-C, are diagrams of an example embodiment of a lead inbox 11000a, slide out navigation 11000b and inventory detail 11000c for a vendor mobile application in accordance with the present invention are shown respectively. A lead inbox 11000a can include information 1210 including names of leads who have called in recently in addition to their phone numbers and recordings of calls, along with which agent assisted each lead. A slide out navigation 11000b can provide easy navigation for a user to view important information 1212 such as leads, sales calls, service calls, parts calls, campaigns, agents, and others as appropriate. An inventory detail screen 11000c can show information 1214 related to inventory stored in an inventory database as well as an option to email particular listings to recipients.

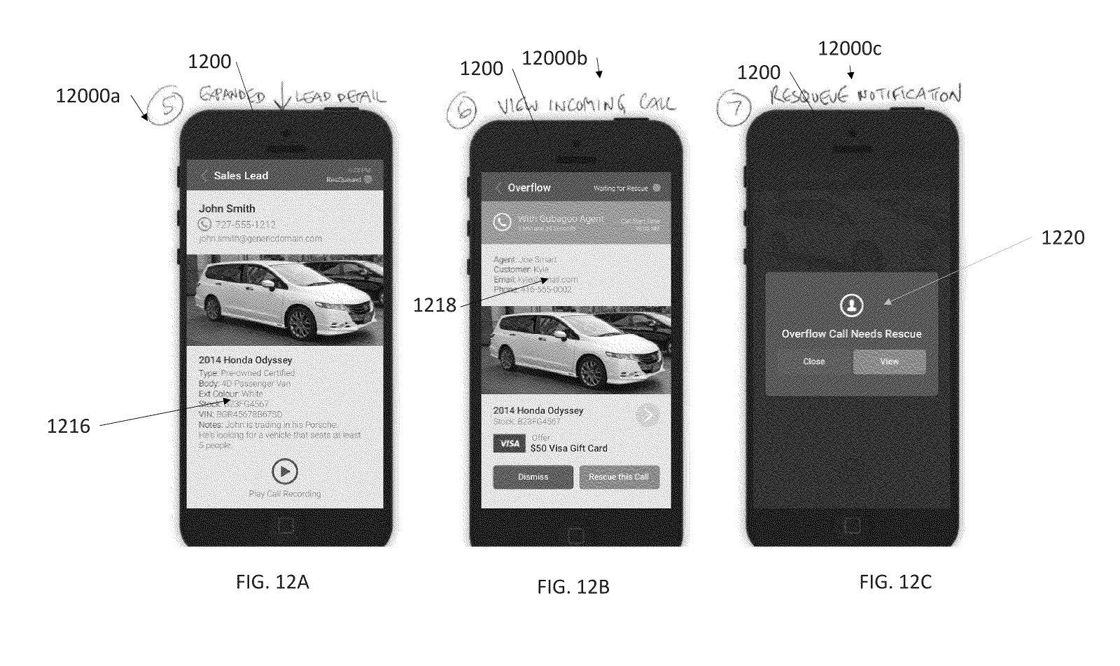

Turning to FIGS. 12A-C, are diagrams of an example embodiment of an expanded lead detail 12000a, incoming call viewer 12000b and call takeover screen 12000c for a vendor mobile application in accordance with a the present invention are shown respectively. In the example embodiment a more detailed lead information screen 12000a can be viewed by a user that includes information 1216 such as the lead name and contact information, the product or service the lead is interested in, as well as a recording of the lead call. An incoming call viewer 12000b can display a call information screen 12000b with information 1218 such as which agent is currently fielding the call, information about the caller and the interests of the caller, offers, and an option to take over the call. A call takeover screen 12000c can include information 1220 in the form of a push notification from a system server that a call is important and could or should be taken over with the option to view information about the call and takeover or to close the notification.

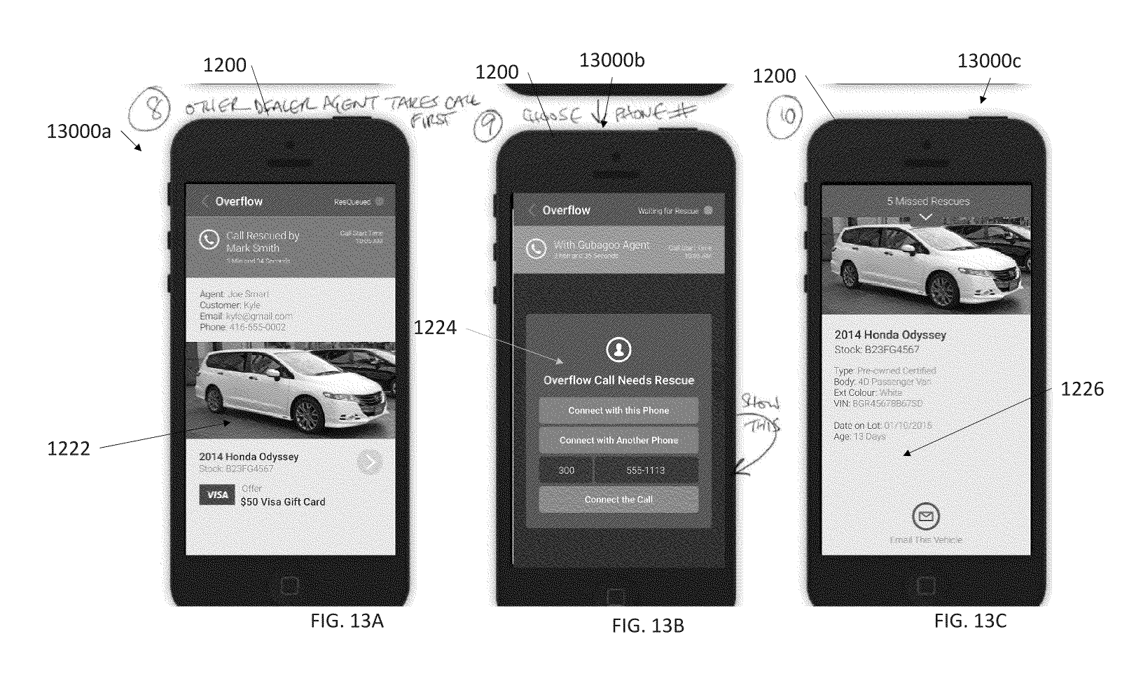

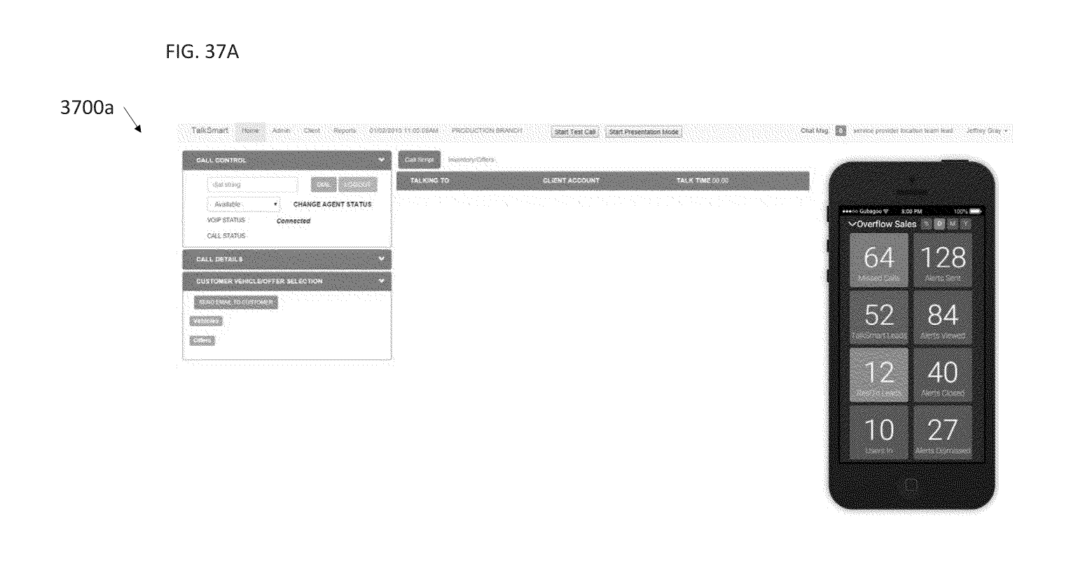

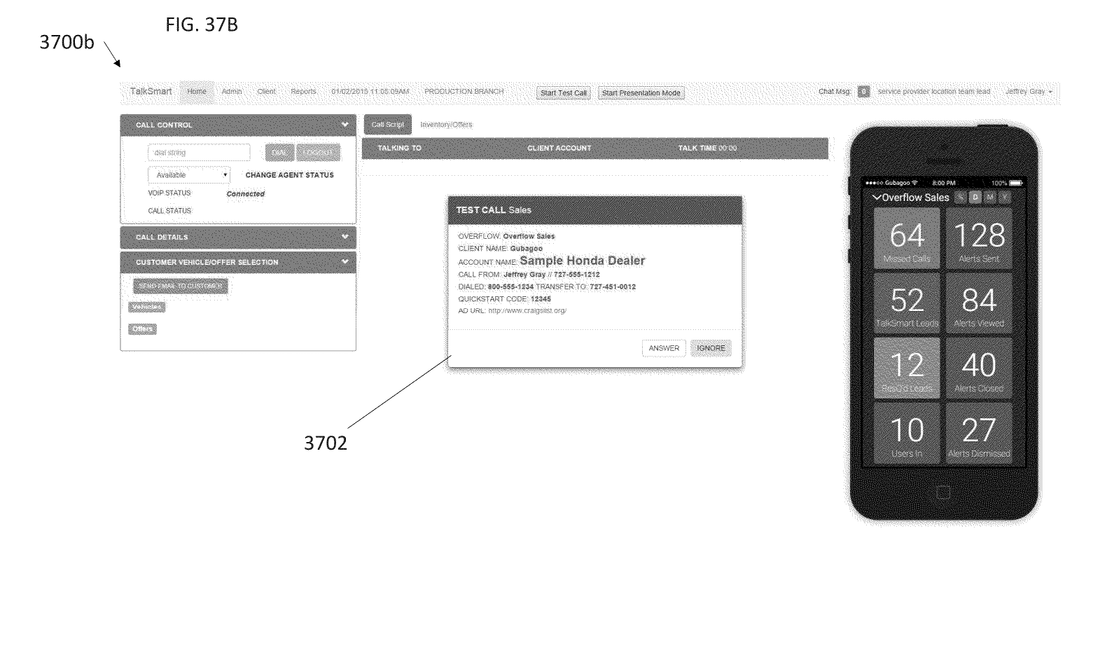

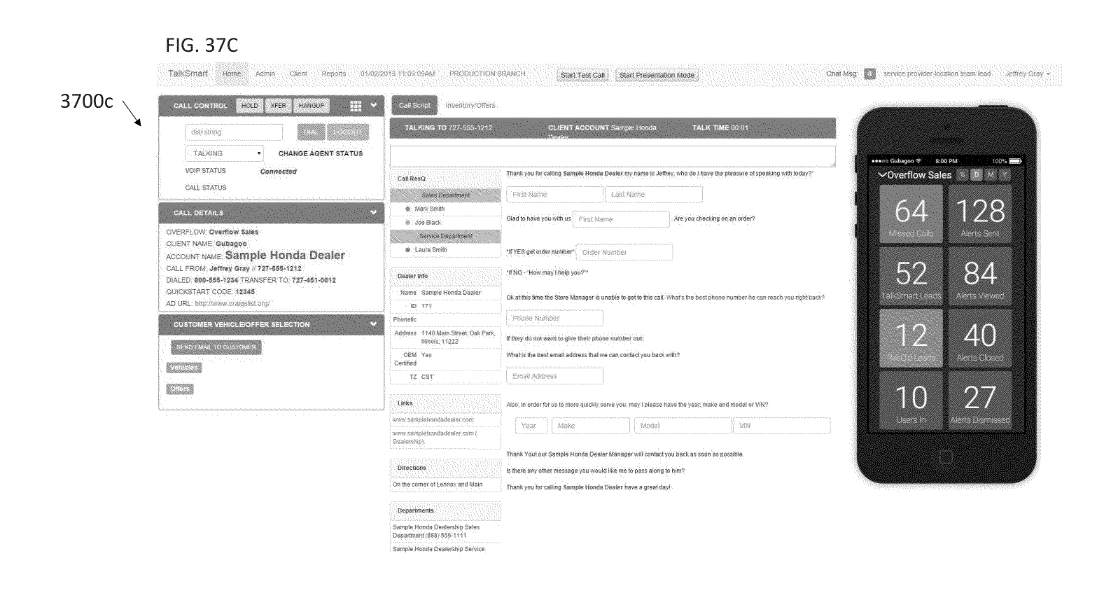

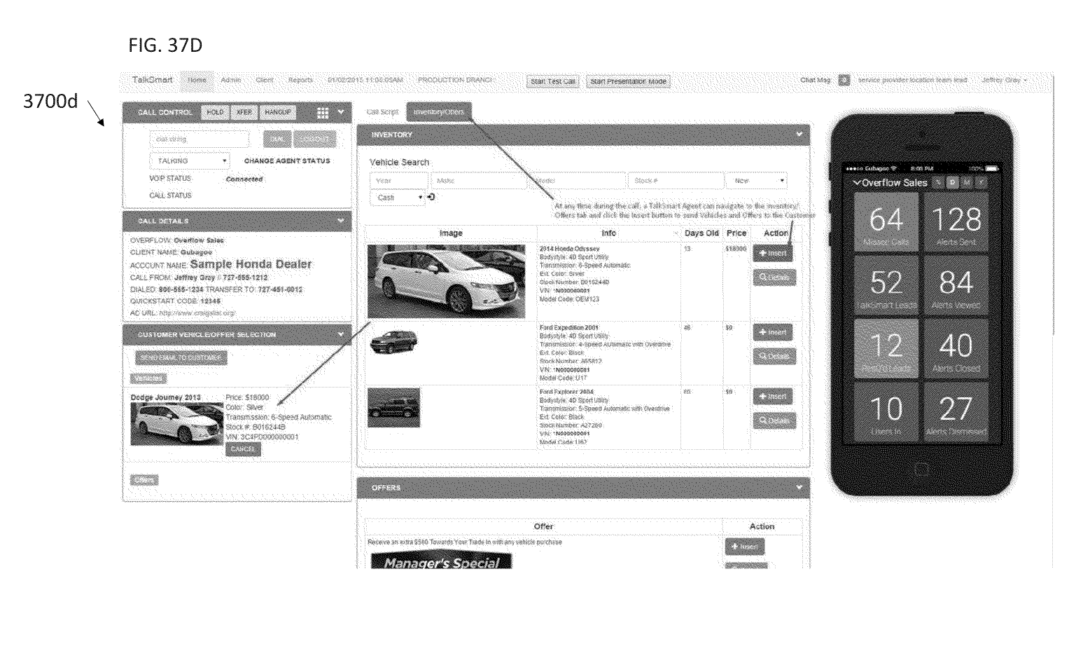

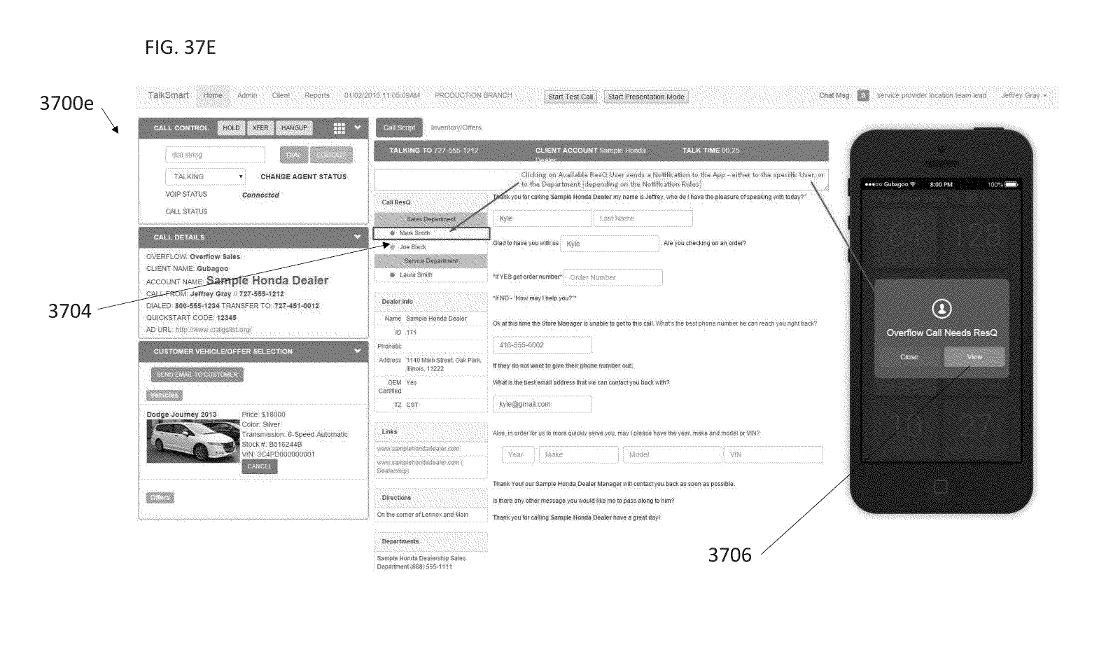

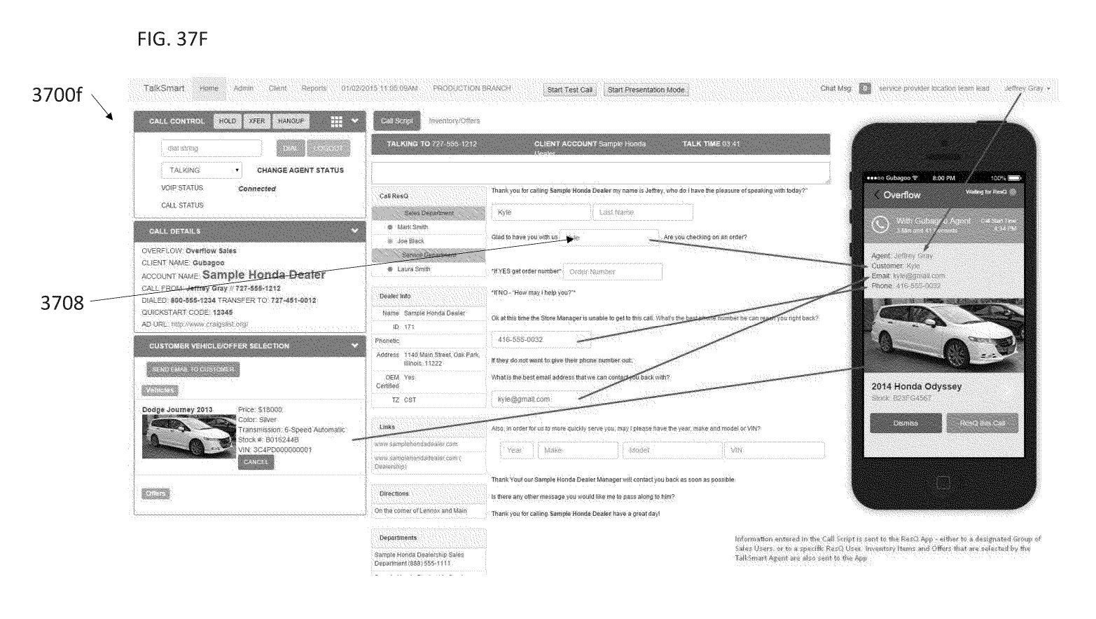

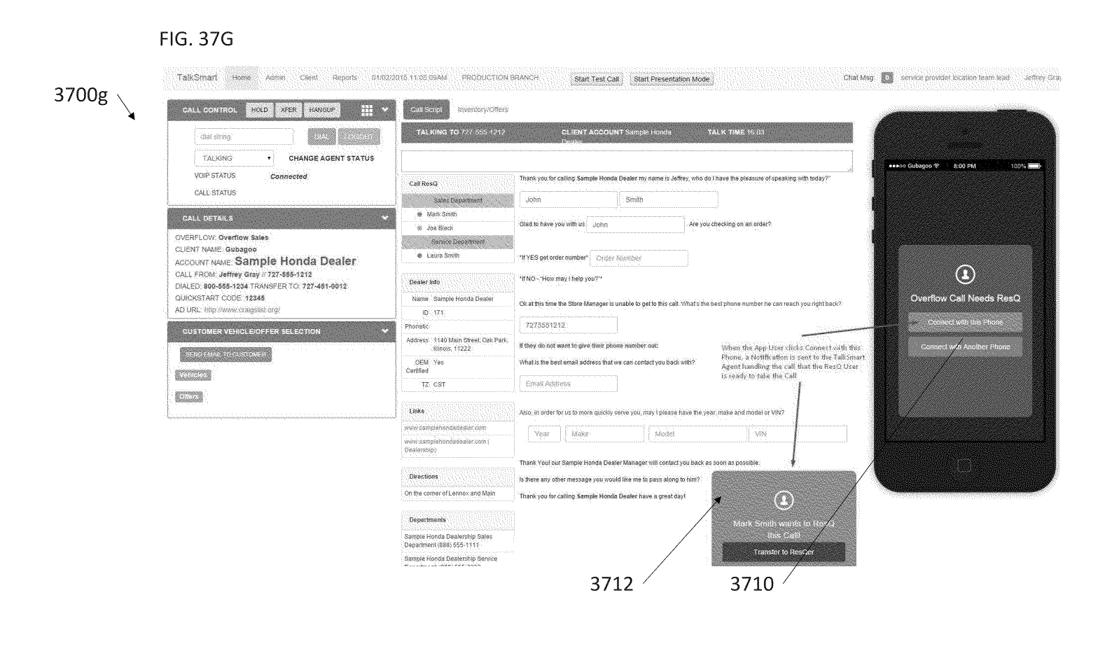

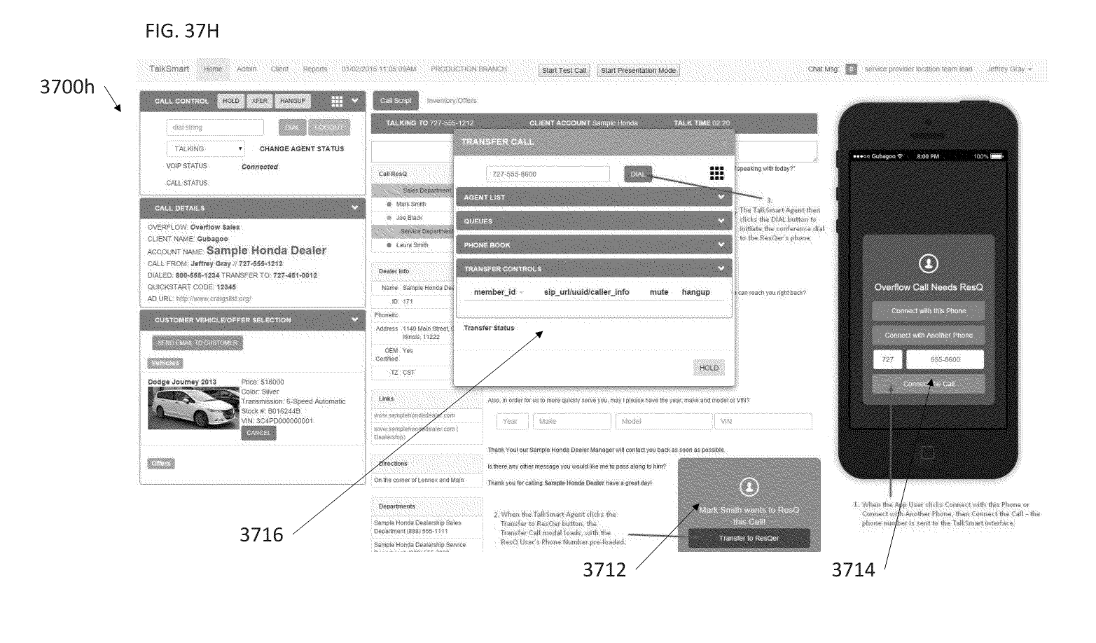

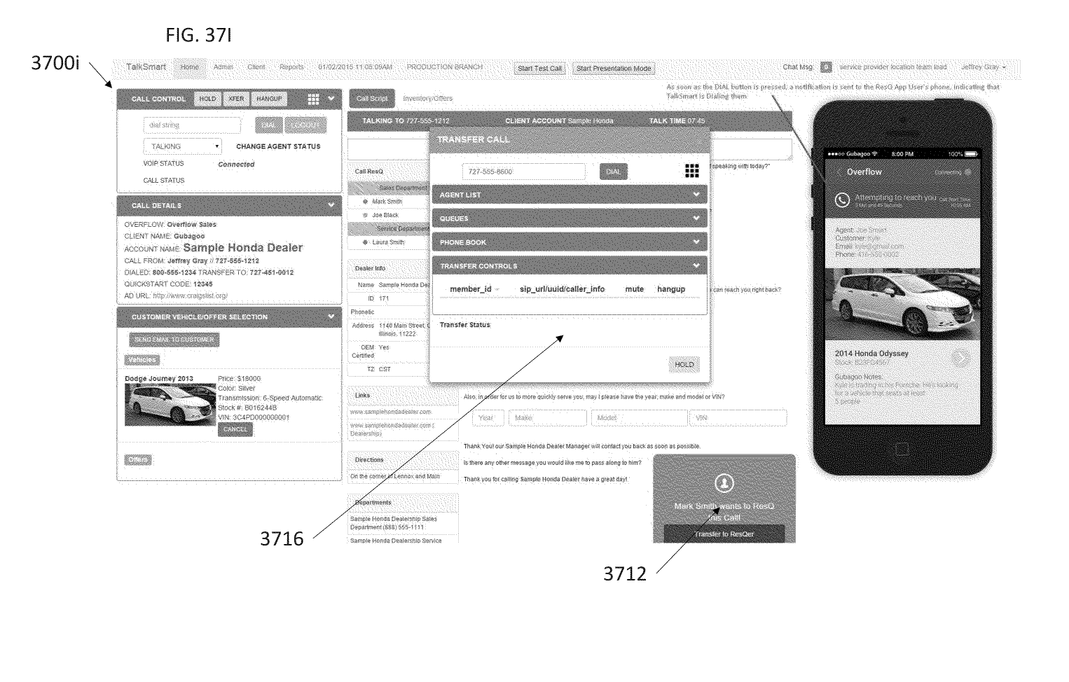

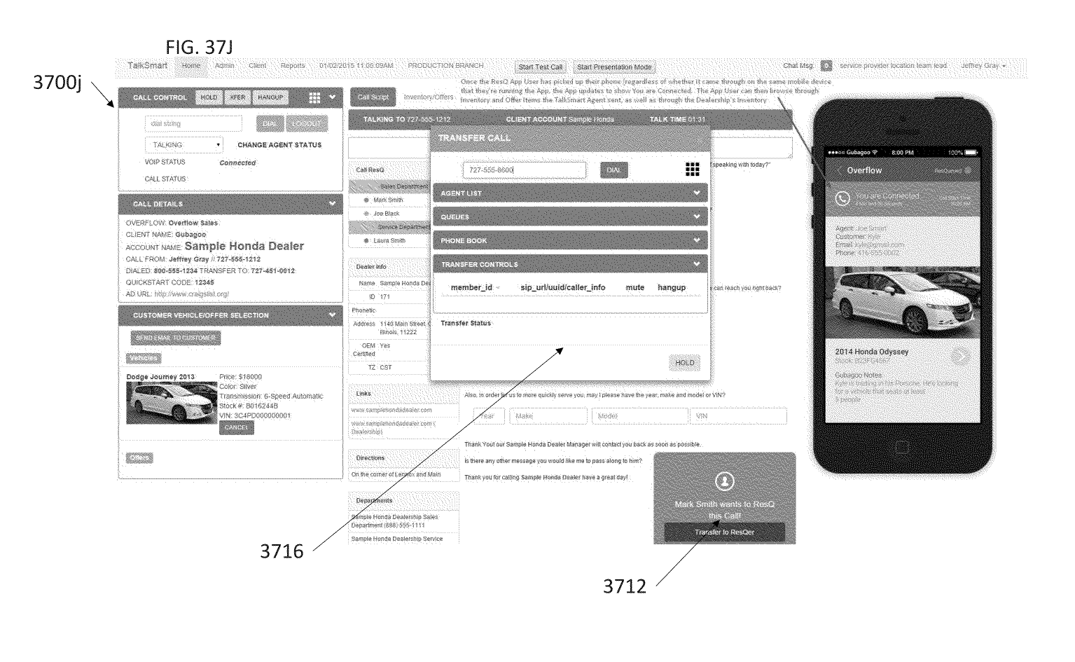

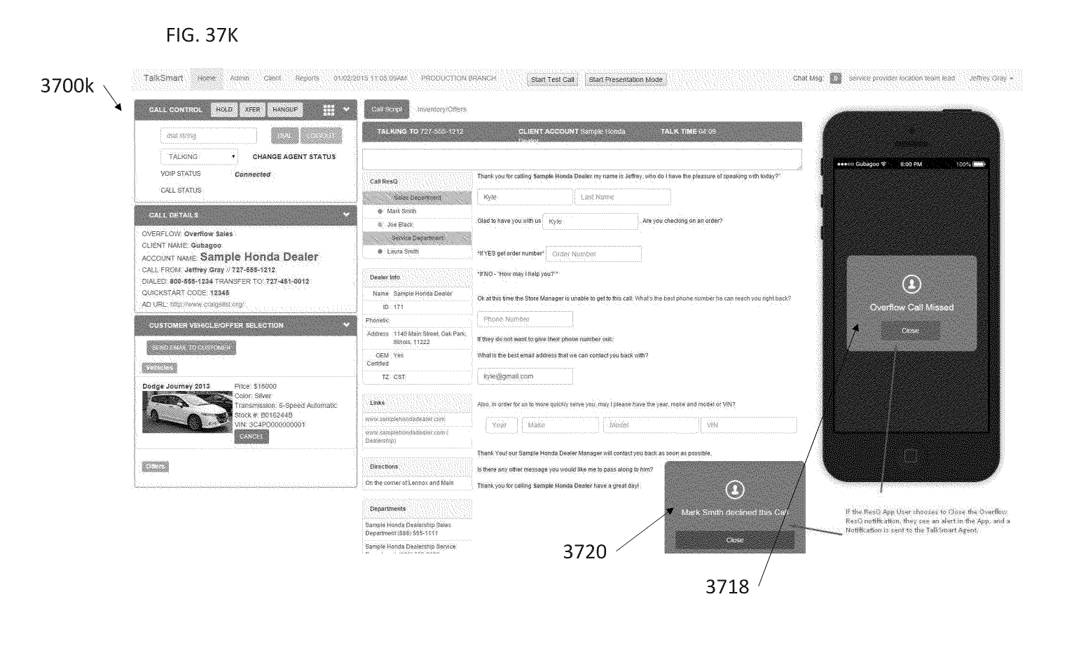

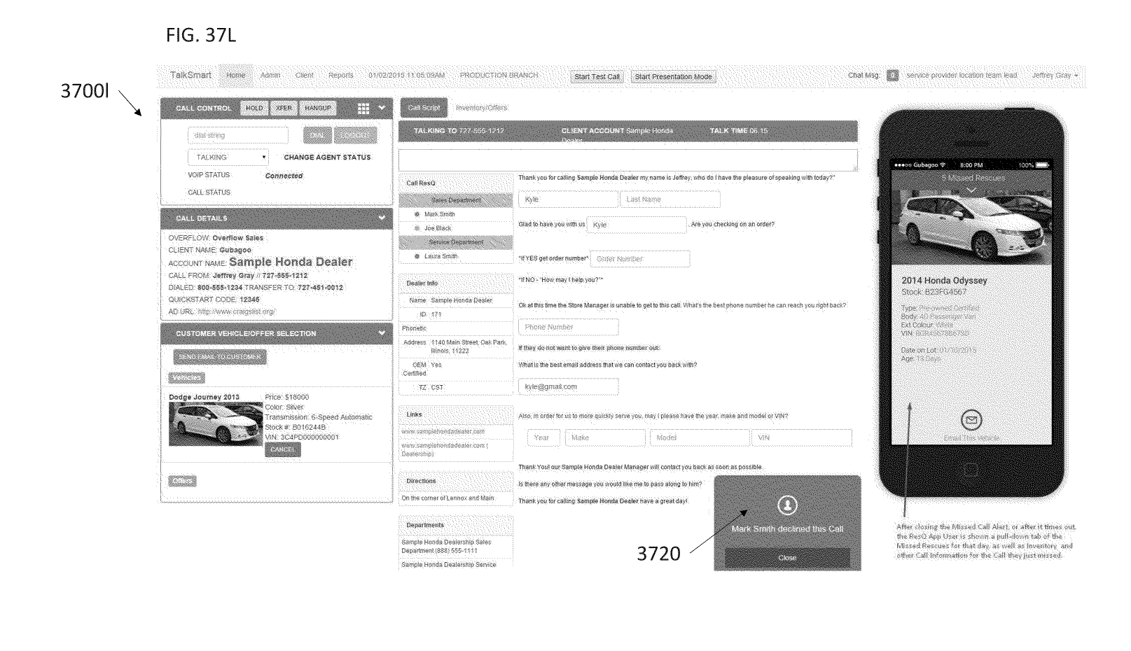

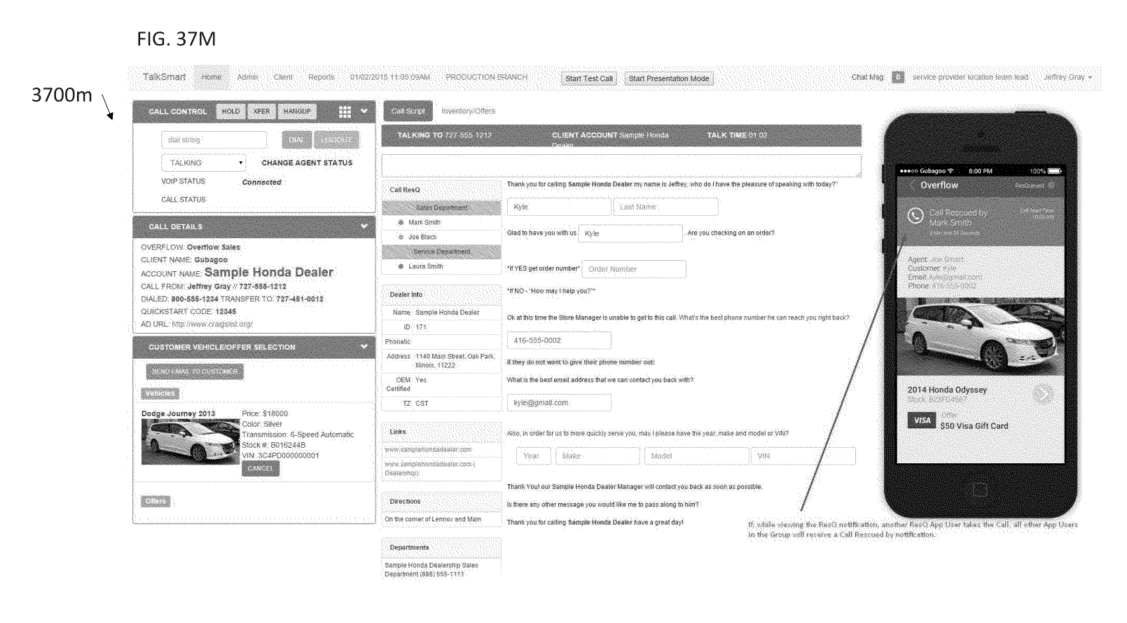

Turning to FIGS. 13A-C, are diagrams of an example embodiment of a takeover viewer screen 13000a, call transfer screen 13000b and takeover details screen 13000c for a vendor mobile application in accordance with the present invention are shown respectively. In takeover viewer screen 13000a, information 1222 pertinent to the customer can be shown in addition to the agent who was handling the call before it was taken over. A call transfer screen 13000b can include options in a window 1224 such as taking over the call with the device the user is using, taking over the call from another telephone or other smart device, or transferring the call to another number. A takeover details screen 13000c shows information 1226 about a declined call, described in more detail below with regard to FIG. 37L.

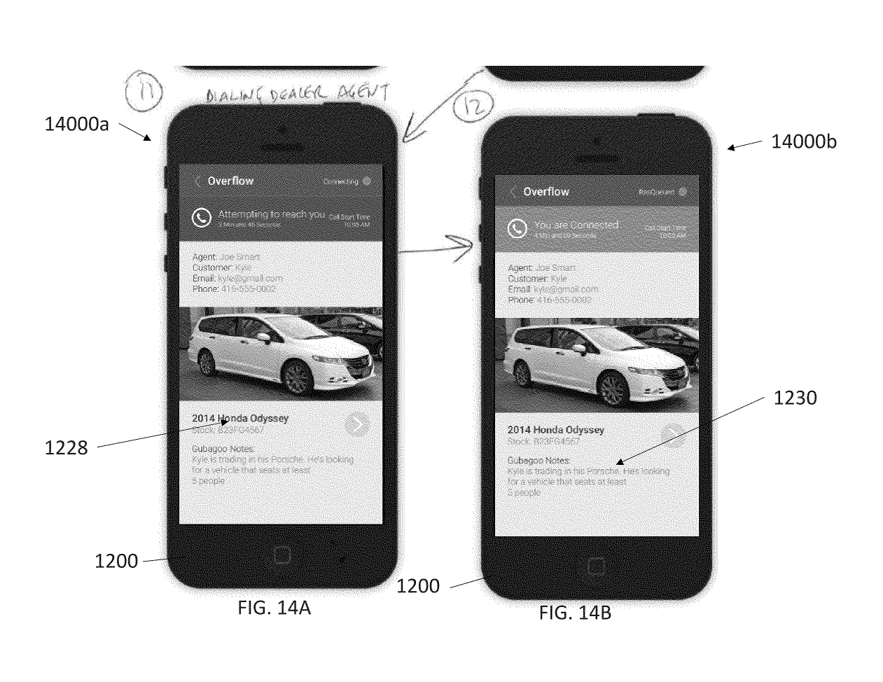

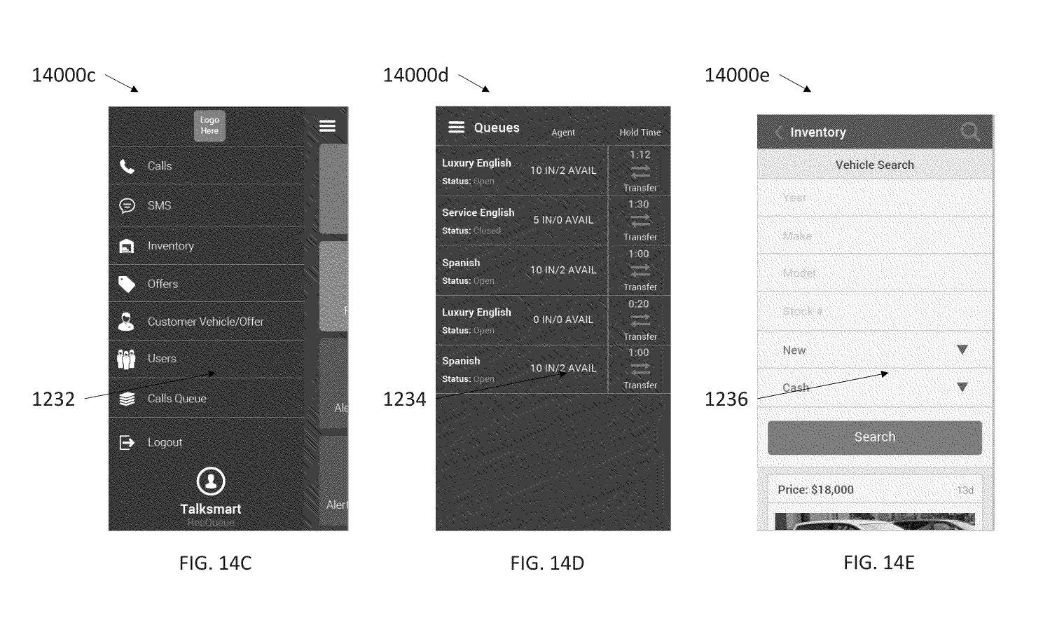

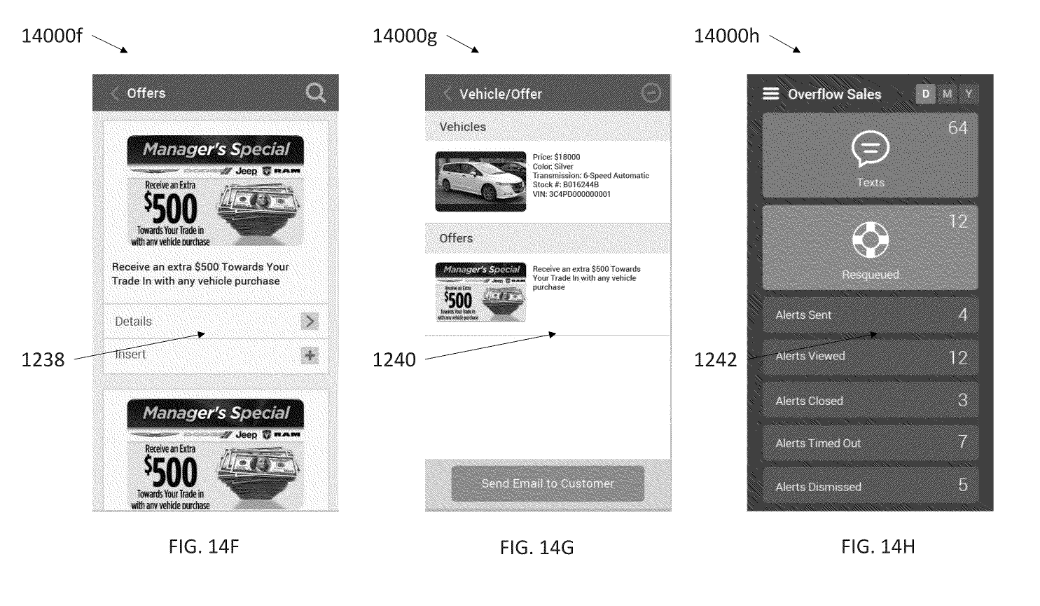

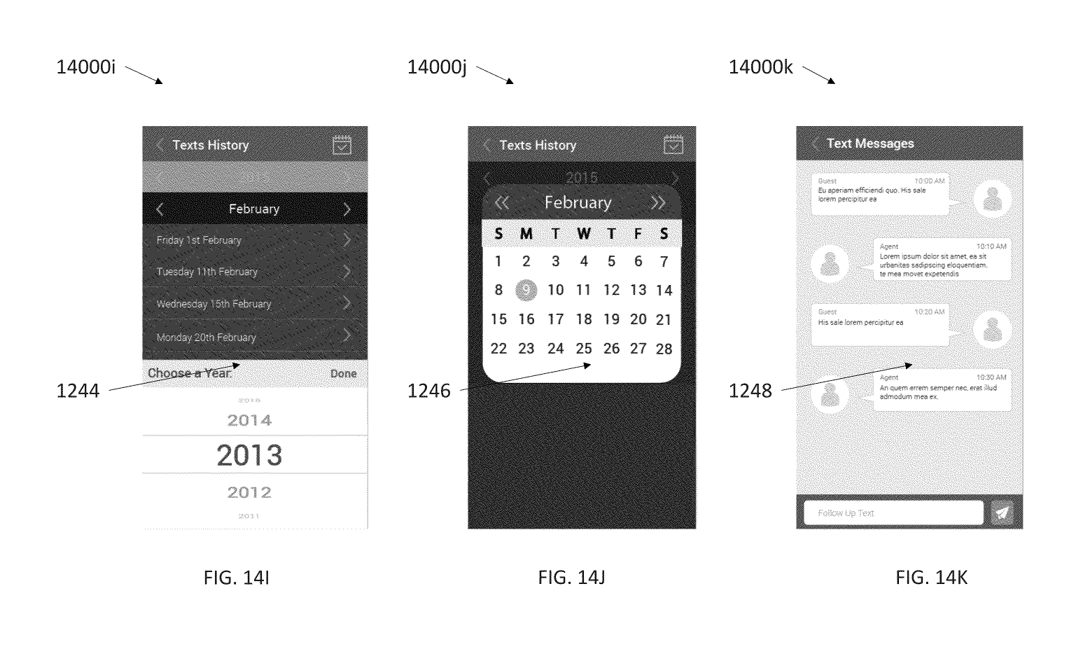

Turning to FIGS. 14A-B, a diagram of an example embodiment of an incoming call screen 14000a and connected call screen 14000b for a vendor mobile application in accordance with the present invention are shown respectively. An incoming call screen 14000a can show information 1228 about a call that is being made to a number associated with the user device. This can include Agent, Customer, Email, Phone number, Information, Notes and call information. A connected call screen 14000b shows information 1230 about a call that is currently connected including similar information.

Turning to FIGS. 14C-K, diagrams of example embodiments of a menu screen 14000c, queues screen 14000d, vehicle search screen 14000e, special offers screen 14000f, combination screen 14000g, overflow text alerts screen 14000h, text history screen 14000i, text calendar screen 14000j and texting screen 14000k for a vendor mobile application in accordance with the present invention are shown respectively. A menu screen 14000c can show a menu 1232 to navigate the application. This can include Calls, SMS, Inventory, Offers, Customer Vehicle/Offer, Users, Calls Queue, and Logout buttons. Queues screen 14000d can show information 1234 about calls that are being made to a number associated with the vendor or departments of the vendor. This can include Luxury English, Service English, Spanish, agent numbers, average hold time and other information. Vehicle search screen 14000e can show search functionality 1236 allowing a user to search for inventory with the user device. This can include year, make, model, stock number, new offerings, cash prices, and other information. Special offers screen 14000f can show special offers information 1238 that the user can add to an offer to a customer through the user device. This can include amounts, details, options to add and other information. Combination screen 14000g can show offers and vehicles information 1240 to present to a customer through the user device. This can include an option to contact the customer, such as through email with the information. Overflow text alerts screen 14000h can show information 1242 about texts that have been transmitted and received by the system. This can include Texts, Requeues, alerts sent, alerts viewed, alerts closed, alerts timed out and alerts dismissed information. Text history screen 14000i can show information 1244 about texts that have been received and transmitted by the system. This can include functionality to search for information 1244 using scroll wheels, buttons and other functionality. Text calendar screen 14000j can show a calendar 1246 about texts that have been received and transmitted by the system and functionality to select dates using buttons. Texting screen 14000k can show a conversation 1248 about currently occurring or previously transmitted and received by the system. This can include functionality to send text messages.

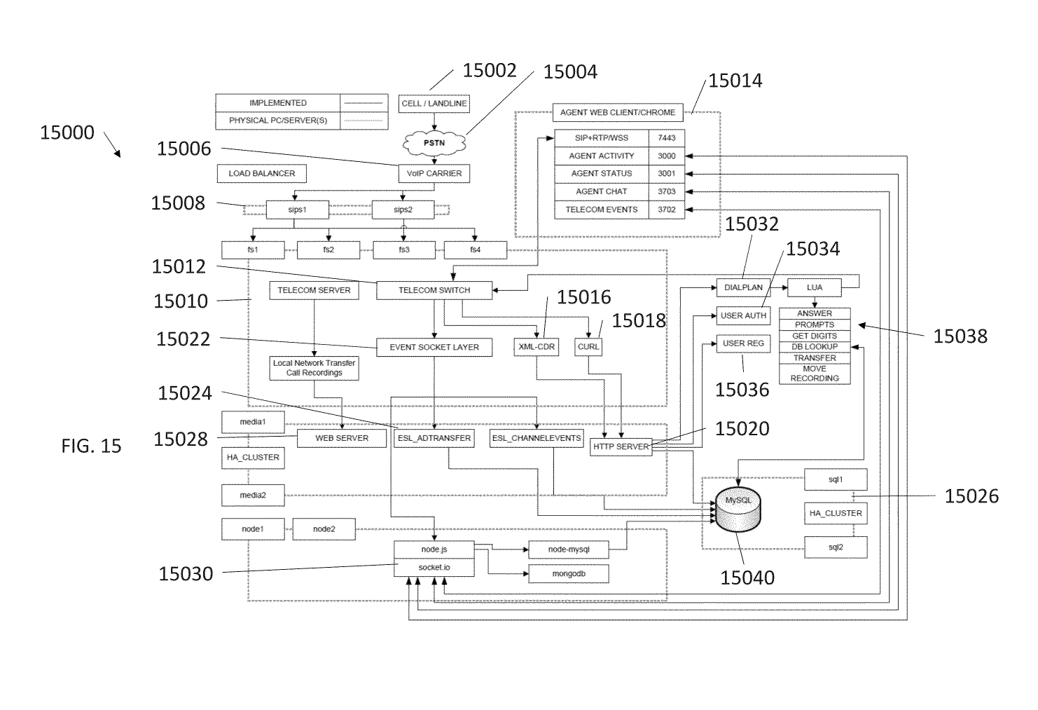

Turning to FIG. 15, an example embodiment of a system architecture 15000 in accordance with the present invention is shown. In the example embodiment, a cell phone or landline 15002 can make a call via a PSTN 15004 which can route the call via a VoIP carrier 15006 to a SIP (Session Initiation Protocol) server 15008 and then to a telecom server 15010. The telecom server 15010 can then route the call to or via a telecom switch 15012 which can interact with an agent web client 15014 with varied functionality as described below. The telecom switch 15012 can also update an XML-CDR (Call Detail Record) 15016 and CURL 15018 which can update an HTTP server 15020. The Telecom Switch 15012 can also send data via an event socket layer 15022 to an ESL_Adtransfer 15024 which can then update a SQL Server 15026. ESL_Adtransfer 15024 can be a PHP daemon process which has logic to listen for Events published by the telecom switch 15012, and upon receiving those events can take specific actions. These can include storing information in a database (e.g. 15026), sending out real-time notifications to a notification service, sending call information to an HTTP service packed as XML or JSON and performing system utilities such as transcoding a call recording to MP3 or other format.

Meanwhile, the telecom server 15010 can transfer call recordings to a web server 15028. The Agent web client 15014 can also interact via sockets 15030 with the SQL server 15026. The HTTP server 15020 can interact with the SQL server 15026 in addition to interacting with a DialPlan 15032, User Authorization 15034 and User Registration 15036. The DialPlan 15032 can implement actions via object oriented programming with the telecom switch 15012 and also perform actions 15038 such as answering calls, delivering prompts, receiving digits, performing data transactions with databases such as a SQL server database 15040, transferring calls and moving recordings.

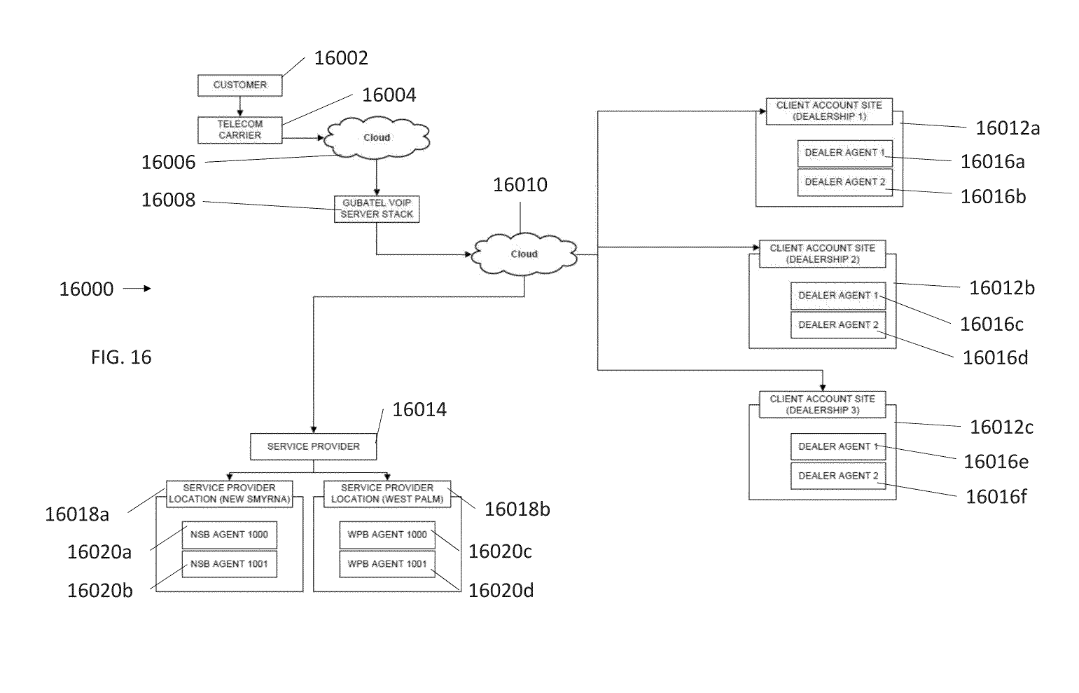

Turning to FIG. 16, an example embodiment of a system architecture 16000 in accordance with the present invention is shown. In the example embodiment, a customer 16002 can make a call using a device which is routed via a telecom carrier 16004 to a cloud computing service 16006. This service 16006 can route the call via a VoIP server stack 16008 to another or the same cloud computing service 160010 which can route the call to any of a number of appropriate vendors such as 16012a, 16012b, 16012c and a service provider 16014. The vendors 16012a, 16012b, 16012c can be located at unique locations and include numerous vendor employees or agents 16016a, 16016b, 16016c, 16016d, 16016e, 16016f who can answer the call. Likewise, the service provider 16014 can route the call to service provider locations 16018a, 16018b which can be unique and which can have individual employees or agents 16020a, 16020b, 16020c, 16020d who can answer the call and interact with the system.

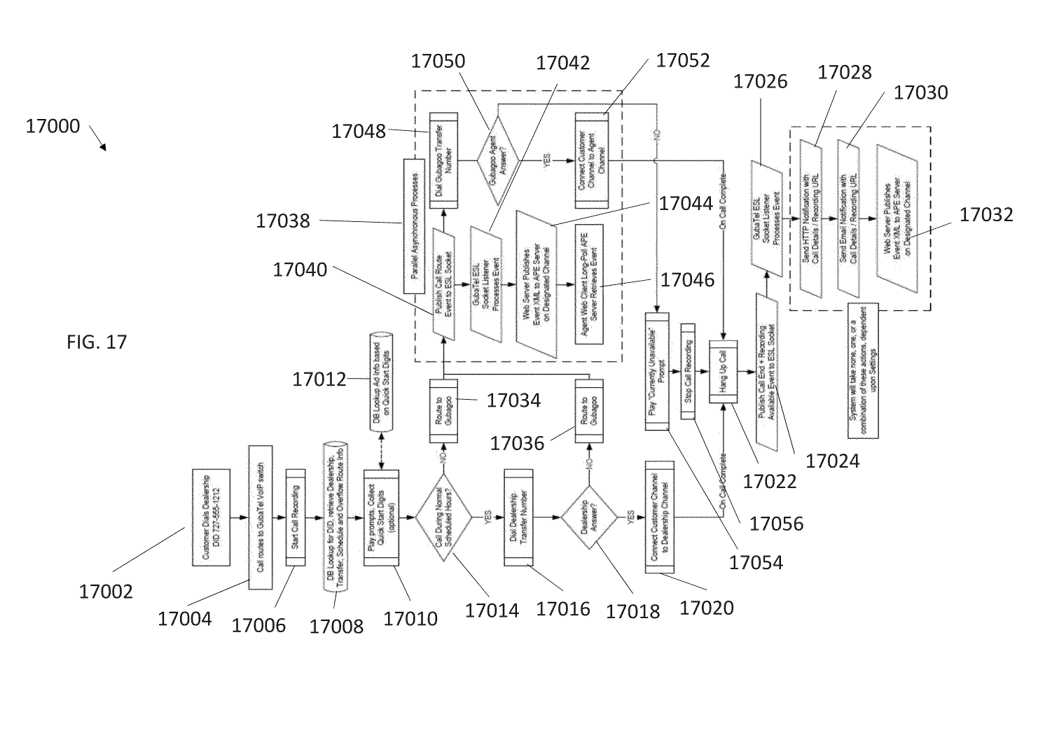

Turning to FIG. 17, an example embodiment of a prior art vendor call routing overflow flow chart 17000 as may be implemented by the system in accordance with the present invention is shown. In the example embodiment a customer 17002 can call a vendor DID and the call can be routed to a system VoIP 17004 switch which begins a call recording 17006. The system can then perform a database lookup sequence 17008 for the DID, retrieve vendor transfer data, scheduling, overflow route, and other operations. The system can then begin a process 17010 of prompting the customer via stored routines and collect quick start digits in addition to a process 17012 of looking up advertising information associated with the call based on quick start digits if appropriate. The system then determines in step 17014 whether the call was received during normal scheduled vendor hours via a comparison between the time the call was received and stored vendor hours data. If the call was received during normal vendor hours the system can begin dialing a dealership call transfer number in step 17016 and wait for a response in step 17018. If the vendor answers the call then the system can connect the customer channel to the vendor channel in step 17020. Upon completion of the call, the system can hang up the call or otherwise disconnect the connection in step 17022 and perform a step 17024 to create and publish a call end and recording available event before sending to an ESL socket which is then sent to a system ESL socket listener which processes the event in step 17026 and depending on system settings either perform one of: step 17028 A) send an HTTP notification with call details and call recording URL, step 17030 B) send an email notification with call details and call recording URL, step 17032 C) publish event XML to a server on a designated channel using a web server, a combination thereof or none of these steps.

In instances where the system determines the call was not made during normally scheduled hours in step 17014 or the vendor did not answer the call after a call transfer in step 17018, the call can be routed via steps 17034 and 17036 respectively to a system with parallel asynchronous processes 17038. Initially a call route event can be published to an ESL socket in step 17040. Next a system ESL socket listener can process the event in step 17042 and a web server can publish the event XML to a server on a designated channel in step 17044 and an agent web client server can retrieve the event in step 17046. After publishing the call route event to an ESL socket in step 17040 a system transfer number can be dialed in step 17048 and if a system agent answers the call in step 17050 the customer channel can connect to the agent channel in step 17052 until the call is complete and a hang up event occurs before proceeding to step 17022, where the hang up process described above occurs. If a system agent does not answer a call in step 17050 can be placed in a queue, then a prompt can be retrieved and played that informs the customer that agents are currently unavailable in step 17054 and when the call recording ends in step 17056 after which the prompt ends and the system can proceed to a hang up process in step 17022 as described above begins.

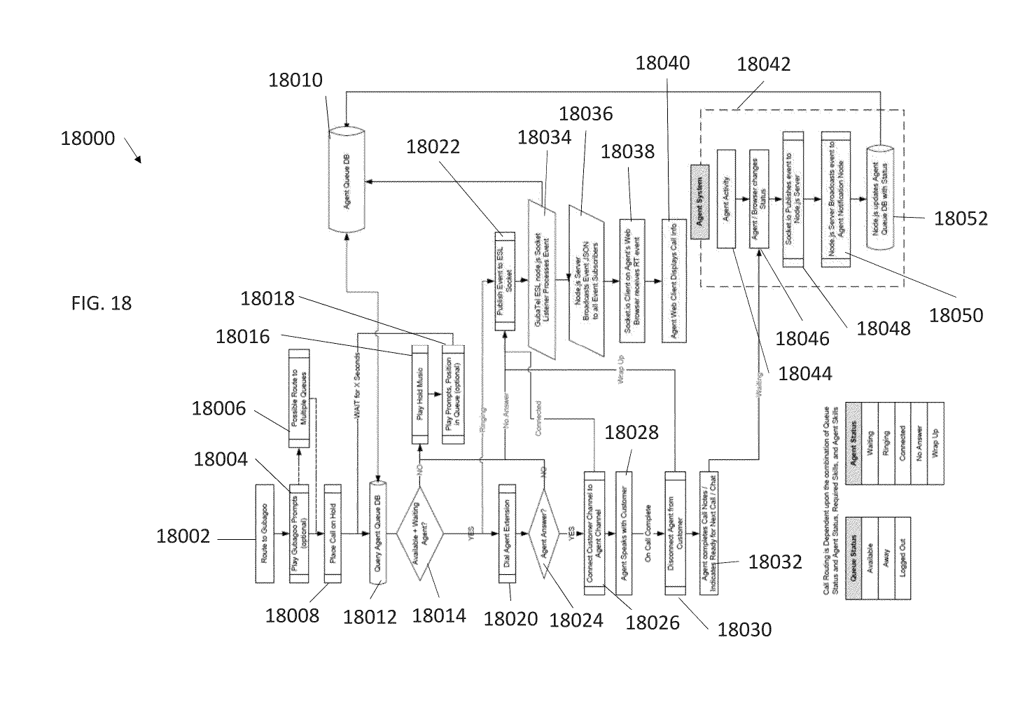

FIG. 18 is an example embodiment of a call queue routing flow chart 18000 as may be implemented using the current system in accordance with the present invention. In the example embodiment a call can be routed to the system in step 18002. Once received at the system, system prompts can be played in step 18004 and the call can be placed in one or more queues in step 18006 before or as it is being placed on hold in step 18008. An agent queue database 18010 can be queried in step 18012 for a listing of agents with appropriate skills to answer the call in step 18014. If no available agent is found to be available and waiting, then the call can remain on hold and hold music can be played in step 18016, prompts or position in queue can also be relayed to the caller in step 18018 and the system may wait a preset period of time before querying the agent queue database again using step 18012. If an available or waiting agent is located in the database in step 18014 then the agent's extension can be dialed in step 18020 and simultaneous with the ringing an event description can be published to an ESL socket in step 18022 which will be described in further detail below. If the agent does not answer in step 18024 then the call can remain on hold and return to step 18016 as described above and an event description can be published to an ESL socket in step 18022 which will be described in further detail below. If the agent does answer in step 18024 then the customer channel can be connected to the agent channel in step 18026 and an event description can be published to an ESL socket in step 18022 which will be described in further detail below. Next an agent can speak with the customer in step 18028 until a call completion occurs, after which the call is disconnected in step 18030 and an event description can be published to an ESL socket in step 18022 which will be described in further detail below. The agent can complete call notes and indicate whether the agent is prepared for a next caller or chat by changing an agent status in step 18032.

When an event description is published to an ESL socket in step 18022, the system ESL node socket listener can process the event in step 18034 and update an agent queue database 18010 and broadcast the event as a JSON document to all event subscribers in step 18036. A socket client on an agent's web browser can receive the event update in real time in step 18038 and the agent web client can display pertinent call information in step 18040.

An agent system 18042 can include agent activity 18044 which causes an agent or browser changing status 18046. This can include away, available, offline, busy, or others. This status can be published by a socket to a node server in step 18048 which can then broadcast the event to an agent notification node in step 18050. Thereafter, the node can update the agent queue database 18010 with the change in status in step 18052.

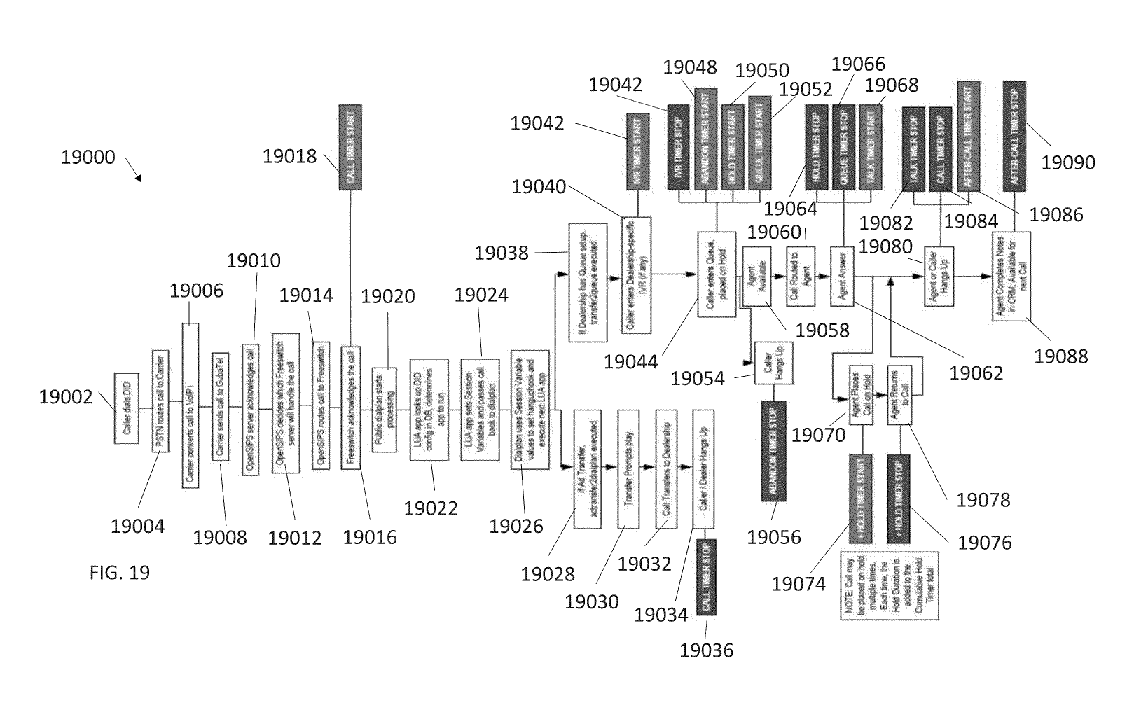

Turning to FIG. 19, an example embodiment of a call event timers flow chart 19000 in accordance with the present invention is shown. In the example embodiment a caller can dial a DID in step 19002. A PSTN can route the call to a carrier in step 19004 which then converts the call to VoIP in step 19006. The carrier can send the call to the system in step 19008 where a server such as an OpenSIPS (by OpenSIPS Project) server acknowledges the call in step 19010. The server can determine in step 19012 which of a list of servers will handle the call and route the call to that server. That server can then acknowledge the call in step 19014 and start a call timer in step 19018. A public dialplan can begin processing the call in step 19020 and an application such as a LUA app can look up the DID configuration in a database and determine the application to run in step 19022. The LUA app can set session variables and pass the call back to the dialplan in step 19024 which can use session variable values in step 19026 to set a hangup hook and execute additional LUA apps.

If the call is an advertisement transfer then a step 19028 can execute an adtransfer2dialplan and transfer prompts can play in step 19030 while the call transfers to the vendor in step 19032 and progresses as normally before the caller or dealer hangs up in step 19034 and the call timer is stopped in step 19036.

If the vendor has a queue setup such as part of the system, then a queue transfer program can be executed in step 19038. The caller can enter a dealership specific IVR in step 19040 if one is set up and an IVR timer can be started accordingly in step 19042. The caller can enter a queue and be placed on hold in step 19044, at which point none, one or a combination of: an IVR timer can be stopped in step 19046, an abandon timer started in step 19048, a hold timer started in step 19050, a queue timer started in step 19052 can occur. If the caller hangs up in a step 19054 then the abandon timer stops in step 19056. If the caller does not hang up and an agent is available in step 19058 then the call can be routed to the available agent in step 19060. If the agent answers in step 19062 then the hold timer can be stopped in step 19064, the queue timer stopped in step 19066 and the talk timer started in step 19068. If the agent places the call on hold in step 19070 a hold timer can be started in step 19074 and then stopped in step 19076 after the agent returns to the call in step 19078. Upon an agent or caller hang-up in step 19080 the talk timer can be stopped in step 19082, the call timer stopped in step 19084, and an after call timer can be started in step 19086. Then the agent can complete notes in CRM and become available for the next call in step 19088 at which point the after call timer can stop in step 19090.

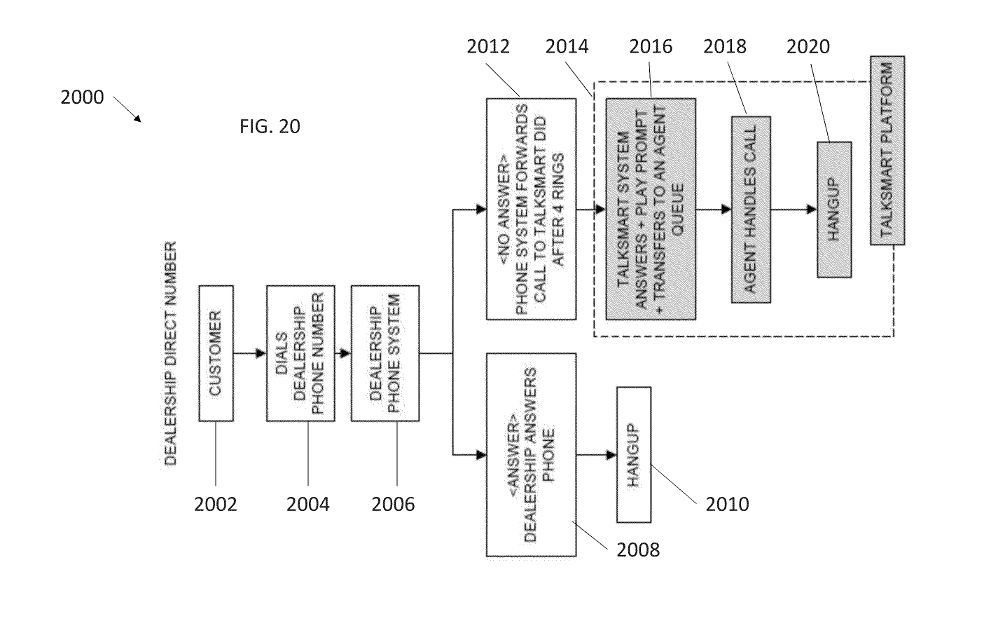

Turning to FIG. 20, an example embodiment of a call flow chart 2000 in accordance with the present invention is shown. This can be a vendor call being routed to the system. In the example embodiment, a customer 2002 can dial a vendor phone number on a mobile or land line device in step 2004. The call is then routed to a vendor phone system in step 2006. The vendor can then answer the call in step 2008 and the call proceeds as a normal call would until the call is ended in step 2010. Alternately, if the vendor does not answer the call then the vendor phone system can forward the call to a system DID after a preprogrammed number of rings has occurred, e.g. four rings, in step 2012. After the call has been forwarded the system 2014 can answer the call and play a prerecorded, stored prompt and transfer the call to an agent queue in step 2016. An agent can then answer the call and speak with the customer in step 2018 before hanging up in step 2020.

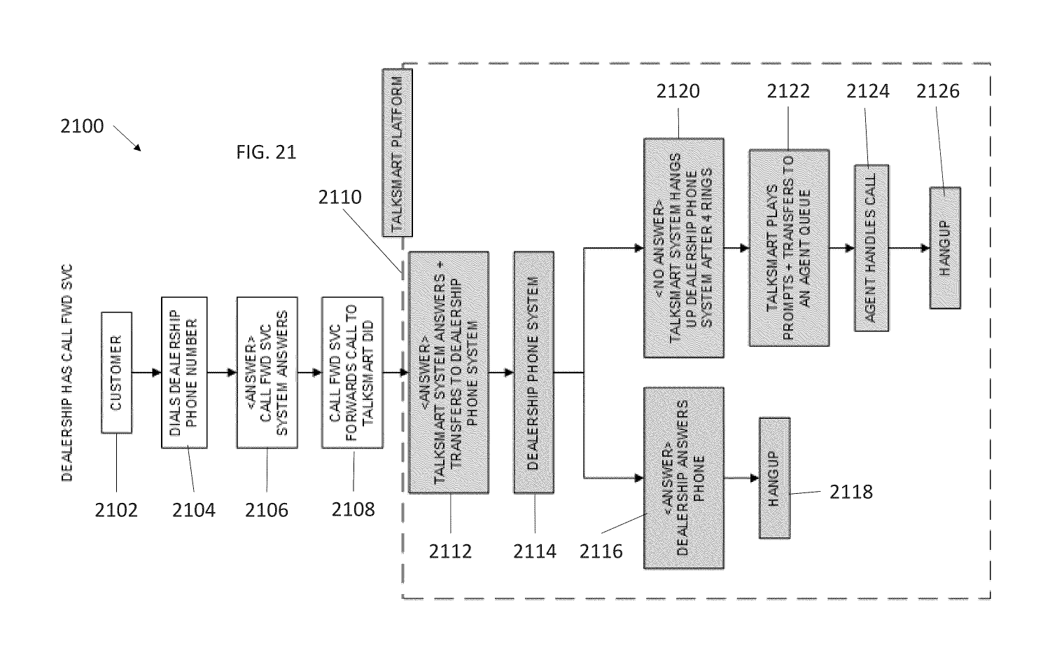

Turning to FIG. 21, an example embodiment of a call forwarding flow chart 2100 in accordance with the present invention is shown. This can be a vendor call being routed to the system. In the example embodiment a customer 2102 can dial a vendor phone number in step 2104 and a call forwarding service can answer the call in step 2106. The call forwarding service can then forward the call to a system DID in step 2108. From this point on the system platform 2110 can answer the call and transfer to a vendor phone system 2114 in step 2112. The vendor phone system 2114 can answer the phone call in step 2116, proceed as a normal call, and hang up when the call is over in step 2118. Alternately the system 2110 can hang up the vendor phone dial after a predetermined, stored number of rings if it has not been answered by that time in step 2120 and then play prompts stored in non-transitory memory and transfer the call to an agent queue in step 2122 where an agent can handle the call in step 2124 before hanging up in step 2126.

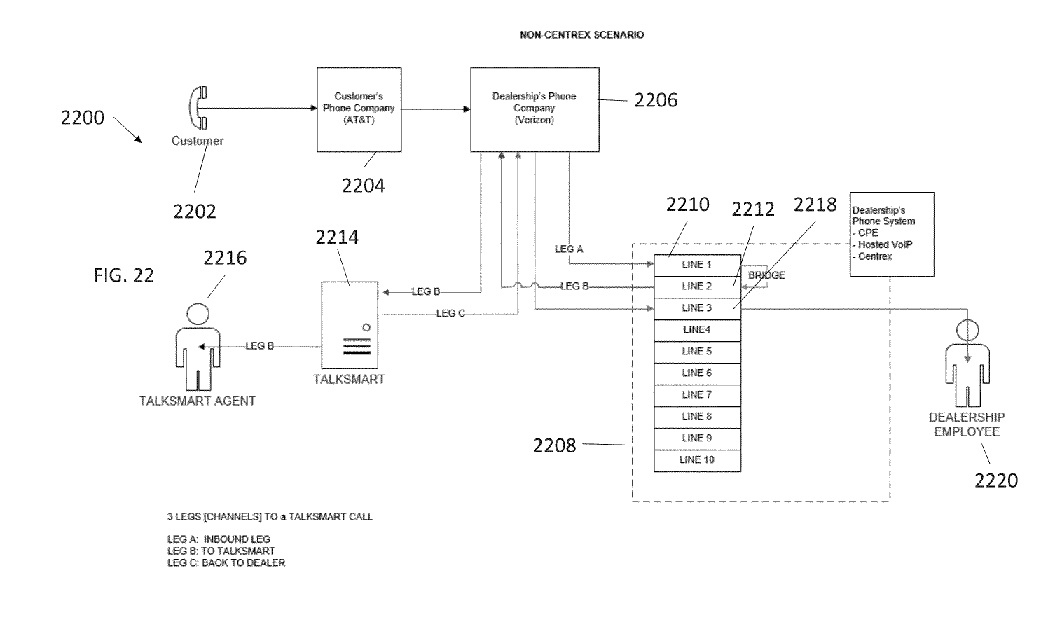

Turning to FIG. 22, an example embodiment of a non-Centrex architecture flowchart 2200 in accordance with the present invention is shown. In the example embodiment a customer or client 2202 can place a call which is routed through the customer's telephone company or network 2204 such as the Internet to a vendor's telephone company 2206. It can be routed using the vendor's internal phone system 2208 such as CPE or Hosted VoIP to a first line 2210 and then bridged to a second line 2212. The call can then be routed back to the vendor's phone company 2206 before being sent to the system server 2214 and an agent 2216. The system 2214 can store updated information and can send updated information back to the vendor's phone company 2206 to a third line 2218 on the vendor's phone system 2208 which can then be accessed or answered by a vendor employee 2220.

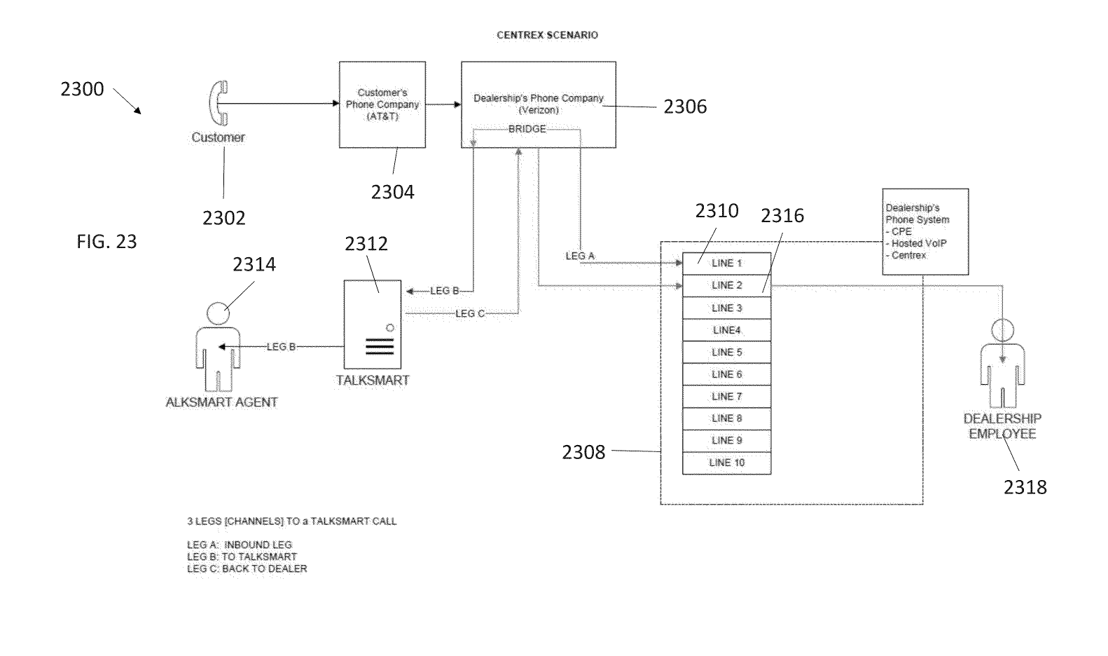

Turning to FIG. 23, an example embodiment of a Centrex architecture flowchart 2300 in accordance with the present invention is shown. In the example embodiment a customer or client 2302 can place a call which is routed through the customer's telephone company or network 2304 such as the Internet to a vendor's telephone company 2306. It can be routed using the vendor's internal phone system 2308 to a Centrex system first line 2310 and bridged to the system server 2312 via the vendor's phone company 2306 where an agent 2314 can communicate with the customer 2302. The system 2312 can store updated information and can send updated information back via the vendor's phone company 2306 to a second line 2316 on the vendor's phone system 2308 which can then be accessed or answered by a vendor employee 2318.

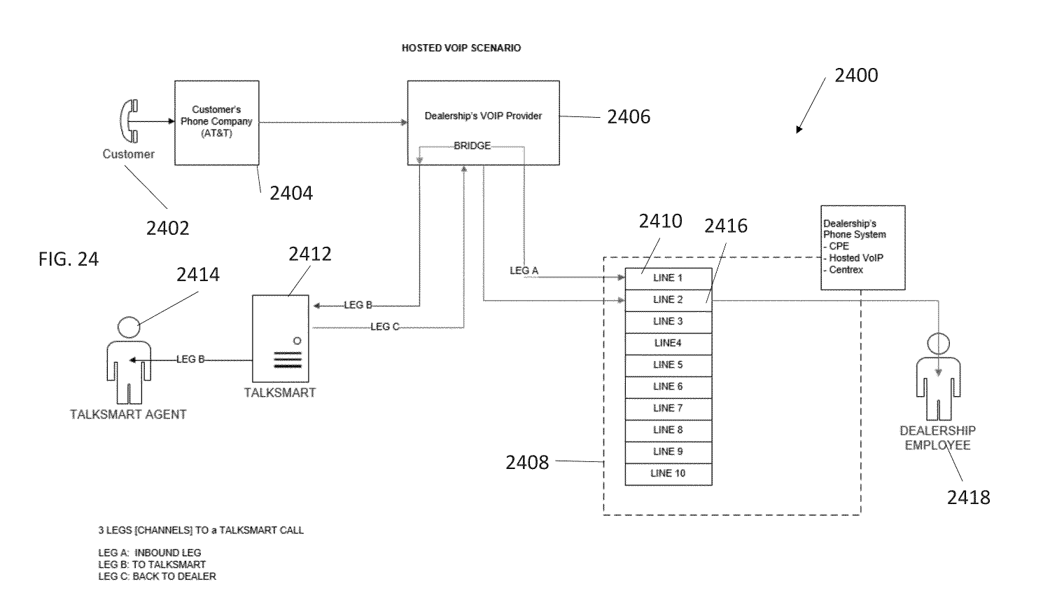

Turning to FIG. 24, an example embodiment of a hosted VoIP architecture flowchart 2400 in accordance with the present invention is shown. In the example embodiment a customer or client 2402 can place a call which is routed through the customer's telephone company or network 2404 such as the Internet to a vendor's VoIP provider 2406. It can be routed using the vendor's internal phone system 2408 to a hosted VoIP system first line 2410 and bridged via the vendor's VoIP provider 2406 to the system server 2412 where an agent 2414 can communicate with the customer 2402. The system 2412 can store updated information and can send updated information back via the vendor's VoIP provider 2406 to a second line 2416 on the vendor's phone system 2408 which can then be accessed or answered by a vendor employee 2418.

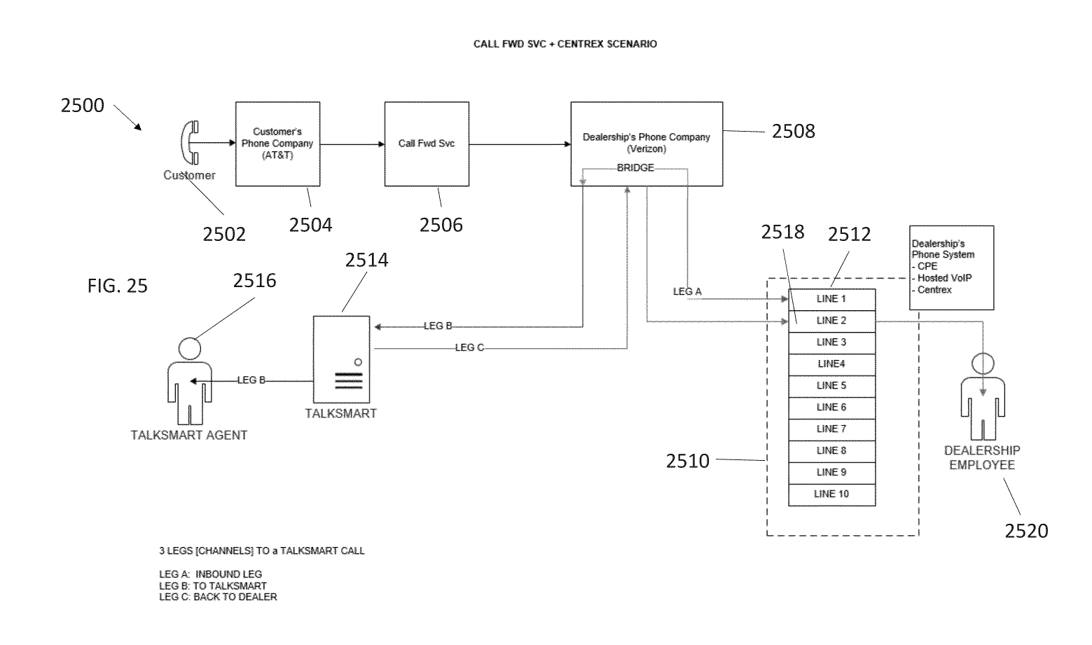

Turning to FIG. 25, an example embodiment of a call forwarding service and Centrex architecture flowchart 2500 in accordance with the present invention is shown. In the example embodiment a customer or client 2502 can place a call which is routed through the customer's telephone company 2504 to a call forwarding service 2506 and then to a vendor's telephone company 2508. It can be routed using the vendor's internal phone system 2510 to a Centrex system first line 2512 and bridged via the vendor's telephone company 2508 to the system server 2514 where an agent 2516 can communicate with the customer 2502. The system 2514 can store updated information and can send updated information back to the vendor's phone company 2508 to a second line 2518 on the vendor's phone system 2510 which can then be accessed or answered by a vendor employee 2520.

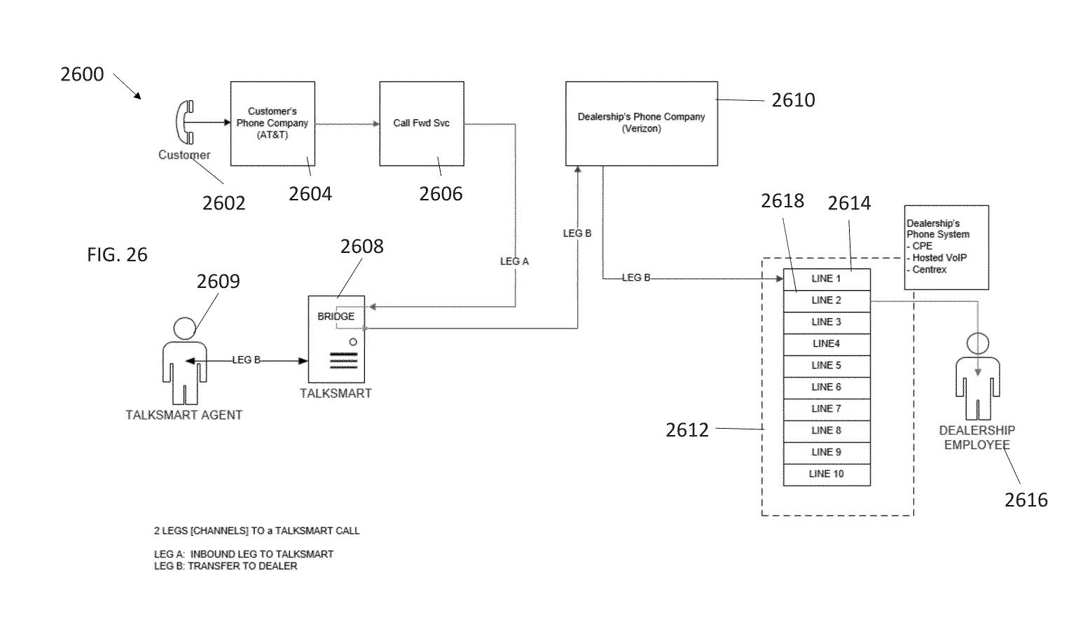

Turning to FIG. 26, an example embodiment of a call forwarding service and system architecture flowchart 2600 in accordance with the present invention is shown. In the example embodiment a customer or client 2602 can place a call which is routed through the customer's telephone company or network 2604 such as the Internet to a call forwarding service 2606 before routing to a system server 2608 where it can be answered by an agent 2609 before being bridged to a vendor's phone company 2610. It can be routed using the vendor's internal phone system 2612 to a first line 2614 which can then be accessed or answered by a vendor employee 2616 on a second line 2618.

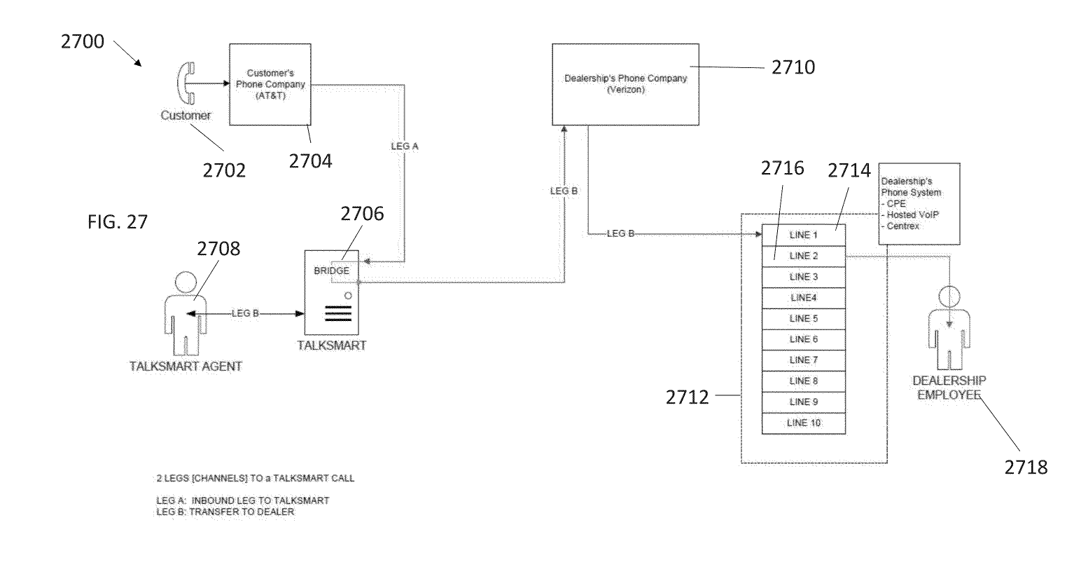

Turning to FIG. 27, an example embodiment of a system architecture flowchart 2700 in accordance with the present invention is shown. In the example embodiment a customer or client 2702 can place a call which is routed through the customer's telephone company or network 2704 such as the Internet to a system server 2706 where it can be answered by an agent 2708 before being bridged to a vendor's phone company 2710. It can be routed using the vendor's internal phone system 2712 to a first line 2714 which can then be accessed or answered by a vendor employee 2718 on a second line 2716.

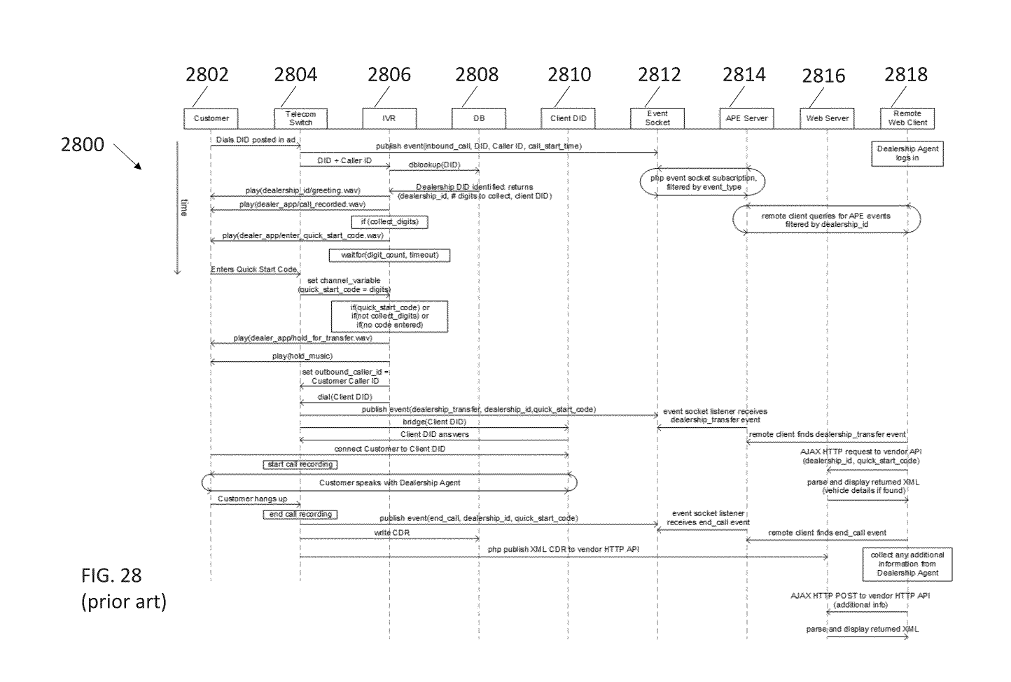

Turning to FIG. 28, an example embodiment of a prior art architecture flowchart 2800 in accordance with the present invention is shown. In the example embodiment, a dealership agent 2812 can log in to a system and a customer 2802 can dial a DID posted in an advertisement which can cause a telecom switch 2804 to publish event information to an event socket 2812. This can cause the event socket 2812 to begin a look with an APE server 2814 of php event socket subscription filtering by event type. Telecom switch 2804 can also send DID and a caller ID to an IVR 2806 which can perform a DID database lookup from a database 2808 which results in retrieval of a dealership DID identification by the IVR2806 that can then send a dealership id and dealer app call recording message to the customer 2802. If digits are collected by IVR 2806 then it can play a dealer application quick start code to customer 2802. Meanwhile, remote client queries for APE events can be filtered between remote web client 2818 and APE server 2814 by dealership ID. IVR 2806 can wait for a digit count and a timeout before customer 2802 enters a quick start code which is processed and relayed by telecom switch 2804 to set channel variables to IVR2806. If the quick start code is collected, not collected or no code is entered then a dealer application hold for transfer message can be sent to customer 2802, along with hold music, setting outbound customer caller id, dialing client DID from IVR 2806 to telecom switch 2804. This can cause telecom switch 2804 to publish event transfer to event socket 2812 and bridge client DID to Client DID 2810. When answered, telecom switch 2804 can connect customer 2802 to client DID 2810 before starting a call recording. Meanwhile, APE server 2814 can receive the dealership transfer event by listening to event socket 2812 and remote web client 2818 can find the dealership transfer event on the APE server 2814 before sending an AJAX HTTP request to a vendor API before the call recording starts. Next the customer 2802 can speak with dealership agent over client DID 2810 and remote web client can parse and display returned XML such as vehicle details from web server 2816. When customer 2802 hangs up, telecom switch 2804 can detect it and end the call recording. Telecom switch 2806 can publish a call end event code to event socket 2812 which is detected by event socket listener 2814 from event socket 2812. Telecom switch 2804 can write a CDR to Database 2808 while remote client 2818 can detect the call end event from APE server 2814. Telecom switch 2804 can then php publish XML CDR to vendor HTTP API of web server 2816 and remote web client 2818 can collect any additional information from dealership agent. AJAX HTTP Post from remote web client 2818 can be sent to web server 2816 before parsing and displaying returned XML from Web server 2816.

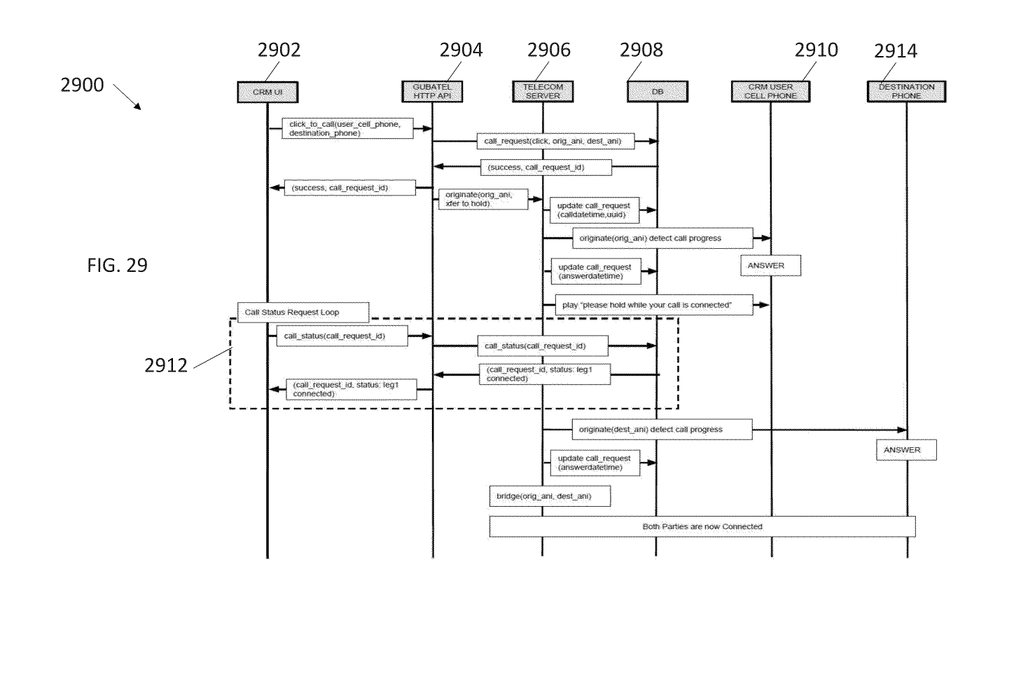

Turning to FIG. 29, an example embodiment of a call flowchart 2900 in accordance with the present invention is shown. In the example embodiment, a CRM UI 2902 can use click to call functionality to allow a user to select a button or phone number on a user device such as a smart phone to call a number. This then routes to a system HTTP API 2904 which forwards a call request to a system database 2908 via a telecom server 2906. The system database 2908 returns a success message to the system HTTP API 2904 via a telecom server 2906 and a requested call id which is forwarded back to the CRM UI 2902. The system HTTP API 2904 sends an originate message including a transfer to hold message to the telecom server 2906 and the telecom server 2906 sends an update call request including call information such as date and time and user id to the database 2908. The telecom server 2906 also sends an origination message to a CRM user smart device such as a cellular phone 2910 in order for call progress tracking. The telecom server 2906 also sends an update call request upon a CRM user smart device 2910 answering the call. The telecom server 2906 can send a confirmation to a CRM user smart device 2910 such as “please hold while your call is connected” in order to notify the user that the call is being connected. A call status request loop 2912 can include a call status request from a CRM UI 2902 to a system HTTP API 2904 which is in turn sent to a database 2908 via a telecom server 2906. An update can be sent back from the database 2908 via a telecom server 2906 to notify the CRM UI 2902 that the call is connected. The telecom server 2906 can update a destination phone 2914 of an originate call progress message and a database 2908 of a call request update including answering information such as date and time. A bridge can occur on the telecom server 2906 and the parties can be connected.

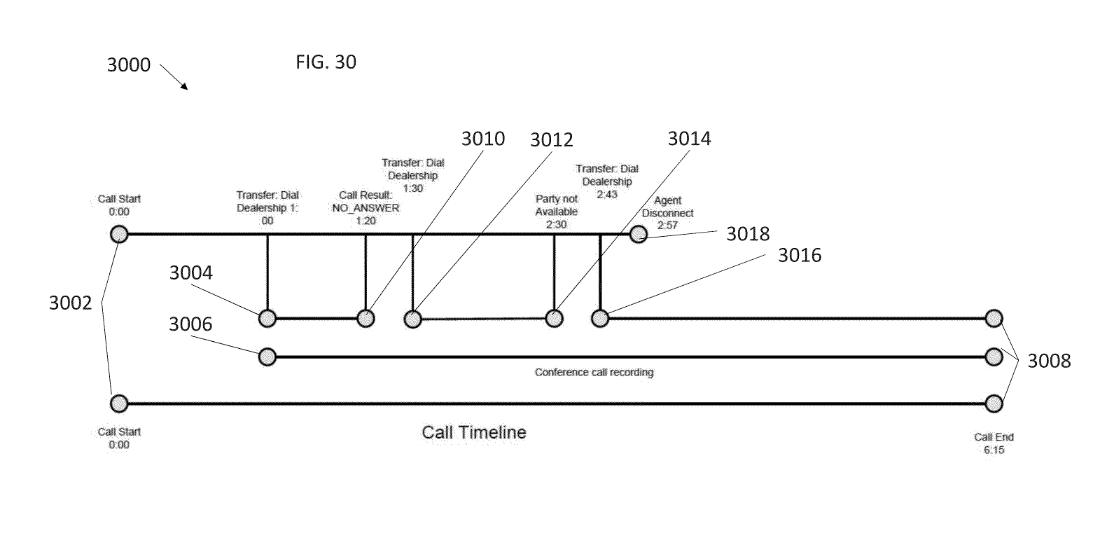

Turning to FIG. 30, an example embodiment of a call timeline flowchart 3000 in accordance with the present invention is shown. In the example embodiment a call from a client or customer can be started at time 0:00 (M:SS) in step 3002. A transfer dial to a first vendor can occur at 1:00 in step 3004. A conference call recording can be initiated in step 3006, such as at 1:00, and played until after the call is disconnected in step 3008. After a predetermined number of rings or a preset time such as 1:20, a timeout can occur in step 3010. After the timeout another timer or series of actions can cause a delay, such as until 1:30, and another transfer can begin in step 3012. After a timeout with no answer in step 3014, such as at 2:30 a party unavailable message can be generated and played to the customer or client. At this point the call can be transferred to the vendor in step 3016, such as at 2:43, before an agent disconnect occurs in step 3018, such as at 2:57. The call can then end at step 3008, such as at 6:15.

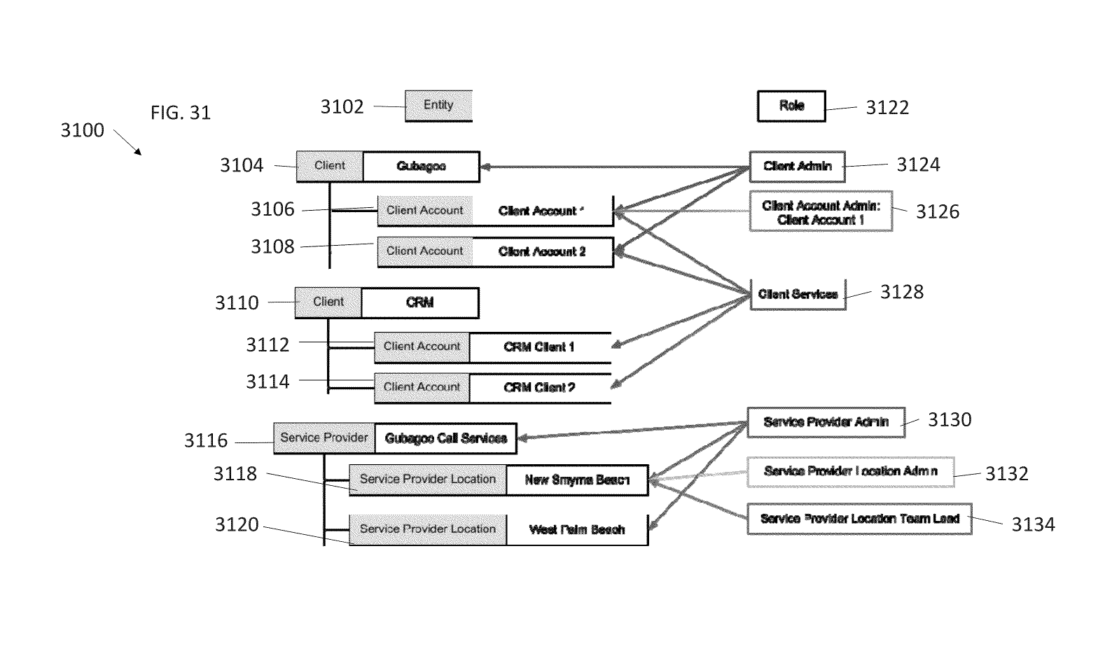

Turning to FIG. 31, an example embodiment of a role designation chart 3100 in accordance with the present invention is shown. In the example embodiment various entity 3102 structures are shown. For example a client “Gubagoo” 3104 is arranged such that it has multiple accounts “Client Account 1” 3106 and “Client Account 2” 3108. Similarly, a client “CRM” 3110 is arranged such that it has multiple accounts “CRM Client 1” 3112 and “CRM Client 2” 3114. Similarly, a service provider “Gubagoo Call Services” 3116 is arranged such that it has multiple accounts “New Smyrna Beach” 3118 and “West Palm Beach” 3120. Various roles 3122 can be assigned to individual players in the system. In the example embodiment a first client administrator 3124 can deal with client “Gubagoo” 3104 and its associated accounts 3106 and 3108. A lower level role can be a client account administrator 3126 who manages a single account of a single client 3104 such as “Client Account 1” 3106. A client services role 3128 can handle client accounts for multiple clients 3106, 3108, 3112 and 3114. A service provider administrator 3130 can act similarly to a client administrator 3124 but for a service provider 3116. A service provider location administrator 3132 can be assigned to a single service provider location 3118. A service provider location team lead 3134 can be associated with a single service provider location 3118.

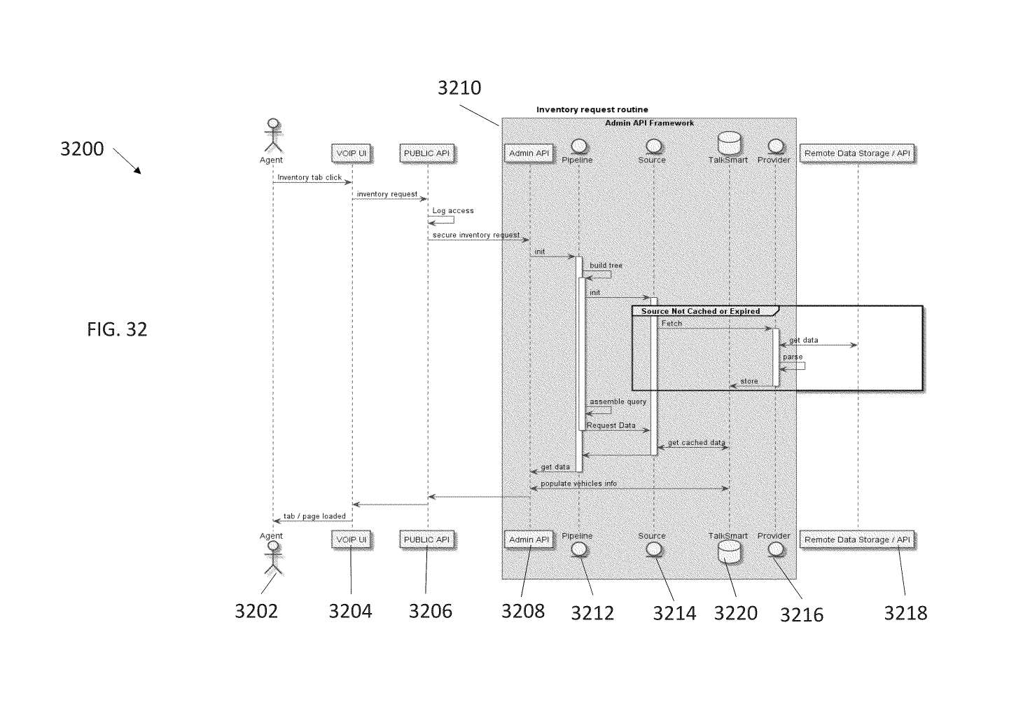

Turning to FIG. 32, an example embodiment of an inventory request routine flowchart 3200 in accordance with the present invention is shown. In the example embodiment an agent 3202 can click an inventory tab in the system VoIP UI 3204. This can in turn lead to an inventory request in a public API 3206 which can log access by authorized personnel. A secure inventory request can be sent to an Admin API 3208 of an Admin API framework 3210 which sets an initialization. This initialization can begin a building tree in a pipeline 3212 which in turn can send an initialization to a source 3214. If the source 3214 is not cached or the cache has expired then the source 3214 can send a request to a provider 3216. The provider 3216 can access a remote data storage 3218 or API outside of the Admin API framework 3210 in order to acquire the requested data. The provider 3216 can parse the data and store it in a system database 3220. The pipeline 3212 can assemble a query and request data from the source 3214 and the source 3214 can access the system database 3220 before sending data back to the pipeline 3212. The data can be relayed back to the Admin API 3208 and relevant inventory information can be accessed by the Admin API 3208 from the system database 3220. The Admin API 3208 can send data back to the Public API 3206, in turn to the VoIP UI 3204 and the tab or page can be loaded for the agent 3202 and presented on a user interface.

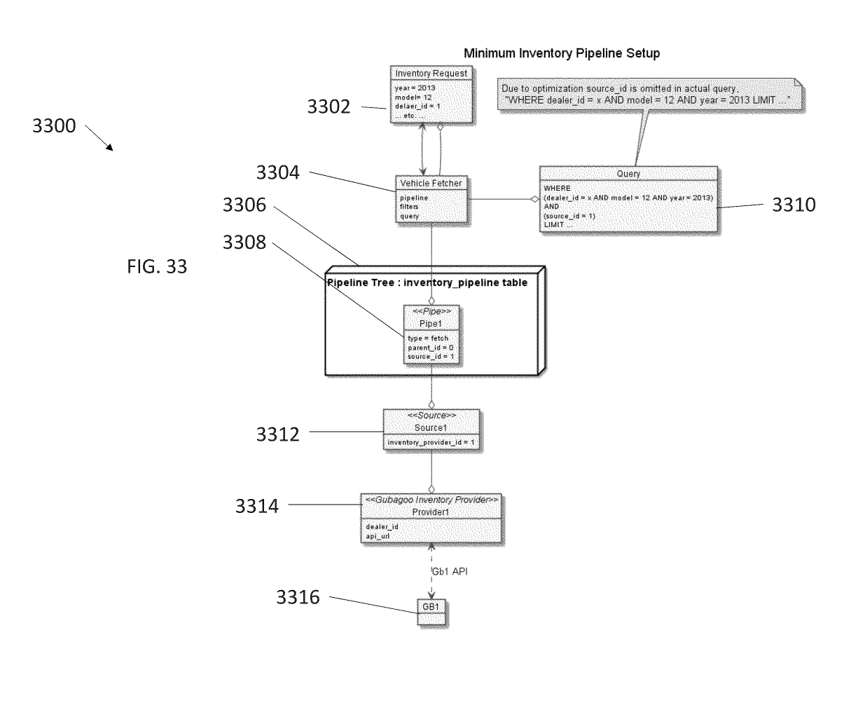

Turning to FIG. 33, an example embodiment of a minimum inventory pipeline setup chart 3300 in accordance with the present invention is shown. In the example embodiment an inventory request 3302 can have several values or fields such as year, model, location and others as appropriate. The inventory request 3302 can be sent to an inventory fetcher 3304 which uses a pipeline tree 3306 including one or more pipelines 3308 and filters to construct a query 3310. A query 3310 is the object code which uses a pipeline tree 3306 pipeline table, before using source 3312 to supply a system inventory provider 3314 the information to the system via a system API 3316.

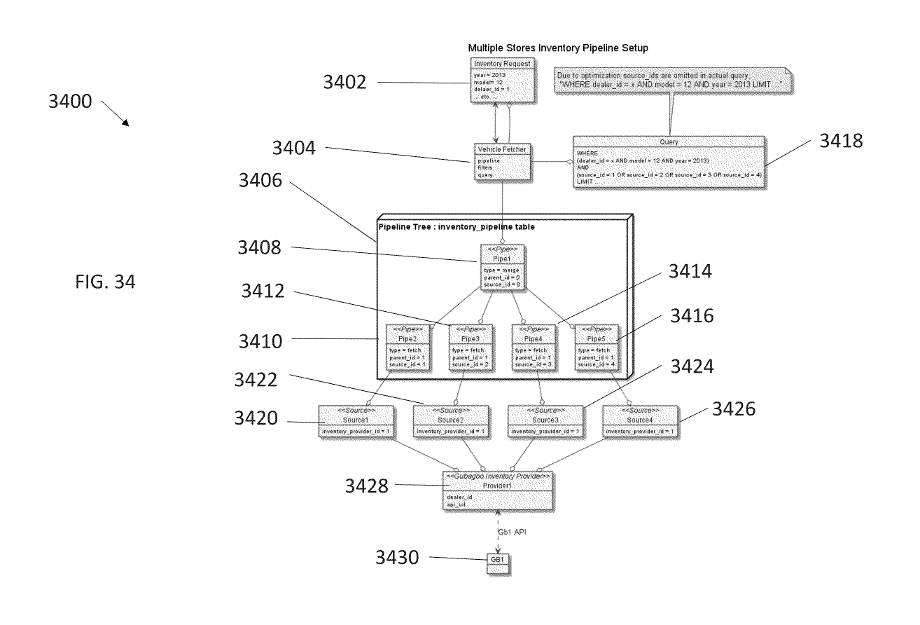

Turning to FIG. 34, an example embodiment of a multi-location inventory pipeline setup chart 3400 in accordance with the present invention is shown. In the example embodiment an inventory request 3402 can have several values or fields such as year, model, location and others as appropriate. The inventory request 3402 can be sent to an inventory fetcher 3404 which uses a pipeline tree 3406 including one or more pipelines 3408, 3410, 3412, 3414, 3416 and filters to construct a query 3418. A query 3418 is the object code which uses the pipeline tree 3406 pipeline table which can branch from a single pipe 3408 to multiple pipes 3410, 3412, 3414, 3416, to accessing multiple sources 3420, 3422, 3424, 3426 respectively before supplying a system inventory provider 3428 the information to the system via a system API 3430.

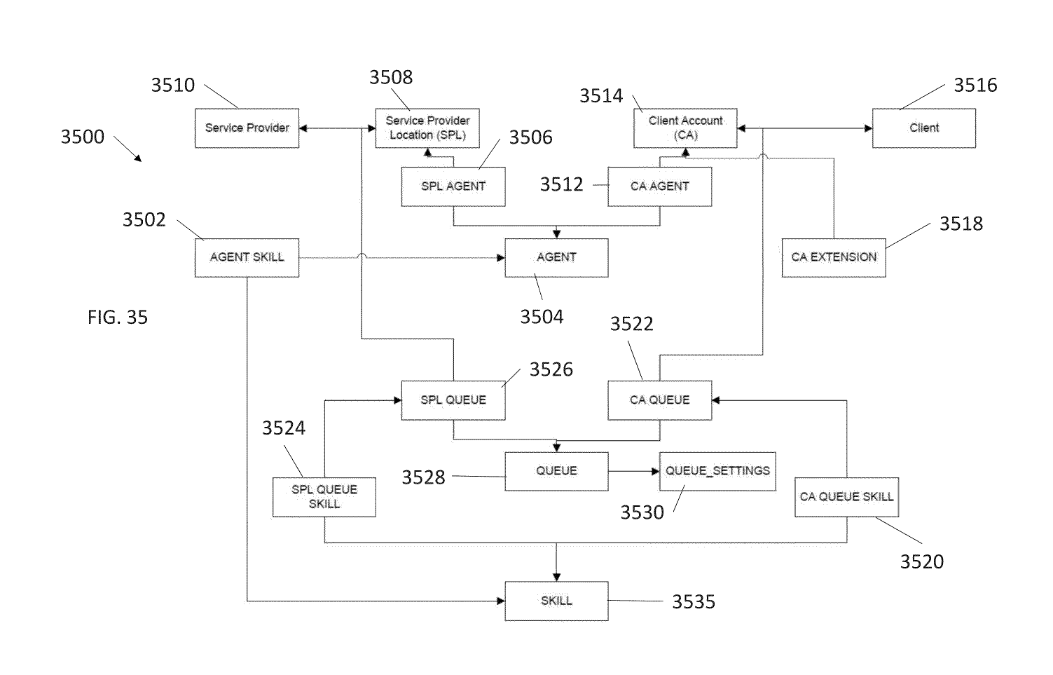

Turning to FIG. 35, an example embodiment of a skill relationship chart 3500 in accordance with the present invention is shown. In the example embodiment an agent skill 3502 can be attributed to an agent 3504 and a skill category. An SPL (Service Provider Location) agent 3506 can be assigned to a SPL 3508 of a particular service provider 3510. Similarly, a CA (Client Account) agent 3512 can be assigned to a CA 3514 of a particular client 3516. A CA extension 3518 can also be assigned to a particular CA 3516. A CA Queue Skill 3520 can be attributed to a CA Queue 3522 and transitively to a CA 3514 and client 3516. Similarly a SPL Queue Skill 3524 can be attributed to a SPL Queue 3526 and transitively to a Service Provider 3510 and SPL 3508. CA Queue 3522 and SPL Queue 35326 can be assigned to an overall Queue 3528 and then influence Queue settings 3530. SPL Queue Skill 3524 and CA Queue Skill 3520 can be assigned to an overall Skill 3532 associated with agent skill 3502.

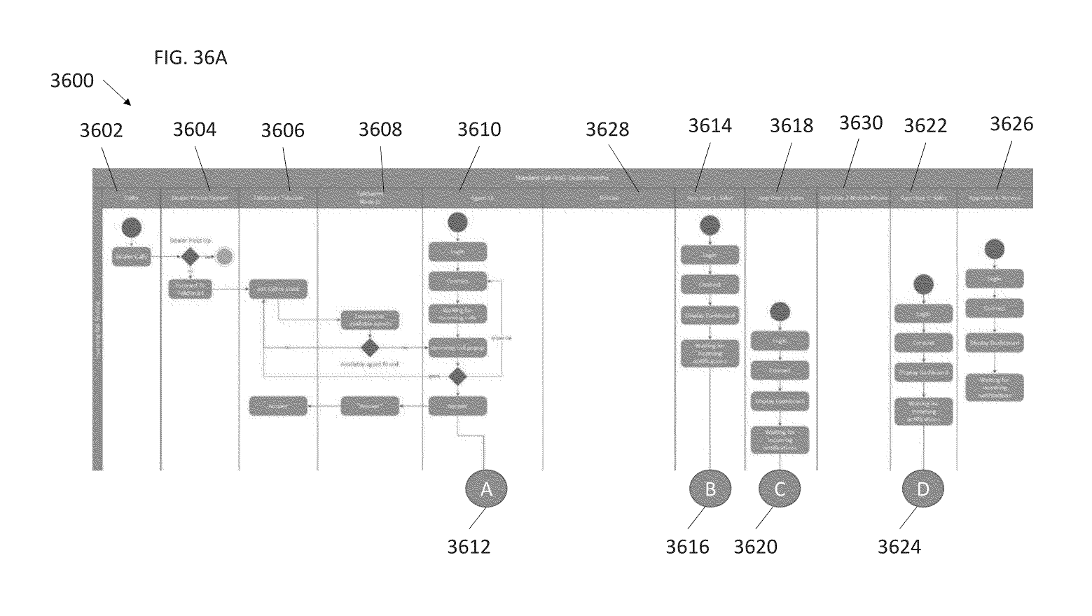

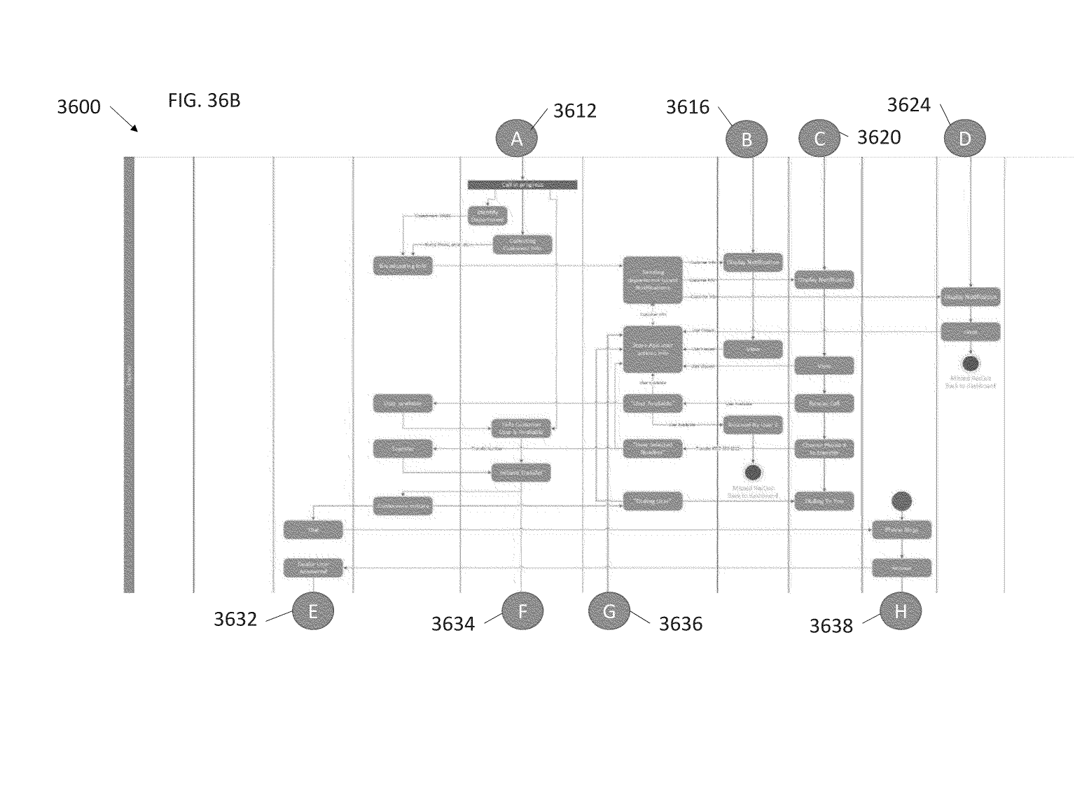

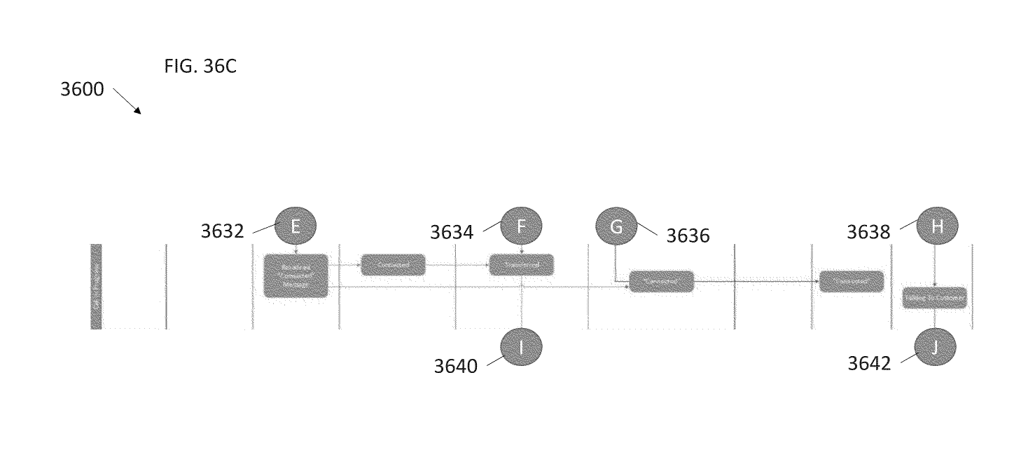

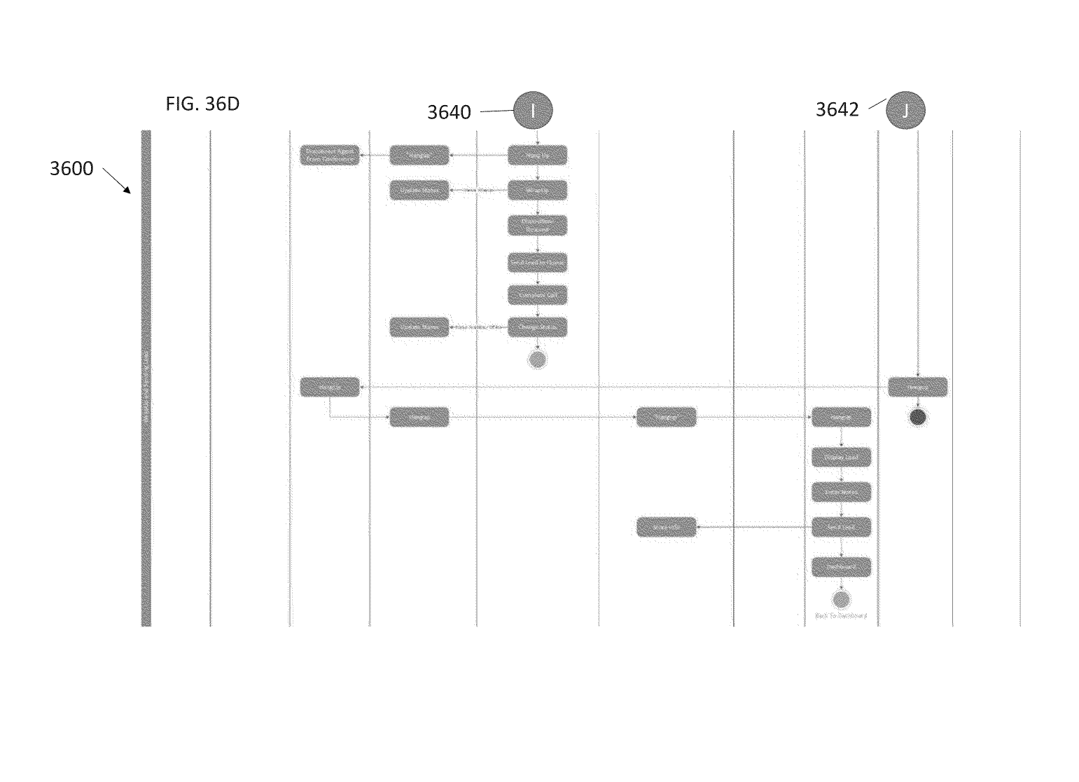

FIGS. 36A-D are an example embodiments of flowcharts showing a standard call takeover in accordance with the present invention.

Turning to FIG. 36A, an example embodiment of incoming call routing is shown. In the example embodiment, a caller 3602 calls a vendor phone system 3604 and the vendor either picks up or does not. If the vendor does not pick up then the call is forwarded to the system 3606 where it is sent to a stack. The system 3606 searches for available agents using a particular node 3608 and if it does not find one the call can be sent back to the stack. If an agent is found then an incoming call popup can appear on an agent user interface 3610 that can be interactive. An agent user interface 3610 is accessed by the agent when the agent logs in to the system and connects. The agent then waits for calls to be routed to them and receives an incoming call popup when a call is forwarded as previously described. If a call is ignored then the call is sent back to the stack. If the call is missed then the agent user interface 3610 can connect again. If the call is answered then the node 3608 can be updated as well as the system 3606 before transitioning to “A” 3612 which follows in the description of FIG. 36B.

An “App User 1” 3614 in sales can log in to the system, connect, view a dashboard displayed by the system and wait for incoming notifications before transitioning to “B” 3616 which follows in the description of FIG. 36B. An “App User 2” 3618 in sales can log in to the system, connect, view a dashboard displayed by the system and wait for incoming notifications before transitioning to “C” 3620 which follows in the description of FIG. 36B. An “App User 3” 3622 in sales can log in to the system, connect, view a dashboard displayed by the system and wait for incoming notifications before transitioning to “D” 3624 which follows in the description of FIG. 36B. An “App User 4” 3626 in service can log in to the system, connect, view a dashboard displayed by the system and wait for incoming notifications.

Turning to FIG. 36B, an example embodiment of call transferring is shown. From “A” in FIG. 36A, an agent UI 3610 can designate a call in progress and can identify a department such as sales and collect customer information based on agent input or telephone information such as name, phone, email and others. The information can be broadcasted from the system node 3608 to a takeover application 3628. The takeover application 3628 can send department based notifications including customer information to relevant app user devices such as “App User 1” 3614, “App user 2” 3618 and “App user 3” 3622 where a notification can be displayed. In the example embodiment “App user 3” 3622 closes the app and a notification that the call has been missed is displayed and a dashboard is displayed while a notification that the user closed the call notification is sent to a store app user actions info module the takeover application 3628. Both “App user 1” 3614 and “App user 2” 3618 have viewed the call notification and user viewed notifications are sent to a store app user actions info module the takeover application 3628. Department based notifications also send customer information to a store app user actions info module of the takeover application 3628. “App user 2” 3618 has chosen to takeover the call and a user available notification is sent to the takeover application 3628 which updates the store app user actions info module and also sends a notification to “App user 1” 3614 that “App user 2” 3618 has performed a call takeover. This can display a missed call notification and display a dashboard for “App user 1” 3614. The call takeover performed by “App user 2” 3618 allows “App user 2” 3618 to select a phone number to transfer the call to which can be the “App user 2 mobile phone” 3630 number. The phone number can also be sent to the takeover application 3628 as a “user selected number” before updating the system node 3608. The user available notification can also update the system node 3608 that the user is available which can then inform the agent UI 3610 that the user is available before initiating a transfer. The transfer is initiated and the process transitions to “F” 3634 which follows in the description of FIG. 36C in addition to notifying the system node 3608 that the conference has been initiated. Conference initiation then causes dialing by the system 3606 whereby the number of “App user 2 mobile phone” 3630 begins to ring and is then answered the process transitions to “H” 3638 which follows in the description of FIG. 36C. Transition to “G” 3636 which follows in the description of FIG. 36C can update the takeover app 3628. Transition to “E” 3632 which follows in the description of FIG. 36C can occur when the system recognizes that an “App user 3” 3622 answers a call.

Turning to FIG. 36C, an example embodiment of call in progress is shown. “E” 3632 progresses to broadcasting a connected message which then informs the system node 3608 that the call conference was connected as well as the takeover app 3628. The node 3608 and takeover app 3628 both go to transferred and then the process transitions to “I” 3640 which follows in the description of FIG. 36D. The takeover app 3628 informs “User app 2” 3618 that the call is connected. “App user 2 mobile phone” 3630 from “H” 3638 goes to talking to customer and then transitions to “J” 3642 which follows in the description of FIG. 36D.

Turning to FIG. 36D, an example embodiment of call wrap up and lead forwarding is shown. “I” 3640 occurs when Agent UI 3610 goes to hang up and sends a notification to node 3608 and then system 3606 to disconnect the agent from the conference. Agent UI 3610 Hang up also causes wrap up to be sent to node 3608 which updates the status of the call. Wrap up also updates a disposition of Agent UI 3610 to takeover, sends a lead to a queue, completes the call, changes status, and updates status of node 3608 before terminating the process.

“J” 3642 proceeds for the call until a hang up or disconnect occurs and the call is terminated on the phone 3630. The system 3606 is notified of the hang up and then the node 3608 before the takeover app 3628. The takeover app 3628 notifies “App user 2” 3618 of the hang up and displays the lead and allows for note entering before sending the lead to the takeover app 3628 for storage and displaying a dashboard.

FIGS. 37A-M show example embodiments of user interface interaction between the system and takeover application.

Turning to FIG. 37A, an example embodiment of a side-by-side of a web user interface 3700a with no incoming call and takeover application interface dashboard (see description of FIG. 10B) in accordance with the present invention is shown (see also FIG. 1 and related description). In the example embodiment the web user interface is showing no call information before a call is received by the system. The takeover application interface dashboard is showing the system status including the number of missed calls, system leads, takeover leads, users logged in, alerts sent, alerts viewed, alerts closed, alerts dismissed, and others.

Turning to FIG. 37B, an example embodiment of a side-by-side of a web user interface 3700b with an incoming call and takeover application interface dashboard in accordance with the present invention is shown. In the example embodiment a call is received from a vendor phone system and information is displayed in a window 3702 the web user interface. This information can include department, client, account name, caller identification, what number the caller dialed, what number the call was transferred to, quickstart codes, advertisement information, and others (see also FIG. 2 and related description). The system presents the user with the option to answer the call or ignore it. The takeover application interface continues to show the dashboard.

Turning to FIG. 37C, an example embodiment of a side-by-side of a web user interface 3700c with a call script display and takeover application interface dashboard in accordance with the present invention is shown. In the example embodiment the web user interface is displaying a call script and call details as previously described herein. The takeover application interface continues to show the dashboard.

Turning to FIG. 37D, an example embodiment of is a side-by-side of a web user interface with inventory search 3700d and takeover application interface dashboard in accordance with the present invention is shown. In the example embodiment an agent can navigate inventory and offers by selecting a tab or button and adding the information to a customer offer selection (see also FIG. 3 and related description). The takeover application interface continues to show the dashboard.

Turning to FIG. 37E, an example embodiment of a side-by-side of a web user interface with takeover option and takeover application interface push notification (see description of FIG. 12C) in accordance with the present invention is shown. In the example embodiment an agent can select an appropriate individual or department 3704 to inquire as to whether they can take over the call. After selecting the individual or department, the web application will send a push notification to the takeover application running on the individual or department's smart device. The takeover application display shows a push notification that a user can elect to view or close by selecting an appropriate button 3706.

Turning to FIG. 37F, an example embodiment of a side-by-side of a web user interface with inputted customer details and takeover application interface with call details (see description of FIG. 12B) in accordance with the present invention is shown. In the example embodiment, information can be gathered by the agent and inputted into various fields 3708 in the web interface of the system and stored in a database. This information can then be displayed in the takeover application of one or more devices including customer information, inventory information, offer information, service information, parts information, previous call information or other pertinent information.

Turning to FIG. 37G, an example embodiment of a side-by-side of a web user interface with call takeover notification and takeover application interface with connection options (see description of FIG. 13b) in accordance with the present invention is shown. In the example embodiment a user has elected to take over the call using the takeover application using an appropriate command or action. The application presents the user with the option 3710 to connect with the current device or to select another number or device to connect with. The takeover application can then send a notification message 3712 to the system for display at the web user interface to notify the agent that the user wishes to take over the call.

Turning to FIG. 37H, an example embodiment of a side-by-side of a web user interface with call takeover details 3700h and takeover application interface with call connection (see description of FIG. 13b) in accordance with the present invention is shown. In the example embodiment the takeover application can allow a user to select options 3714 such as “connect with this phone,” “connect with another phone” or input phone number digits along with a confirmation button. The phone number is sent to the system upon confirmation and displayed in a window 3712 along with the following: the agent on the call can select a transfer button which can load a module with a pre-populated call transfer box 3716 that includes the number transfer that was inputted or selected by the user on the takeover application. The agent can then select a dial or connect button in window 3716 to initiate a conference dial to the phone number selected by the user.

Turning to FIG. 37I, an example embodiment of a side-by-side of a web user interface with call takeover details 3700i and takeover application interface with call connection notification (see description of FIG. 14a) in accordance with the present invention is shown. In the example embodiment a notification is sent to the takeover application indicating to the user that the system is attempting to connect them with the call.

Turning to FIG. 37J, an example embodiment of a side-by-side of a web user interface with call takeover details 3700j and takeover application interface with call connection details (see description of FIG. 14b) in accordance with the present invention is shown. In the example embodiment the takeover application displays that a connection has been made between the system and the takeover application. This can occur whether or not the call was directed to the device the takeover application is currently operating on or a different device or landline. The takeover application can allow the user to browse inventory and offer items that were presented to the customer by the agent and also additional inventory and offers.

Turning to FIG. 37K, an example embodiment of a side-by-side of a web user interface with call takeover details 3700k and takeover application interface with call transfer missed notification in accordance with the present invention is shown. In the example embodiment a takeover application user can choose not to respond or to close a notification received from the system. In this case an alert can be displayed in the takeover application 3718 and in the web user interface 3720 indicating to the user and agent respectively that the call was missed or declined.

Turning to FIG. 37L, an example embodiment of a side-by-side of a web user interface 3700l with call takeover declined details and takeover application interface with call missed details in accordance with the present invention is shown. In the example embodiment another display can be shown to the user of the takeover application if the user declined the call or closed a missed call alert. This display can include information for the call that was missed or declined. There can also be interactive features such as pull-down tabs of all missed calls for a given period of time such as an hour, half-day, day, week or others.

Turning to FIG. 37M, an example embodiment of a side-by-side of a web user interface with call details 3700m and takeover application interface with other user call connection details (see description of FIG. 13A) in accordance with the present invention is shown. In the example embodiment a display can be shown to all users of the takeover application when one user takes over a call, including information about the call.

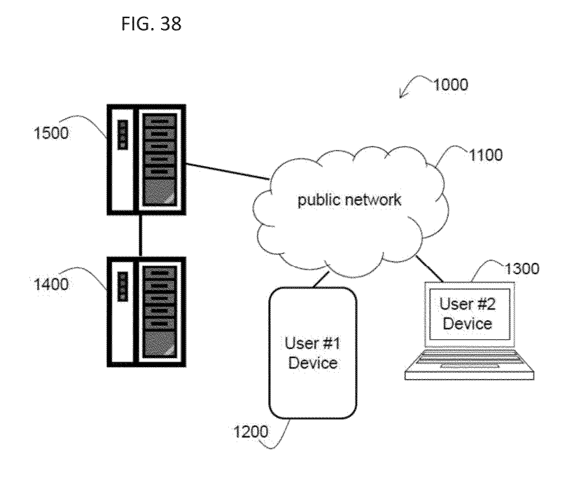

Turning to FIG. 38, a computer-based system 1000 in accordance with a preferred embodiment of the present invention is shown. The system 1000 generally includes a webserver system 1400 and a telecom server system 1500, both may be distributed on one or more physical servers, each having processor, memory, an operating system, and input/output interface, and a network interface all known in the art, and a plurality of end user computing devices 1200/1300 communicatively coupled to a public network 1100, such as the Internet and/or a cellular-based wireless network. Likewise, databases herein can include non-transitory memory and may be object oriented, or otherwise accessible and operable as is currently known in the art.

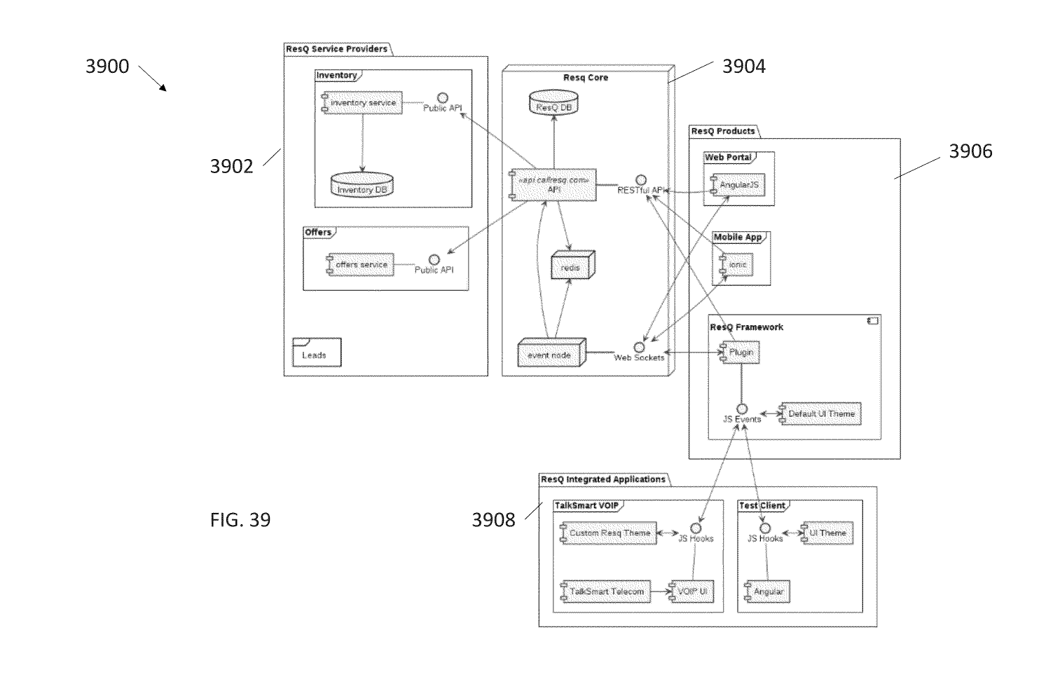

Turning to FIG. 39, an example embodiment of a call takeover architecture 3900 is shown. In the example embodiment, a takeover service provider 3902 can interact with a core service 3906, which in turn can interact with products 3906, which in turn can interact with integrated applications 3908. Examples of service providers 3902 include an inventory service provider with a Public API, inventory service and Inventory database; offers which includes an offers service and public API and Leads. Examples of core services 3904 include a database, API, redis, event node, web sockets and API. Examples of products 3906 include web portals, mobile applications, and frameworks including plugins, events and default UI themes. Integrated applications 3908 include VoIP which further includes telecom, VoIP UI, JS hooks and Custom theme; and test clients which includes JS Hooks, Angular and UI themes.

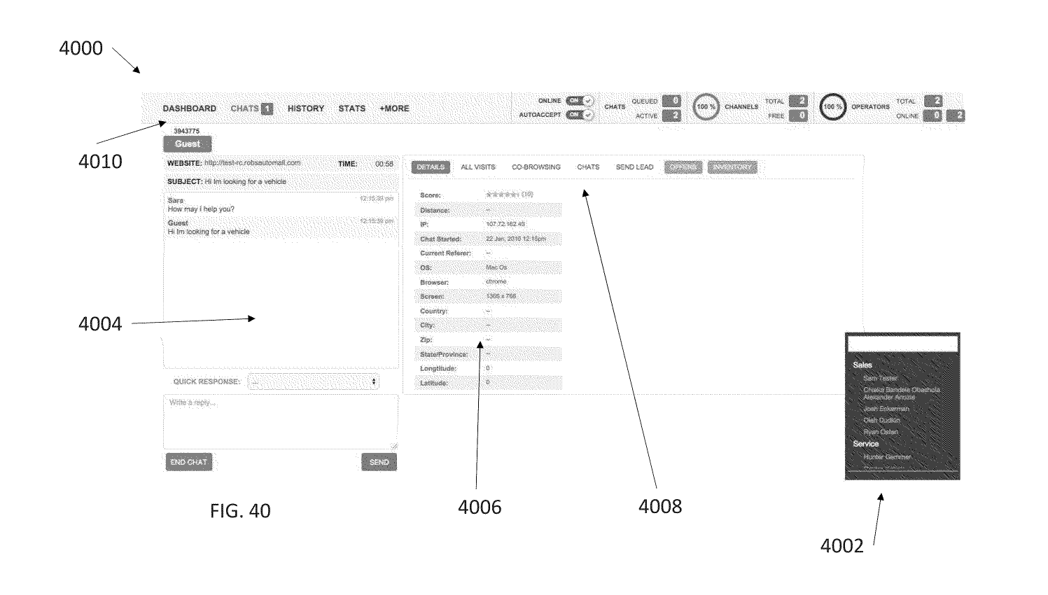

FIG. 40 is an example embodiment of a chat operator user interface screen 4000 with a call takeover “widget” 4002 in the bottom right corner. In the example embodiment, the chat operator user interface screen 4000 includes a chat area 4004 where an operator or agent can view and interact with a text based conversation with a client. In some embodiments this can be a transcript of a voice conversation that is displayed live using voice recognition software. Also shown are call details 4006 which can include a score or rating of a customer lead, a distance to a vendor location, an IP address, a chat start time, a customer referrer, an operating system, a browser, a screen information area, a country, a city, a zip code, a state or province, a longitude and a latitude. Operators can also select other user interface options 4008 including all visits, co-browsing, chats, send lead, offers and inventory. A header area 4010 can include links to a dashboard, live chats, history, stats, more, and options to show the operator is online and auto-accepting leads, has chats queued or active, a percentage of channels with a total and free, and a percentage of operators with a total and online number. Call takeover “widget” 4002 can include a list of employees organized by department where the operator can select or view those who may take over the call or transfer the call.

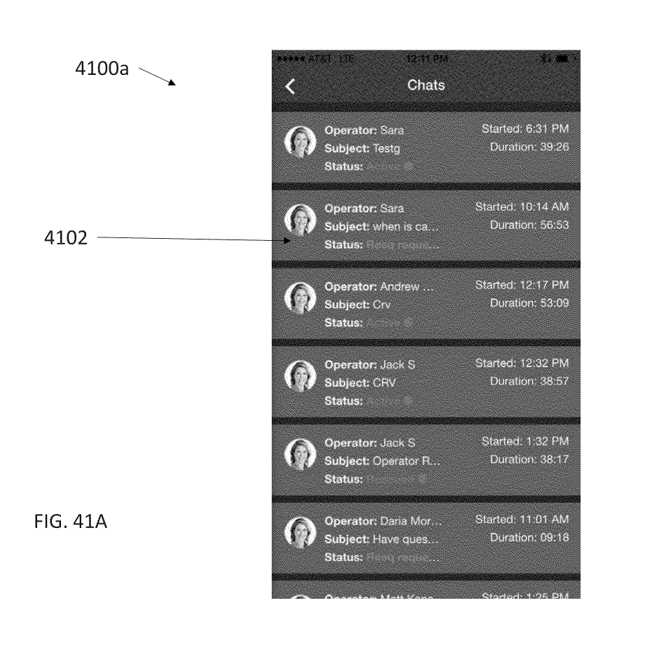

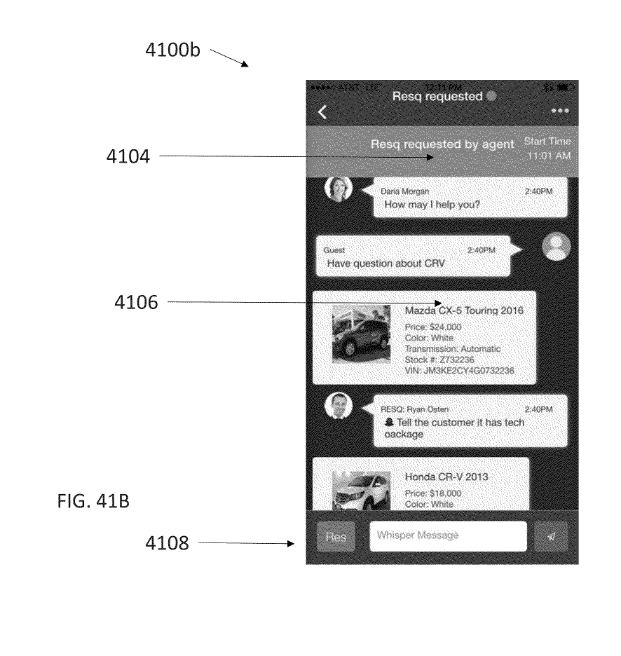

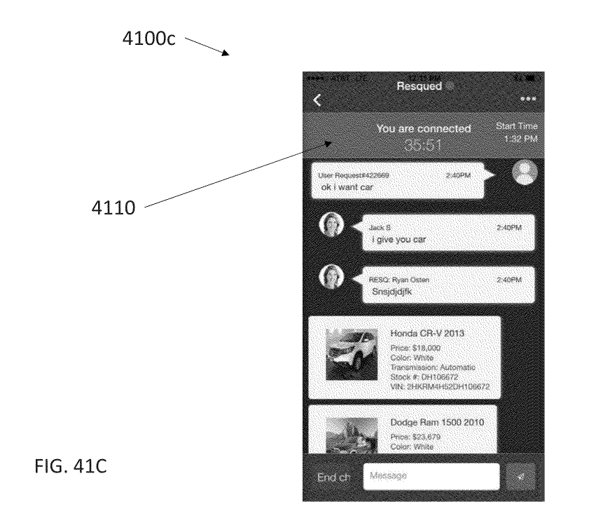

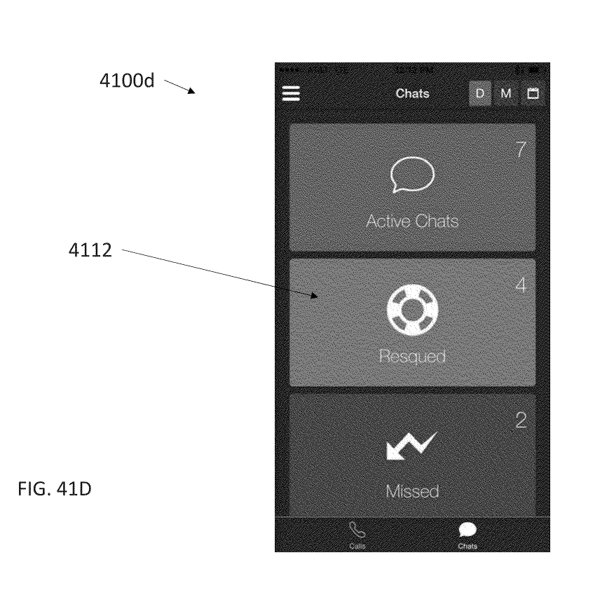

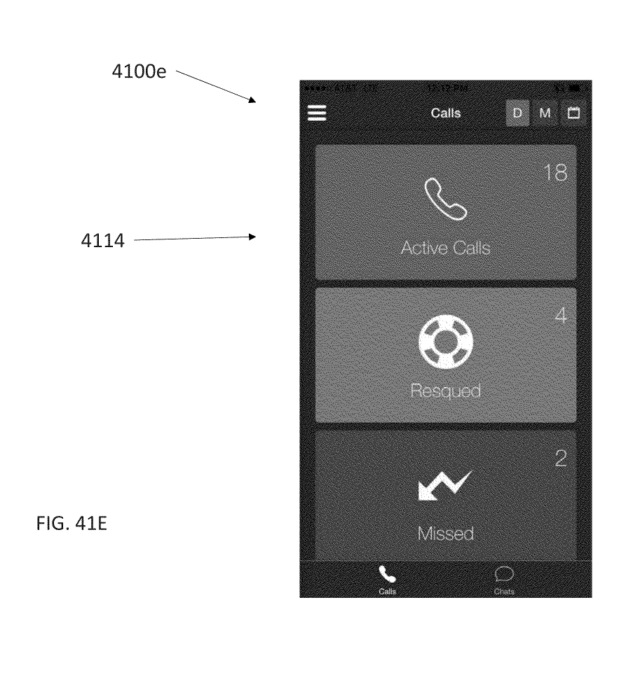

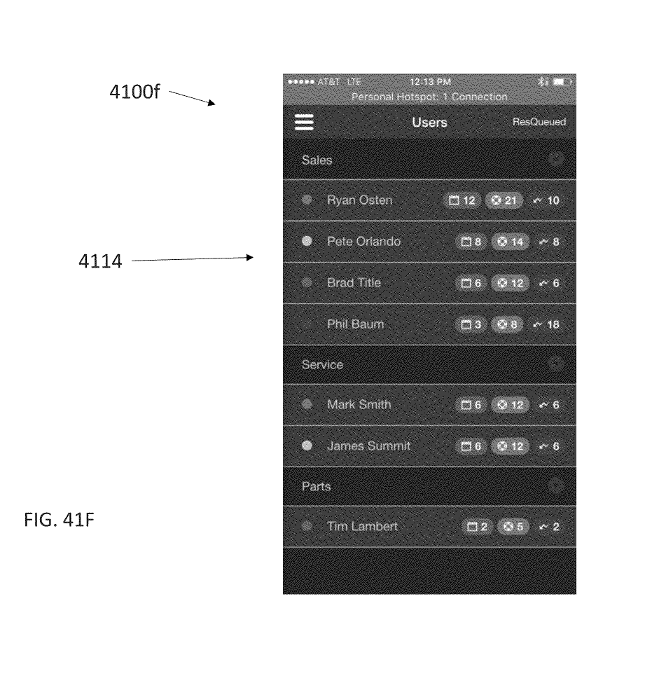

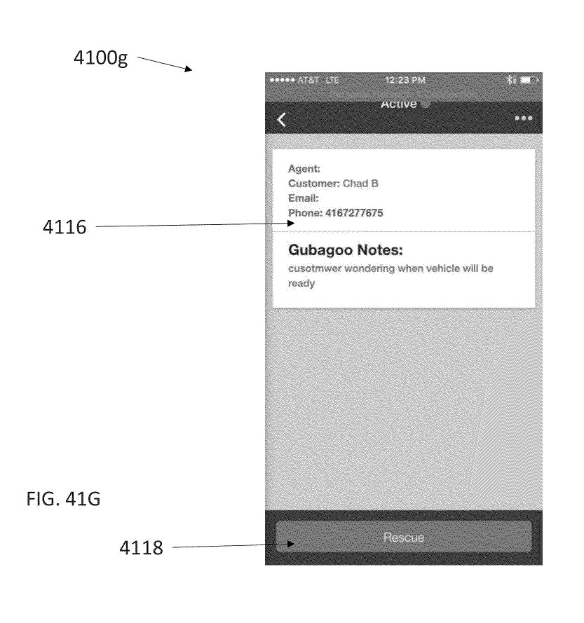

FIG. 41A is an example embodiment diagram of an operator call status user interface screen 4100a for a vendor mobile application in accordance with the present invention. In the example embodiment various operator chat status indicators 4102 can include an image of an operator, operator name, subject of a call, status such as live or needing a takeover or “resq” rescue, time the chat started and duration of the chat.

FIG. 41B is an example embodiment diagram of an agent chat user interface screen 4100b with a takeover notification 4104 for a vendor mobile application in accordance with the present invention. In the example embodiment, an agent takeover notification 4104 can be displayed on the agent chat user interface screen 4100b when an agent wishes to take over the chat. Chat area 4106 can include details of the conversation between an operator as well as a messaging area 4108 where the user can send messages to the agent or customer, ask for a transfer or send offers to the customer.

FIG. 41C is an example embodiment diagram of an operator chat user interface screen 4100c with a takeover notification 4110 for a vendor mobile application in accordance with the present invention. In the example embodiment the agent is notified that they have successfully taken over the chat by the takeover notification 4110.

FIG. 41D is an example embodiment diagram of an operator chat status screen 4100d for a vendor mobile application in accordance with the present invention. Various selectable buttons 4112 indicate active chats, taken over chats (“resqued”) and missed chats.

FIG. 41E is an example embodiment diagram of an operator call status screen 4100e for a vendor mobile application in accordance with the present invention. Various selectable buttons 4114 indicate active calls, taken over calls (“resqued”) and missed calls.

FIG. 41F is an example embodiment diagram of a vendor department status screen 4100f for a vendor mobile application in accordance with the present invention. In the example embodiment the user can view the status of various agents by department including colored or other indicators as to status, number of active calls serviced, number of taken over calls, and number of missed calls.

FIG. 41G is an example embodiment diagram of a vendor live call screen 4100g for a vendor mobile application in accordance with the present invention. In the example embodiment an information area 4116 a user can view agent information, customer information, email, phone number and notes regarding the conversation. A selectable takeover button 4118 allows the user to take over the call.

FIG. 41G is an example embodiment diagram of a vendor live call screen 4100g for a vendor mobile application in accordance with the present invention.

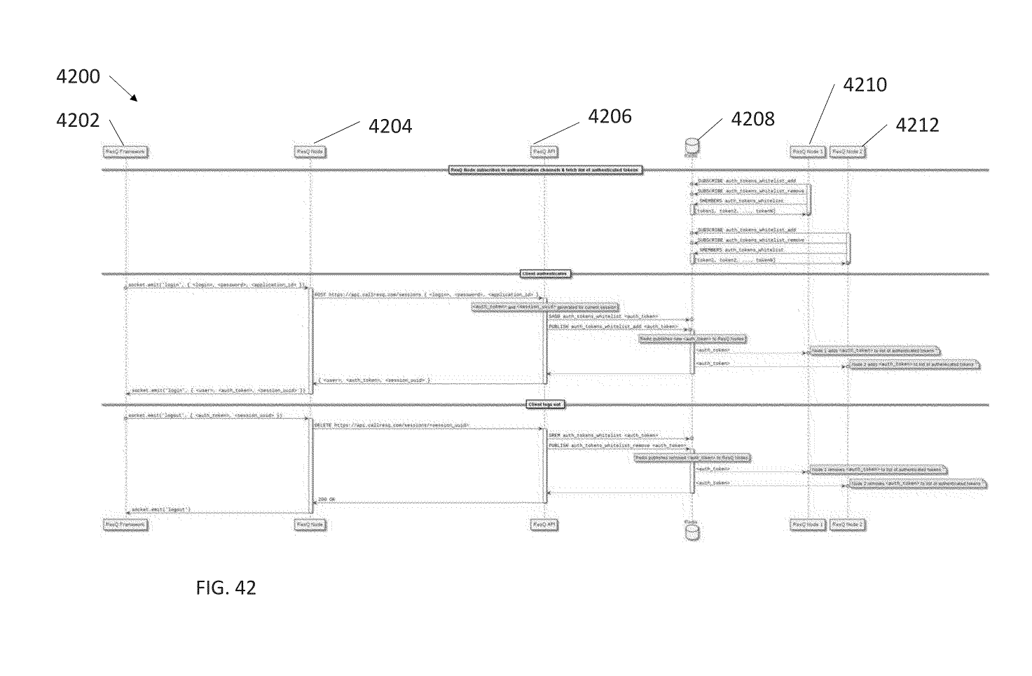

FIG. 42 is an example embodiment diagram of an authentication sequence 4200. In the example embodiment during a takeover node subscription to authentication channels fetch and fetching a list of authenticated tokens, a first takeover node 4210 can subscribe with authentication tokens whitelist add, whitelist remove, whitelist and receive number of tokens from a Redis database. Likewise, a second takeover node 4212 can subscribe with authentication tokens whitelist add, whitelist remove, whitelist and receive number of tokens from a Redis database.

During client authentication, a takeover framework 4202 can login to a takeover node 4204 using a login, password and application identifier. This can be posted to a takeover API 4206 where an authentication token including a session user id is generated for the current session. A SADD authentication tokens whitelist with authentication token can be sent to Redis database 4208 and authentication tokens whitelist add including authentication token can be published to the Redis database 4208 and thereafter a new authentication token can be published to first and second takeover nodes 4210 and 4212 which can add the authentication token to a list of authentication tokens. Then takeover API 4206 can send the user the authentication token and session user id to takeover node 4204 which can forward it back to takeover framework, 4202.

A client logout process can include a takeover framework 4202 can sending authentication token and session id to a takeover node 4204. This can be deleted from a takeover API 4206. A SREM authentication tokens whitelist with authentication token can be sent to Redis database 4208 and authentication tokens whitelist remove including authentication token can be published to the Redis database 4208 and thereafter the authentication token can be published to remove first and second takeover nodes 4210 and 4212 which can remove the authentication token from a list of authentication tokens. Then takeover API 4206 can send the user the authentication token removal acknowledgement to takeover node 4204 which can forward the logout to takeover framework, 4202.

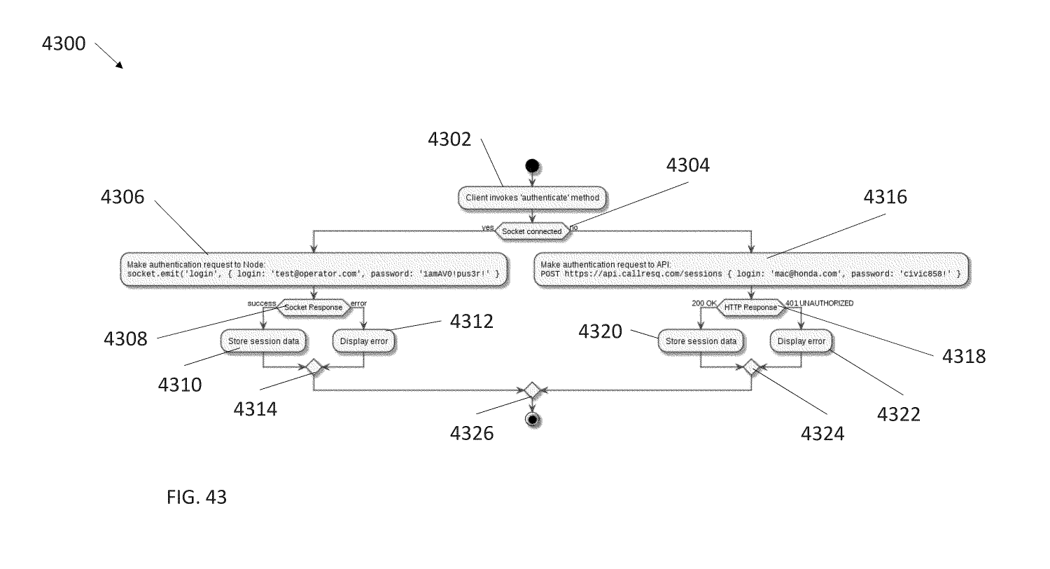

FIG. 43 is an example embodiment diagram of a framework authentication activity diagram 4300. In the example embodiment a client can invoke an authentication method 4302 can then determine if a socket is connected in step 4304. If a socket is connected then an authentication request can be sent to the node with a login, and password in step 4306. If the socket responds in step 4308 then the session data can be stored in step 4310. If the socket does not respond in step 4308 then an error can be displayed in step 4312 before first convergence 4314 is reached. If a socket is not connected in step 4304 then an authentication request can be sent to API in step 4316. If the HTTP response is affirmative in step 4318 then session data can be stored in 4320 but if not then an error can be displayed in step 4322 before a second convergence 4324 is reached. 4314 and 4324 can then converge in step 4326.

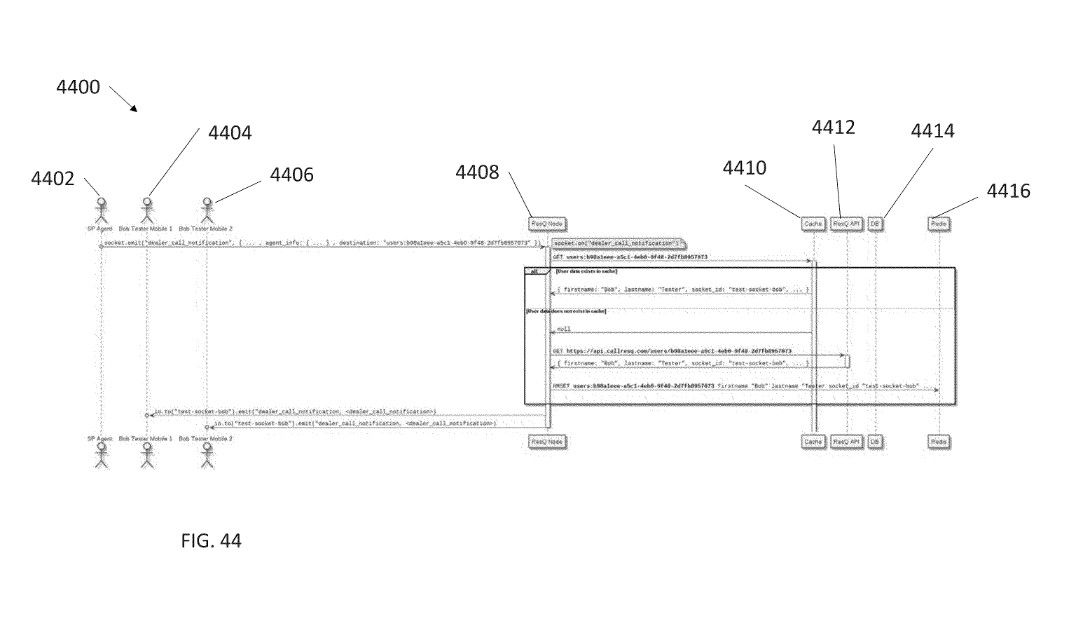

FIG. 44 is an example embodiment of a user cache sequence diagram 4400. In the example embodiment, a SP agent can send a dealer call notification including agent information to a destination such as a takeover node 4408. This can turn a socket on with a dealer call notification and send a request for the user to cache 4410. If the user data exists in the cache, it can send a firstname, lastname, and socket id back to the node 4408. If the user name does not exist in the cache 4410 then a null response can be sent back to node 4408 which can then send a request to a takeover API 4412 which can return a firstname, lastname, and socket id back. Then a HMSET users with firstname, lastname and socket id can be sent from node 4408 to Redis 4416. Thereafter, node 4408 can send tests to a first and second mobile device 4404 and 4406 respectively with dealer call notifications.

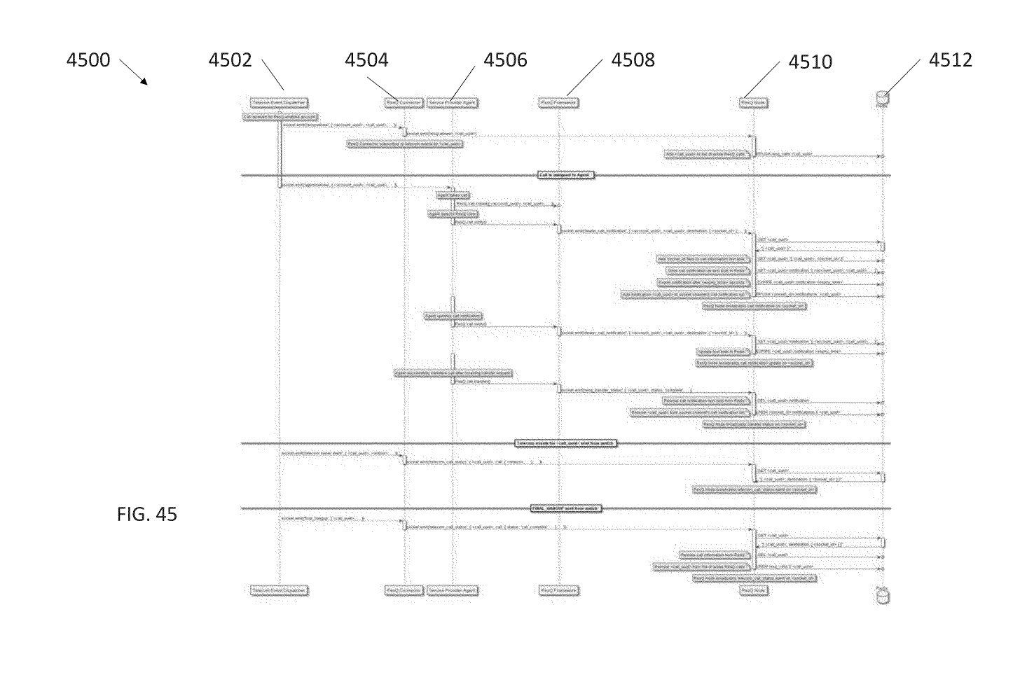

FIG. 45 shows an example embodiment of a call notification sequence diagram 4500. In the example embodiment, a telecom event dispatch can receive a call at a takeover system enabled account before sending an account user id and call id to a takeover connector 4504. Takeover connector 4504 can send the call id to a takeover node 4510 which can add the call id to a list of active calls before pushing the call id to a Redis database 4512.

When a call is assigned to an agent the telecom event dispatcher can send a service provider agent 4506 the account id and call id and the service provider agent 4506 can take the call which then sends a create account id and call id information to takeover framework 4508. Once the service provider agent 4506 selects a takeover user it can send a notification to takeover framework 4508 which can send a dealer call notification including the account id, call id and destination socket id to node 4510. Node 4510 can then look up the call id from Redis database 4512 before adding a socket id field and assigning the call id to the socket id in Redis database 4512. Thereafter, the call notification can be set with the account id and call id, expired after a particular time period, notification can be added to socket channels call notification list and the node 4510 can broadcast a call notification.

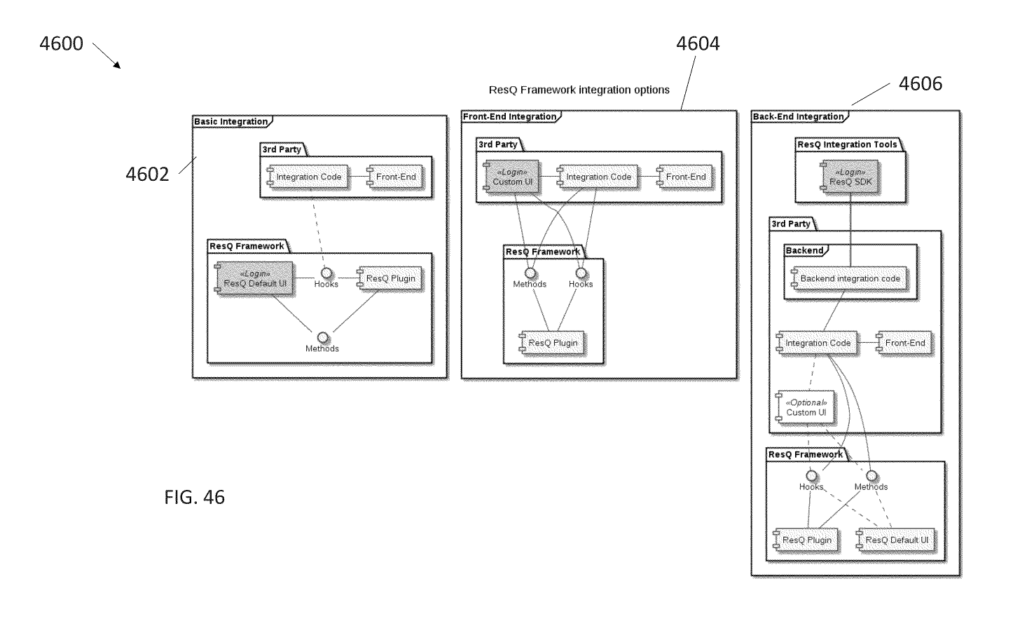

FIG. 46 is an example embodiment of a takeover system integration options diagram 4600. In the example embodiment a basic integration 4602 can include third party integration code and a front end and a takeover framework including login, hooks, plugin and methods. Front end integration 4604 can include third party integration including login with a custom user interface, integration code and a front end and a takeover framework including methods hooks and a takeover plugin. Back end integration 4606 can include takeover integration tools including a login; third party integration including backend integration code, integration code, front end, and optional custom user interface and a takeover framework including hooks, methods, takeover plugin and takeover default user interface.

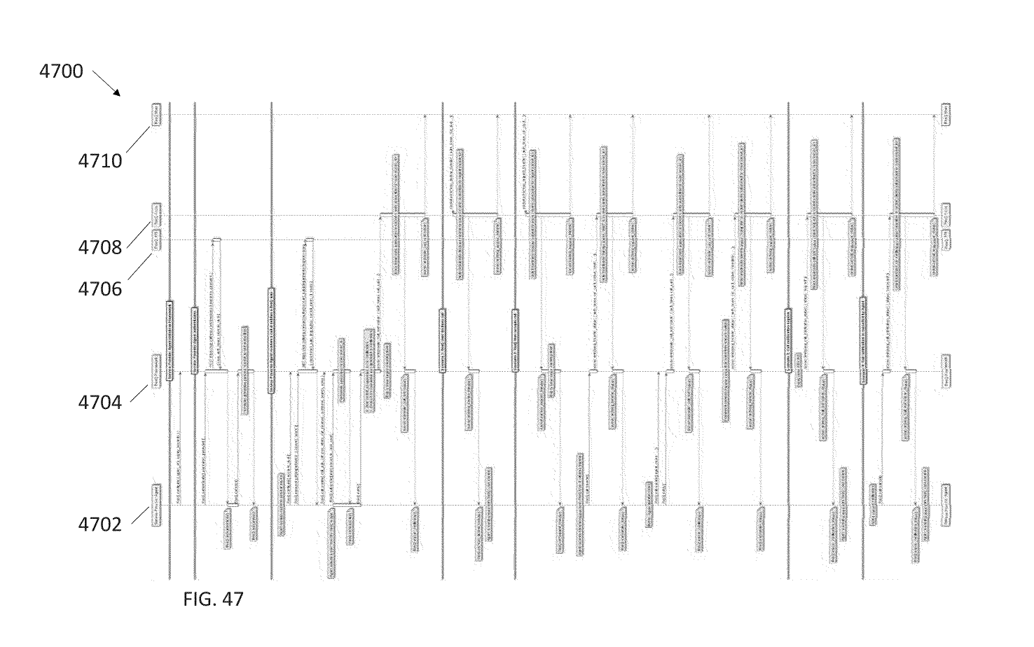

FIG. 47 is an example embodiment of a framework sequence diagram 4700. In the example embodiment a service provider agent initializing a framework can include a service provider agent 4702 sending a takeover configuration including agent information and a time limit to a takeover framework 4704.

A service provider agent authentication process can include a service provider agent 4702 sending an authentication including username and password to framework 4704. This can be posted to a takeover API 4706 which can return the user, authentication token and session id which can be sent to service provider agent 4702 and authenticated. Then a takeover connection can be established with takeover framework 4704 where the framework generates a personal socket id and subscribes and the service provider agent 4702 is connected.

A service provider agent receiving a call and notifying a takeover user can include a service provider agent 4702 receiving a call from an external source and sending a takeover configuration to takeover framework 4704 with an account user id and a request for departments and users. Takeover framework 4704 can send this to takeover API 4706 which can return department user id, text display, socket room id and users that can be forward to service provider agent 4702. The agent 4702 can select a user from a takeover “widget” and the framework 4704 can subscribe the user to a socket id whereby the takeover application of the service provider agent 4702 can subscribe. This can then send a notification back to framework 4704 where a user socket id is appended to a call notification and a time expiry can be calculated and appended to the notification and turning on the expiry timer countdown. Dealer call notification including authentication token and call user id can be sent to a takeover node 4708 which can broadcast a notification to subscriber socket clients before sending a dealer call notification back to framework 4704. A call notification can be sent back to service provider agent 4702 from framework 4704. A dealer notification can also be sent from node 4708 to a user 4710.

In a first scenario where a takeover user declines to takeover a call a decline transfer message including an authentication token and user id can be sent from the user 4710 to node 4708 which in turn sends a takeover declined message to framework 4704 and forwarded to service provider agent 4702. The agent 4702 can then be unsubscribed from the takeover user channel. Node 4708 can then send confirmation back to the user 4710.

In a second scenario where a takeover user accepts a takeover call a request transfer message including an authentication token and user id can be sent from the user 4710 to node 4708 which in turn sends a takeover transfer message to framework 4704 which ends an expiry timer and forwards the message to service provider agent 4702. The agent 4702 can then accept the transfer request and the transfer can be initiated by agent 4702. Agent 4702 can transmit a call transfer message to framework 4704 which can send a takeover transfer message including an authentication token, call user id and start status to Node 4708 can which can begin broadcasting a transfer status to start to socket client subscribers. Node 4708 can transmit a transfer status back to framework 4704 which can send the status to agent 4702. As a bonus, in some embodiments, an agent can update notes and send the update and a notification to framework 4704. Framework 4704 can then send a dealer call notification including authentication token and call id to node 4708 which can broadcast the notification to socket clients subscribers. Node 4708 can transfer a dealer call notification back to framework 4704 and a call notification can be sent back to agent 4702. Meanwhile a dealer call notification can be sent from node 4708 to user 4710. Framework 4704 can receive a transfer completion event from a telecom switch (not shown) and send a takeover transfer status including authentication token, call id, and status complete message to node 4708 which can broadcast the transfer complete status to socket client subscribers. Node 4708 can send the takeover transfer status to framework 4704 which can forward it to agent 4702. Meanwhile, takeover transfer status can be transmitted from node 4708 to user 4710.

In a third scenario where a takeover expiry timer expires, framework 4704 can transmit takeover call notification status expired message to node 4708 which in turn can broadcast call notification status expired to socket client subscribers. Node 4708 can transmit a call notification status to framework 4704 which can forward it to agent 4702 who can then be unsubscribed from the takeover user channel. Meanwhile, node 4708 can transmit a call notification status to user 4710.

In a fourth scenario where a takeover call notification is cancelled by an agent, agent 4702 can cancel a notification which transmits a cancel message to framework 4704 which can then transmit a takeover call notification status cancelled message to node 4708 that can broadcast the call notification status to socket client subscribers. Node 4708 can send a call notification status to framework 4704 which can forward it to agent 4702 which can cause the agent 4702 to be unsubscribed from the takeover user channel. Meanwhile node 4708 can send a call notification status to user 4710.

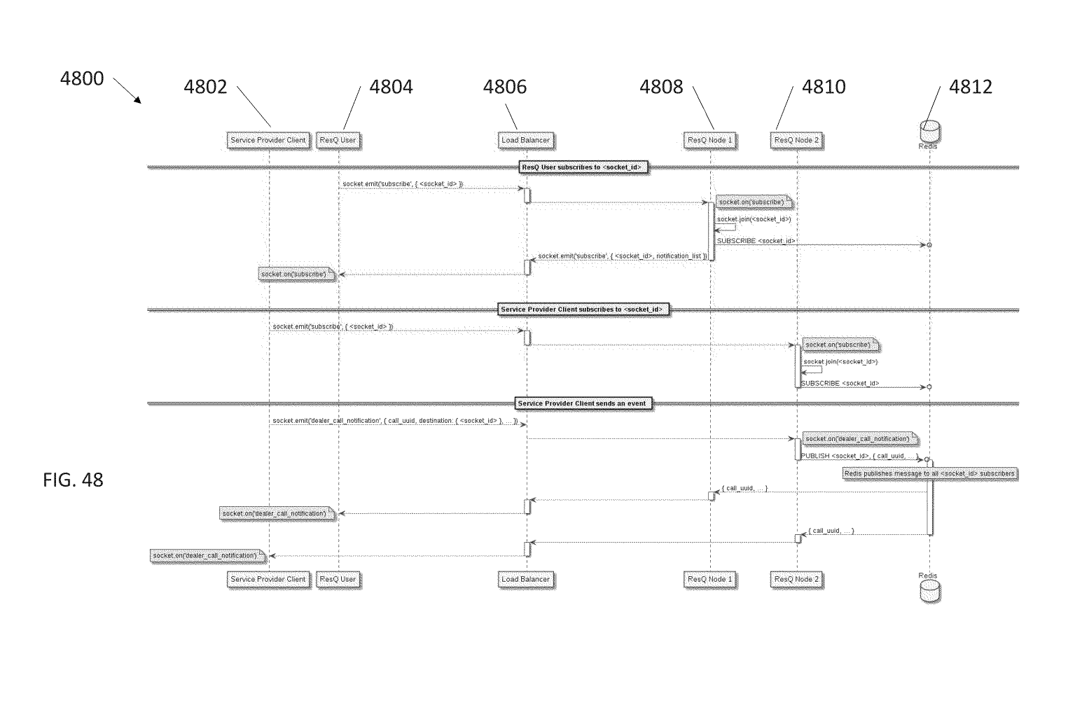

FIG. 48 is an example embodiment of a pub sub sequence diagram 4800. In the example embodiment, a takeover user subscription to a node with a socket id can include a takeover user 4804 sending a subscription request to a load balancer 4806 which can forward it to a first takeover node 4808. This can cause node 4808 to subscribe the user by turning on and joining the socket id before transmitting the socket id subscription to Redis database 4812. Node 4808 can then send a subscription message with a socket id and notification list to load balancer 4806 which can transmit the subscription to takeover user 4804.

A service provider client subscription to a socket id process can include a service provider client 4802 sending a subscription request to a load balancer 4806 which can forward it to a second takeover node 4810. This can cause node 4810 to subscribe the user by turning on and joining the socket id before transmitting the socket id subscription to Redis database 4812.

A service provider client sending an event process can include a service provider client 4802 sending a dealer call notification to a load balancer 4806 which can forward it to a second takeover node 4810. This can cause node 4810 to turn the socket on and publish the socket id including the call id to Redis database 4812. First node 4808 can retrieve the call id from database 4812 before sending it to load balancer 4806 which can transmit a dealer call notification to takeover user 4804. Similarly, second node 4810 can retrieve the call id from database 4812 before sending it to load balancer 4806 which can transmit a dealer call notification to service provider client 4802.

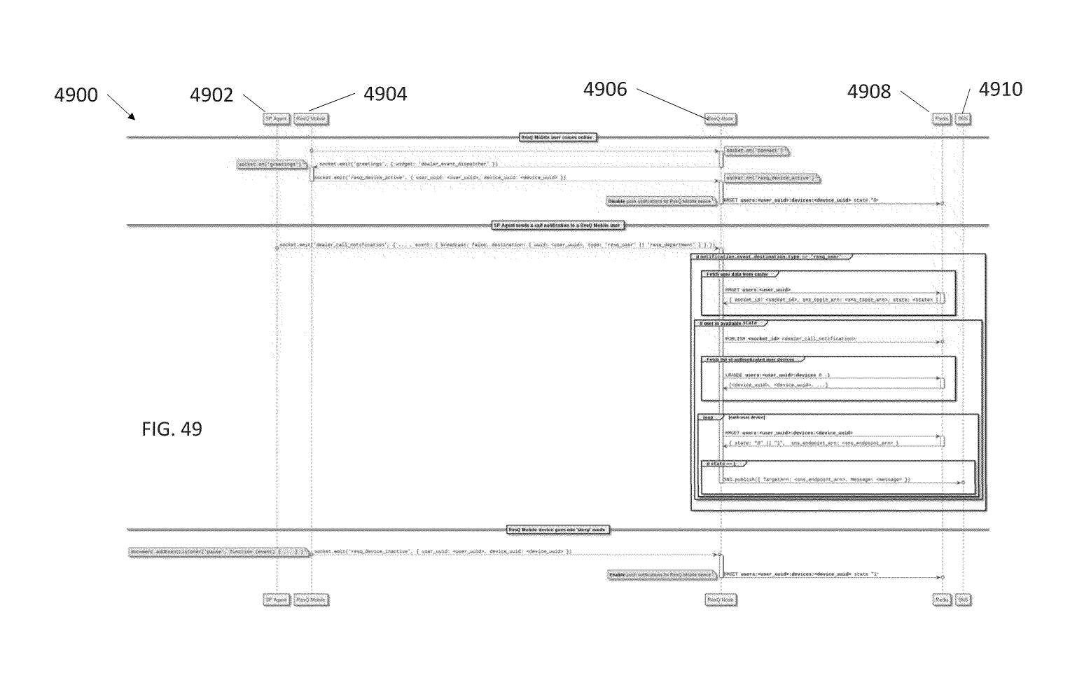

FIG. 49 is an example embodiment of a call notification sequence diagram 4900. In the example embodiment, a takeover mobile device 4904 can connect to a node 4906 which can transmit a greetings message with a dealer event dispatcher widget update back to mobile device 4904. Mobile device 4904 can display the greeting message and transmit a device active notification including a user id and device id to node 4906 which can receive the message and set the user id and device id state to “O” in Redis 4908.

A Service Provider agent sending a call notification to a takeover mobile device user process can include a service provider agent device 4902 transmitting a dealer call notification including an event with a false broadcast and a destination including user id and takeover user id to node 4906. If a notification event destination is a takeover user then user data can be retrieved from a cache by the node 4906 transmitting a user id to Redis 4908 and retrieving a socket id including identifier, sns topic am and state. If a user is available in the state then node 4906 can request user ids and device ids from Redis 4908. For each user device, a loop can occur where the user id and device id retrieval from Redis 4908 occurs and if the state is one then a sns endpoint am and message can be sent to SNS 4910.

In a takeover mobile device going into sleep mode process a pause function event message including a user id and device id can be sent from a takeover mobile device 4904 to node 4906 which can in turn update Redis 4908.

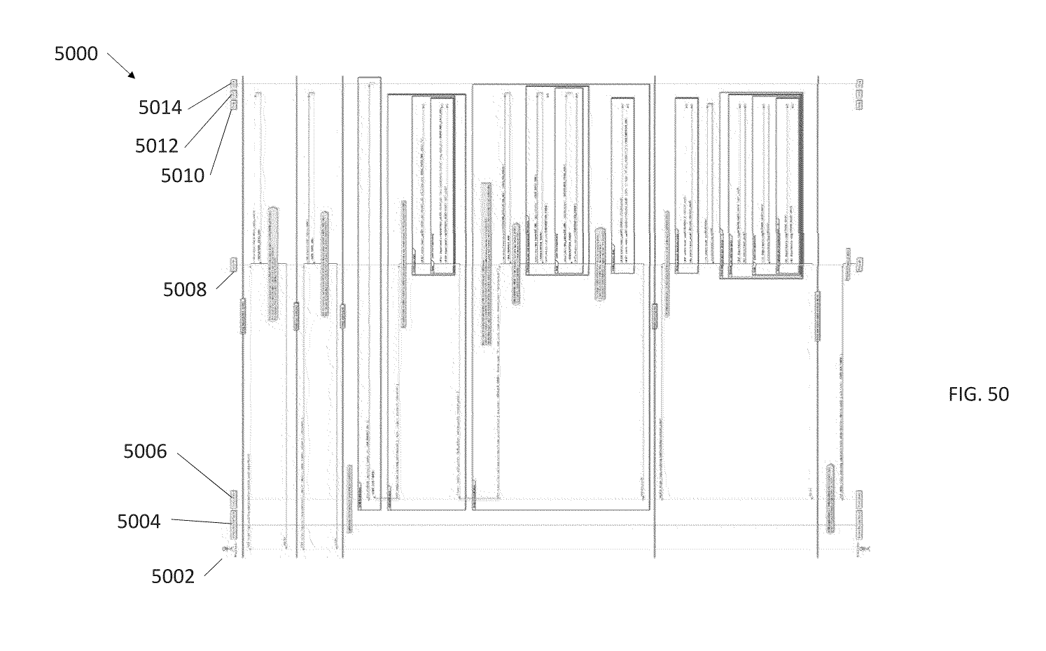

FIG. 50 shows an example embodiment of a SNS registration sequence diagram 5000. In the example embodiment a takeover department creation process can include a takeover administrator 5002 can post an account id with departments to a takeover API 5008 which can transmit a creation of the department topic name to SNS 5012 which can respond with a department topic arm. Takeover API 5008 can create a new row in a takeover department table that includes a sns topic arm column with a value as a push notification equivalent of a socket room/channel that is associated with the takeover account. This can be acknowledged in a message back to the administration 5002.

A takeover user account creation process can include a takeover administrator 5002 can posting an email, name and password to a takeover API 5008 which can transmit a creation of the user topic name to SNS 5012 which can respond with a user topic arm. Takeover API 5008 can create a new row in a takeover user table that includes a sns topic arm column new user that is associated with the takeover account and one or more departments. This can be acknowledged in a message back to the administration 5002.

A takeover user login process can include a GCM registration process where a takeover mobile device 5004 can include a registration by the device sending a sender id and project id to GCM 5014 which can respond with a GCM token. An authentication process can include the takeover mobile device 5004 transmitting an entered login and password to API 5008 which authenticates the provided credentials and retrieves user and department data and creates a row in a takeover sessions table. A cache user data process can include API 5008 transmitting user id, socket id, sns topic arm including user topic arm at a state 0 to Redis 5010. A user department loop can include transmitting department id, socket id and sns topic arm and also transmitting department id and user ids to Redis 5010. API 5008 can then transmit user id, authentication token and session id to mobile device 5006.

A device registration process can include posting a user gcm token, device type, user id, and session id from mobile device 5006 to API 5008 which can create a platform endpoint including a platform application arm and user GCM token to SNS 5012 which can respond with a SNS endpoint arm message. This can uniquely identify the mobile application instance in SNS and allow notifications to be published to the mobile device through the SNS. A subscribe to user and department SNS topics process can include transmitting sns endpoint arm and user topic arm from API 5008 to SNS 5012 which can respond with a subscription token before API 5008 transmits a confirmation message with the token back to the SNS 5012. Then a user department loop can include transmission of a sns endpoint arm and department topic arm from API 5008 to SNS 5012 which can respond with a subscription token before API 5008 transmits a confirmation message with the token back to the SNS 5012. This can cause API 5008 to generate a device id for the requesting device while a new row is created in a takeover device database table and the device can be associated with the appropriate user and session. A cache device data process can include transmitting user id and device id as well as HMSET including user ids, device ids and sns endpoint arms to Redis 5010. API 5008 can respond to mobile device 5006 with a device id.

A takeover user logout process can include transmission of a delete posting from mobile device 5006 to API 5008 which can retrieve device and user data associated with the session as well as user department data. A remove device data from cache process can include transmitting user id and device id as well as delete user including user id and device id from API 5008 to Redis 5010. API 5008 can then retrieve the user id of devices with a number of authenticated user devices from Redis 5010. If the number of devices is zero then a remove user data from cache process can include department and user id removal and delete user id from Redis 5010. A loop for each user department can include retrieving the number of authenticated departments the user is in from Redis 5010. If the number of authenticated department users is zero then department id and department id users can be deleted by API 5008 which can respond to mobile device 5006 a deletion acknowledgement.

A takeover user login on the same device process can include GCM registration processes taking place while the device retrieves a previously assigned device ID. This can be sent from device 5006 to API 5008 and the process can continue as previously described.

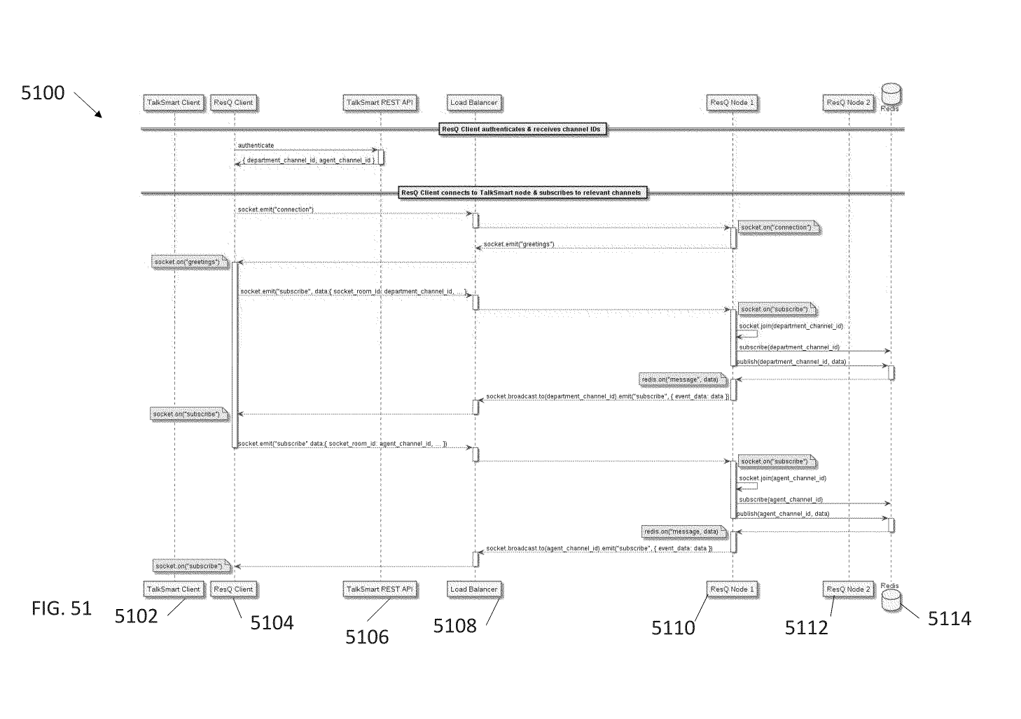

FIG. 51 is an example embodiment of a takeover client subscription sequence diagram 5100. In the example embodiment a takeover client authentication and channel id reception process can include a takeover client 5104 can transmit an authentication message to a system REST API 5106 and receive a department channel id and agent channel id.

A takeover client connecting to a system node and subscribing to relevant channels process can include a takeover client 5104 transmitting a connection to a load balancer 5108 which can forward it to a first takeover node 5110. This can establish a connection and send a greeting message back to load balancer 5108 which can forward back to takeover client 5104. A subscribe message include socket room id and department channel id can be transmitted from client 5104 to load balancer 5108 which can forward it to first node 5110. This can cause the node 5108 to join channel ids and subscribe to channel ids by sending a subscribe message with department channel id to Redis 5114 and publishing a department channel id with data to Redis 5114 before setting up the message and data and broadcasting the department channel id and subscription including event data and data from node 5110 to load balancer 5108 which forwards it to client 5104. Then the socket is on subscription. Subscribe data including socket room id and agent channel id can be transmitted from takeover client 5104 to load balancer 5108 which can be forwarded and updated according to the same process previously described.

In some embodiments of the invention, vendor employees are able to access the system via a desktop, laptop, or other local device. System notifications including takeover notifications and inventory interfaces for individual vendors or teams of vendors can be accessible. The system allows for vendors to have their own version of agents, which can be vendor employees located on-site or at a BDC—Business Development Center or other call center. These vendor employees can log into the overall system or tailored versions of the system on their computers or devices to receive calls. In addition, if the vendor does not want to handle actual system calls, there can be a limited-functionality version of the system UI that allows the vendor employee to browse Inventory through a system portal, send emails with Inventory and Offers to customers, and receive takeover notifications through their web browser, with similar interactions to those offered for mobile devices. These can include real-time updates of the information that system agents are entering into script user interfaces, the ability to notify the system agent on availability issues and others.

In various embodiments, vendor employees, system agents and third parties can act as agents. Agents can have full access, limited access and modifiable access based on roles or levels within the system. Call centers can be local, remote, or both. Some portions of the system can be automated such as through telephonic menus or interactive displays on smart devices. Various tracking and recording means can be employed to monitor agent and workgroup productivity for both vendors and system operators.

It should be understood that various servers, databases, user devices, communicative couplings, networks, protocols, hardware and software can be used to implement the concepts described herein as would be understood to one of ordinary skill in the art. It should also be understood that wherever calls are described herein or chat interfaces, they can be interchangeably used in various embodiments or used in conjunction with one another in still other embodiments. Thus a set of text conversations or phone conversations can be taken over by vendor employees whenever needed from third party agents.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions described herein is merely illustrative, and the invention may appropriately be performed using different or additional process actions, or a different combination or ordering of process actions. For example, this invention is particularly suited for generating leads based on user website behavioral patterns; however, the invention can be used for any lead generation system in general. Additionally and obviously, features may be added or subtracted as desired. Accordingly, the invention is not to be restricted except in light of the attached claims and their equivalents.

What is claimed is:

1. A telecommunications system for handling call volume, comprising:
an application with takeover ability loaded on a mobile device, wherein the application can be updated when a call is being handled by a third party such that a user can view a call status and elect to take over the call when a takeover option is selected on a user interface of the application.

2. The telecommunications system for handling call volume of claim 1, wherein the takeover option further comprises:
an SMS takeover option; and
a call takeover option.

3. The telecommunications system for handling call volume of claim 2, wherein the SMS takeover option further comprises:
an alert to a user to view a text from a customer;
the user selecting the takeover option for a text conversation; and
the user interface displaying a number of text conversations taken over.

4. The telecommunications system for handling call volume of claim 2, wherein the call takeover option further comprises:
displaying a desired inventory purchase offer on the user interface;
displaying customer information on the user interface; and
displaying a selectable option for the user to takeover the call on the user interface.

5. The telecommunications system for handling call volume of claim 1, wherein the application takeover option further comprises:
an offer selection for a system operator to present to a vendor on the user interface.

6. The telecommunications system for handling call volume of claim 5, wherein the offer selection further comprises:
searchable real-time inventory offerings on the user interface;
selection of one or more inventory items based on customer preferences on the user interface; and
selection of an additional sales offer to include with the inventory offering on the user interface.

7. The telecommunications system for handling call volume of claim 6, wherein the application takeover option further comprises:
sending the offer to the customer by email.

8. The telecommunications system for handling call volume of claim 1, wherein the application takeover option further comprises:
a vendor viewing platform to view calls for different departments of the vendor.

9. The telecommunications system for handling call volume of claim 8, wherein the vendor viewing platform further comprises:
display of a number of agents currently assisting customers on the user interface; and
display of a number of agents not currently assisting customers on the user interface.

10. The telecommunications system for handling call volume of claim 1, wherein the application takeover option further comprises:
display of a list of selectable agents to transfer an incoming call to on the user interface.
